(19) United States
(12) Patent Application Publication
(10) Pub. No.: US 2017/0181917 A1
(43) Pub. Date: Jun. 29, 2017

(54) ASSIST DEVICE, SWINGING JOINT DEVICE, LINEAR MOTION VARIABLE RIGIDITY UNIT, AND MACHINE TOOL

(71) Applicant: JTEKT CORPORATION, Osaka-shi (JP)

(72) Inventors: Hiromichi OHTA, Kariya-shi (JP); Yoshitaka YOSHIMI, Okazaki-shi (JP); Kazuyoshi OHTSUBO, Chiryu-shi (JP)

(73) Assignee: JTEKT CORPORATION, Osaka-shi (JP)

(21) Appl. No.: 15/388,214

(22) Filed: Dec. 22, 2016

(30) Foreign Application Priority Data
Dec. 24, 2015 (JP) 2015-252041
Dec. 24, 2015 (JP) 2015-252042
Dec. 24, 2015 (JP) 2015-252043
Dec. 24, 2015 (JP) 2015-252044

(51) Int. Cl. A61H 3/00

(52) U.S. Cl. CPC A61H 3/008; A61H 2201/123; A61H 2201/149; A61H 2201/163; A61H 2201/1642; A61H 2201/5084; A61H 2201/50

(57) ABSTRACT

An assist device is connected to a moving body that performs a reciprocating swing motion. The assist device includes a first output portion configured to swing around a swing center as a center of a swing motion; a variable rigidity device including an elastic body configured to accumulate energy and release the energy in accordance with a first swinging angle as a swinging angle of the first output portion, and a rigidity varying unit configured to change an apparent rigidity of the elastic body seen from the first output portion; a first angle detecting portion configured to detect the first swinging angle; and a control device configured to adjust the apparent rigidity of the elastic body seen from the first output portion by controlling the rigidity varying unit in accordance with the first swinging angle detected by the first angle detecting portion.

### INCORPORATION BY REFERENCE

The disclosure of Japanese Patent Applications No. 2015-252041, 2015-252042, 2015-252043 and 2015-252044 filed on Dec. 24, 2015 each including the specification, drawings and abstract is incorporated herein by reference in its entirety.

### BACKGROUND

1. Technical Field

The disclosure relates to an assist device that assists walking improvement, an operation, and the like of a user. Further, the disclosure relates to a swinging joint device which performs a periodic swing motion and which is able to change a rigidity of a joint. Further, the disclosure relates to a linear motion variable rigidity unit and a machine tool including a linear motion variable rigidity unit.

2. Description of Related Art

An assist device that assists walking or the like of a user is described in Japanese Patent Application Publication No. 2013-236741 (JP 2013-236741 A), Japanese Patent Application Publication No. 2013-173190 (JP 2013-173190 A), and the like, for example. A single-leg walking assist device described in JP 2013-236741 A includes a waist attachment portion attached to a waist of a user, a femoral link portion, and a lower leg link portion, and the lower leg link portion is configured to be attached to a lower leg of the user. An upper part of the femoral link portion is connected to the waist attachment portion so as to be rotatable in an up-down direction, and a torque generator for giving a rotating torque to the femoral link portion is provided between the waist attachment portion and the femoral link portion. That is, walking assistance is provided by applying the rotating torque of the torque generator to the femoral link portion. The torque generator is configured to give a rotating torque to the femoral link portion with the use of actions of a compression spring, a cam, and a cam follower. Further, the torque generator is configured such that a compression amount (a spring force) of the compression spring is adjusted with the use of a tool.

Since the aforementioned single-leg walking assist device is configured such that the compression amount of the compression spring of the torque generator is adjusted with the use of the tool, it is impossible to adjust the spring force of the compression spring in accordance with a swinging angle of the femoral link portion during walking. Therefore, it is difficult to assist the walking with high efficiency. Further, it is also impossible to improve walking such that a walking motion of a user approaches an ideal walking motion.

The assist device described in JP 2013-173190 A is configured to assist a motion of a user by applying a rotating torque of a torque generator such as a motor to a femoral link portion and the like. Thus, in the configuration in which the motor or the like is used as the torque generator, a motor or the like with a large output is required in a case where a load is large. This makes it difficult to reduce power consumption.

As an example of a device that controls a joint that performs a periodic motion, Japanese Patent Application Publication No. 2004-344304 (JP 2004-344304 A) describes a walking assist device that gives an assist force to a lower limb (from a hip joint to a tip of a foot) of a user. The walking assist device includes a waist attachment member attached to a lumbar part of the user in a winding manner, a connecting bar extending from a side of a hip joint to a side of a knee joint, a lower leg attachment member extending from the side of the knee joint to a calf, a hip joint actuator attached to the connecting bar at a position corresponding to the side of the hip joint, and a knee joint actuator attached to the connecting bar at a position corresponding to the side of the knee joint. The hip joint actuator is attached to a connection portion of the waist attachment member so as to be disposed at the side of the hip joint, and the hip joint actuator moves the connecting bar in a front-rear direction around the hip joint relative to the waist attachment member. Further, the knee joint actuator is disposed at the side of the knee joint, and moves the lower leg attachment member in the front-rear direction around the knee joint relative to the connecting bar. Further, the hip joint actuator and the knee joint actuator are electric motors, and electric power to the electric motors is supplied from a battery attached to the waist attachment member.

Further, Japanese Patent Application Publication No. 2012-125388 (JP 2012-125388 A) describes a walking rehabilitation device that assists a motion of a lower leg (from a knee to an ankle) of a user. The walking rehabilitation device includes: a controller disposed around a waist of the user; a femoral link extending from a side of a hip joint to a side of a knee joint; lower leg links extending from both sides of the knee joint to an ankle joint; a motor disposed on the side of the knee joint; and a foot link extending from the ankle joint to a sole. The motor is a connection portion between the femoral link and the lower leg link and is attached to the side of the knee joint. The motor is disposed at the side of the knee joint, and moves the lower leg link in the front-rear direction around the knee joint relative to the femoral link. Further, electric power to the motor is supplied from a battery provided in a controller.

Further, JP 2013-236741 A describes the single-leg walking assist device attached to an affected leg of a user so as to assist a motion of the affected leg. One of the user's legs is healthy, and the other one of them is affected. The single-leg walking assist device includes: the waist attachment portion disposed on a side of a waist of the user; the femoral link portion extending from a side of a hip joint to a side of a knee joint; the lower leg link portion extending downward from the side of the knee joint; a torque generator disposed on the side of the hip joint; and a damper disposed on the side of the knee joint. The torque generator is constituted by a cam and a compression spring. The torque generator is configured to generate a torque at the time when the affected leg moves rearward due to a forward motion of the healthy leg, so as to assist a forward motion of the affected leg with the use of the torque thus generated. Thus, an actuator such as an electric motor is not required. Further, an initial compression amount of the compression spring is adjustable, so that a magnitude of the torque to be generated can be changed.

The walking assist device described in JP 2004-344304 A and the walking rehabilitation device described in JP 2012-125388 A both assist a walking motion of a lower limb or a part of the lower limb with the use of the electric motor. However, if supply of the electric power from a battery does not continue, the assistance cannot be provided. Further, the user who needs walking assistance cannot carry a large and heavy battery, and therefore, it is presumed that a relatively small and lightweight battery is used. Further, JP 2004-344304 A and JP 2012-125388 A do not describe any special configuration for reducing power consumption of the electric motor. Accordingly, it is estimated that continuous operating time of each of the assist devices described in JP 2004-344304 A and JP 2012-125388 A is relatively short.

Further, the single-leg walking assist device described in JP 2013-236741 A is configured such that a torque for a forward motion of a leg is generated by the cam and the compression spring without using an electric motor, and the continuous operating time thereof is longer than the continuous operating time in each of JP 2004-344304 A and JP 2012-125388 A. However, due to variation in body size (variation in inertia moment of a lower limb) among users, variation in a moving angle of a lower limb among users, a physical condition of a user, variation in inclination of a walking path, and the like, it is necessary for the user to manually adjust an initial compression amount of the compression spring by adjusting a position of a determination portion provided in an upper part of the compression spring of the torque generator with a tool such as a flat-blade screwdriver. This requires time and effort.

In a grinding machine described in Japanese Patent Application Publication No. 9-11124 (JP 9-11124 A), a grindstone is attached to a slider that linearly reciprocates in an up-down direction. The slider is attached to a swinging plate that swings around a swinging shaft, and linearly reciprocates in accordance with swinging of the swinging plate. The swinging plate has a counterweight on an opposite side of the swinging shaft from the slider. The counterweight linearly reciprocates relative to the slider. When the slider and the counterweight linearly reciprocate relative to each other, dynamic balance is maintained at the time of a high-speed operation. Note that the swinging plate is driven by a drive motor.

In the grinding machine, a mass of the grindstone shaft is very large. Therefore, it is required to reduce drive energy for causing a grindstone shaft to linearly reciprocate. The grinding machine described in JP 9-11124 A functions to maintain the dynamic balance as described above, but does not function to reduce the drive energy for causing the slider to linearly reciprocate. Accordingly, an output of the drive motor cannot be reduced.

### SUMMARY

The disclosure makes it possible to appropriately perform an assist operation for walk improvement or the like with high efficiency and to reduce power consumption.

Further, the disclosure provides a swinging joint device configured to automatically adjust a rigidity of a joint that performs motion, so as to automatically adjust a torque generated by the motion, thereby making it possible to further reduce power consumption of an electric motor that moves a moving body or to further reduce a load of a user at the time of walking or running.

Further, the disclosure makes it possible to reduce drive energy that causes a linear reciprocating body to linearly reciprocate.

A first aspect of the disclosure relates to an assist device connected to a moving body that performs a reciprocating swing motion. The assist device includes a first output portion configured to swing around a swing center as a center of a swing motion; a variable rigidity device including an elastic body configured to accumulate energy and release the energy in accordance with a first swinging angle as a swinging angle of the first output portion, and a rigidity varying unit configured to change an apparent rigidity of the elastic body seen from the first output portion; a first angle detecting portion configured to detect the first swinging angle; and a control device configured to adjust the apparent rigidity of the elastic body seen from the first output portion by controlling the rigidity varying unit in accordance with the first swinging angle detected by the first angle detecting portion.

In the above aspect, the moving body may be a body of a user; the assist device may further include a body attachment member configured to be attached to the body of the user; the variable rigidity device may include a variable rigidity mechanism, and the variable rigidity mechanism includes the elastic body and is configured such that a rigidity of the variable rigidity mechanism is changed; the first output portion may be an output link; a rotation central part of the output link may be connected to the body attachment member at a predetermined position via the variable rigidity mechanism, the predetermined position corresponding to a hip joint of the user; a rotation free end of the output link may be configured to be attached to a femoral region; the rigidity varying unit may be a rigidity variable actuator configured to change an apparent rigidity of the variable rigidity mechanism seen from the output link; the first swinging angle may be a swinging angle of the output link; the first angle detecting portion may be an angle detecting portion configured to detect the swinging angle of the output link; the assist device may further include an input device configured to input an input value; the control device may control the rigidity variable actuator based on a detection angle detected by the angle detecting portion and the input value input by the input device; and the control device may change the apparent rigidity of the variable rigidity mechanism seen from the output link such that a load is applied to the femoral region in a reciprocating rotational motion of the femoral region around the hip joint, by controlling the rigidity variable actuator.

In the above configuration, the control device controls the rigidity variable actuator based on the detection angle detected by the angle detecting portion and the input value input by the input device. Further, the control device changes the apparent rigidity of the variable rigidity mechanism seen from the output link such that a load is applied to the femoral region by controlling the rigidity variable actuator. Thus, in the walking motion or the like, for example, as the walking motion deviates from the ideal walking motion (the input value), the load applied to the femoral region is increased so as to achieve walk improvement, and the like. Further, for example, a predetermined load can be applied to the femoral region in a squat and the like. Further, since an assist torque applied to the output link is controlled by changing the apparent rigidity of the variable rigidity mechanism, it is possible to reduce power consumption as compared to a conventional assist device that applies a rotating torque of a motor in a rotation direction of an output link.

In the above aspect, the reciprocating rotational motion of the femoral region around the hip joint may be a walking motion; the input device may be configured to input, to the control device, a stride central angle of the femoral region in an ideal walking motion; and the control device may be configured such that, when the stride central angle of the output link in an actual walking motion deviates from the stride central angle of the femoral region in the ideal walking motion, the control device increases the load applied to the femoral region in accordance with a deviation angle of the stride central angle of the output link. In general, at the time of walking, a user walks unconsciously such that a load applied to the femoral region becomes small. Therefore, in the walking motion, the user walks such that a stride central angle of the output link approaches a stride central angle ideal for the femoral region. That is, the user walks such that a deviation angle converges to zero. Thus, the walk of the user approaches an ideal walk, and thus, walk improvement is achieved.

In the above aspect, the input device may be configured to input, to the control device, a maximum stride angle of the femoral region in the ideal walking motion; and when a maximum stride angle of the output link in the actual walking motion is different from the maximum stride angle of the femoral region in the ideal walking motion, the control device may change the apparent rigidity of the variable rigidity mechanism seen from the output link such that the maximum stride angle of the output link approaches the maximum stride angle of the femoral region in the ideal walking motion, by controlling the rigidity variable actuator. Thus, the walk of the user approaches an ideal walk, and thus, the walk improvement is achieved.

In the above aspect, the input device may be configured to input, to the control device, a gait improvement rate that determines a degree of an influence of an angular difference on a control of the apparent rigidity of the variable rigidity mechanism seen from the output link, the angular difference being a difference between the maximum stride angle of the output link and the maximum stride angle of the femoral region in the ideal walking motion. Thus, it is possible to adjust the walk improvement in accordance with a condition of the body of the user such that the walk improvement is performed immediately or the walk improvement is performed gently.

In the above aspect, the input device may be configured to input, to the control device, a load factor that determines a degree of the load applied to the femoral region; and the control device may change the apparent rigidity of the variable rigidity mechanism seen from the output link such that the load is applied to the femoral region based on the load factor, by controlling the rigidity variable actuator. Thus, it is possible to adjust the load applied to the femoral region at the time of performing a squat and the like.

In the above aspect, the elastic body of the variable rigidity mechanism may be a spiral spring provided coaxially with a rotation center of the output link; one end of the spiral spring may be directly or indirectly connected to the rigidity variable actuator, and another end of the spiral spring is directly or indirectly connected to the output link; and the rigidity variable actuator may change the apparent rigidity of the variable rigidity mechanism seen from the output link by changing a rotation angle of the one end of the spiral spring. This makes it possible to relatively easily perform a control that changes the apparent rigidity of the variable rigidity mechanism seen from the output link.

According to the aspect of the disclosure, an assist operation for walk improvement can be appropriately performed. Further, it is possible to reduce power consumption.

In the above aspect, the moving body may be a body of a user; the assist device may further include a body attachment member configured to be attached to the body of the user; the variable rigidity device may include a variable rigidity mechanism, and the variable rigidity mechanism may include the elastic body and may be configured such that a rigidity of the variable rigidity mechanism is changed; the first output portion may be an output link; a rotation central part of the output link may be connected to the body attachment member at a predetermined position via the variable rigidity mechanism, the predetermined position corresponding to a joint of the user; a rotation free end of the output link may be configured to be attached to a part of the body, the part being rotated around the joint; the rigidity varying unit may be a rigidity variable actuator configured to change an apparent rigidity of the variable rigidity mechanism seen from the output link; the first swinging angle may be a swinging angle of the output link; the first angle detecting portion may be an angle detecting portion configured to detect the swinging angle of the output link; the assist device may further include a distance measuring portion configured to measure a distance between a position where the user receive a mass from an object and a rotation center of the output link; the control device may control the rigidity variable actuator based on a detection angle detected by the angle detecting portion and a measurement distance measured by the distance measuring portion; and the control device may change the apparent rigidity of the variable rigidity mechanism seen from the output link such that a load applied to the user is reduced, by controlling the rigidity variable actuator.

In the above configuration, the control device controls the rigidity variable actuator based on the swinging angle of the output link and the measured distance between the position where the user receives the mass from the object and the rotation center of the output link. Further, the control device changes the apparent rigidity of the variable rigidity mechanism seen from the output link such that the load applied to the user is reduced, by controlling the rigidity variable actuator. Thus, an assist torque caused due to an elastic force corresponding to the apparent rigidity of the variable rigidity mechanism is applied to the output link. That is, the control device can change the apparent rigidity of the variable rigidity mechanism seen from the output link with use of the rigidity variable actuator, during an operation of the assist device. Therefore, as compared to a conventional assist device that manually adjusts a rigidity of the elastic body, it is possible to perform an assists operation with high efficiency. Further, since an assist torque applied to the output link is controlled by changing the apparent rigidity of the variable rigidity mechanism, it is possible to reduce power consumption as compared to a conventional assist device that applies a rotating torque of a motor in a rotation direction of an output link.

In the above aspect, the distance measuring portion may include a first acceleration sensor configured to be attached to the position where the user receives the mass from the object, a second acceleration sensor configured to be attached to the rotation center of the output link, and a calculation portion configured to calculate a distance between the first acceleration sensor and the second acceleration sensor based on detection values of the first acceleration sensor and the second acceleration sensor. Thus, it is possible to consecutively measure the distance from the rotation center of the output link to the position where the user receives the mass from the object during an assist operation.

In the above aspect, the elastic body of the variable rigidity mechanism may be a spiral spring provided coaxially with the rotation center of the output link; one end of the spiral spring may be directly or indirectly connected to the rigidity variable actuator, and another end of the spiral spring may be directly or indirectly connected the output link; and the rigidity variable actuator may change the apparent rigidity of the variable rigidity mechanism seen from the output link by changing a rotation angle of the one end of the spiral spring. This makes it possible to relatively easily perform a control that changes the apparent rigidity of the variable rigidity mechanism seen from the output link.

In the above aspect, a speed reducer may be provided between the spiral spring and the output link, and the speed reducer may be configured to maintain the swinging angle of the output link such that the swinging angle of the output link is reduced at a predetermined ratio relative to a swinging angle of the other end of the spiral spring.

In the above aspect, a wrist attachment member configured to attach the first acceleration sensor to a wrist of the user may be provided. This makes it possible to reliably hold the first acceleration sensor at the position where the user receives the mass from the object.

In the above aspect, the rotation center of the output link may be held at a position corresponding to a shoulder joint of the user and the rotation free end of the output link may be attached to an upper arm. This makes it possible to reduce a load at the time when the upper arm is lifted up.

In the above aspect, the rotation center of the output link may be held at a position corresponding to a hip joint of the user and the rotation free end of the output link may be attached to a femoral region. This makes it possible to reduce a load while the user is standing up from a half-sitting posture during an operation of lifting a baggage or the like.

In the above aspect, it is possible to perform an assist operation with high efficiency. Further, it is also possible to reduce power consumption.

In the above aspect, the assist device may be a swinging joint device connected to the moving body that performs the reciprocating swing motion, the swinging joint device being configured to alternately repeat an energy accumulation mode and an energy release mode, the energy accumulation mode being a mode in which energy is accumulated in the elastic body by a motion of the moving body, and the energy release mode being a mode in which the energy accumulated in the elastic body is released so as to assist the motion of the moving body; the rigidity varying unit of the variable rigidity device may be an apparent rigidity varying unit configured to change an apparent rigidity of the elastic body seen from the first output portion; the control device may control the apparent rigidity varying unit in accordance with the first swinging angle detected by the first angle detecting portion, so as to adjust the apparent rigidity of the elastic body seen from the first output portion; and the control device may adjust the apparent rigidity of the elastic body seen from the first output portion based on the first swinging angle and at least one of i) a gravitational force applied to the moving body in accordance with the first swinging angle, ii) an inertia force applied to the moving body in accordance with the first swinging angle and a motion state of the moving body, and iii) a central position of a reciprocating swing motion locus of the first output portion.

According to the above configuration, the control device controls the apparent rigidity varying unit in accordance with the first swinging angle, so as to automatically adjust a magnitude of a torque necessary for assisting a swing motion of the moving body including the first output portion. Thus, it is possible to adjust the torque without trouble. Further, the accumulation of the energy and the release of the energy are performed alternately, so as to generate a torque necessary for supporting the swing motion. Further, the apparent rigidity of the elastic body is adjusted based on the first swinging angle and at least one of the gravitational force applied to the moving body, the inertia force applied to the moving body, and the central position of the reciprocating swing motion locus, and thus, the apparent rigidity can be controlled more appropriately. This makes it possible to further reduce the power consumption of the electric motor, for example, in a case where the moving body is caused to perform a swing motion by the electric motor or the like. Also, in a case where the moving body is a leg of a user, it is possible to further reduce a load of the user (energy for moving the leg) at the time of walking or running.

In the above aspect, the elastic body may be a flat spiral spring; one end of the flat spiral spring may be connected to a first output portion-side input-output shaft portion that is turned around a spring center as a center of the flat spiral spring at an angle in accordance with the first swinging angle of the first output portion; another end of the flat spiral spring may be connected to a rigidity adjustment member that is turned around the spring center by a rigidity adjustment electric motor; the apparent rigidity of the elastic body may be an apparent spring constant of the flat spiral spring; the apparent rigidity varying unit may be constituted by the rigidity adjustment electric motor and the rigidity adjustment member; and the apparent rigidity of the elastic body seen from the first output portion may be adjusted by adjusting a turning angle of the rigidity adjustment member by the rigidity adjustment electric motor.

In the above configuration, in a case where a flat spiral spring is used as the elastic body and the leg of the user is the moving body, for example, the apparent spring constant (rigidity) seen from the first output portion is adjusted appropriately in accordance with a motion of the user such as walking or running. When the apparent spring constant (rigidity) seen from the first output portion is adjusted in accordance with the motion of the moving body, it is possible to perform the accumulation of the energy in the flat spiral spring and the release of the energy from the flat spiral spring smoothly and appropriately.

In the above aspect, in a case where the apparent rigidity of the elastic body seen from the first output portion is adjusted based on the gravitational force and the first swinging angle, the control device may adjust the apparent rigidity of the elastic body seen from the first output portion based on a moving body mass that is a mass of the moving body including the first output portion, a moving body gravity center distance that is a distance from the swing center to a gravity center of the moving body including the first output portion, an angular frequency of swinging, gravitational acceleration, and the first swinging angle.

In the above configuration, with the use of the moving body mass, the moving body gravity center distance, the angular frequency of swinging, the gravitational acceleration, and the first swinging angle, the apparent rigidity of the elastic body is adjusted based on the gravitational force applied to the moving body and the first swinging angle. Thus, the apparent rigidity can be controlled more accurately in consideration of an influence of the gravitational force applied to the moving body.

In the above aspect, the moving body may include a femoral region of a body of a user from a hip joint to a knee, and a lower leg below the knee; the lower leg may swing relative to the femoral region around a knee center that is a knee joint; the first output portion may be connected to the femoral region; a second output portion swingable relative to the first output portion around the knee center may be connected to the first output portion at a position corresponding to the knee center; the second output portion may be connected to the lower leg and may include a second angle detecting portion configured to detect a second swinging angle, the second swinging angle being a swinging angle of the second output portion relative to the first output portion; in a case where the apparent rigidity of the elastic body seen from the first output portion is adjusted based on the gravitational force, the inertia force, and the first swinging angle, the control device may adjust the apparent rigidity of the elastic body seen from the first output portion based on i) a femoral region mass that is a mass of the femoral region including the first output portion, ii) a femoral region length that is a distance from the swing center to the knee center; iii) a femoral region gravity center distance that is a distance from the swing center to a gravity center of the femoral region including the first output portion; iv) a lower leg mass that is a mass of the lower leg including the second output portion; v) a lower leg length that is a distance from the knee center as one end of the lower leg to another end of the lower leg; vi) a lower leg gravity center distance that is a distance from the knee center to a gravity center of the lower leg including the second output portion; vii) an angular frequency of swinging of the first output portion; viii) gravitational acceleration; ix) the first swinging angle; and x) the second swinging angle.

In the above configuration, with the use of the femoral region mass, the femoral region length, the femoral region gravity center distance, the lower leg mass, the lower leg length, the lower leg gravity center distance, the angular frequency of swinging of the first output portion, the gravitational acceleration, the first swinging angle, and the second swinging angle, the apparent rigidity of the elastic body is adjusted based on the gravitational force and the inertia force applied to the femoral region and the lower leg and the first swinging angle. Thus, the apparent rigidity can be controlled more accurately in consideration of the influence of the gravitational force and the inertia force applied to the femoral region and the lower leg.

In the above aspect, in a case where the apparent rigidity of the elastic body seen from the first output portion is adjusted based on the gravitational force, the central position, and the first swinging angle, the control device may adjust the apparent rigidity of the elastic body seen from the first output portion based on i) a moving body mass that is a mass of the moving body including the first output portion; ii) a moving body gravity center distance that is a distance from the swing center to a gravity center of the moving body including the first output portion; iii) an angular frequency of swinging; iv) gravitational acceleration; v) a central angle that is an angle formed between a gravitational acceleration direction and a virtual straight line connecting the swing center to the central position; and vi) the first swinging angle.

In the above configuration, with use of the moving body mass, the moving body gravity center distance, and the angular frequency of swinging, the gravitational acceleration, the central angle, and the first swinging angle, the apparent rigidity of the elastic body is adjusted based on the gravitational force applied to the moving body, the central position, and the first swinging angle. Thus, the apparent rigidity can be controlled more accurately in consideration of the influence of the gravitational force applied to the moving body and the central position.

A second aspect of the disclosure relates to a linear motion variable rigidity unit including a linear motion-rotation conversion mechanism including a linear-motion input-output portion and a rotational motion input-output portion; a variable rigidity mechanism including an elastic body connected to the rotational motion input-output portion; a rigidity variable actuator connected to the variable rigidity mechanism; a control device configured to control the rigidity variable actuator; and a support member configured to support the linear motion-rotation conversion mechanism, the variable rigidity mechanism, and the rigidity variable actuator. The linear-motion input-output portion is connected to a linear reciprocating body that linearly reciprocates; the linear motion-rotation conversion mechanism performs an energy accumulation operation that converts a linear reciprocating motion input from the linear-motion input-output portion to a rotational reciprocating motion so as to output the rotational reciprocating motion from the rotational motion input-output portion, and an energy release operation that converts the rotational reciprocating motion input from the rotational motion input-output portion to the linear reciprocating motion so as to output the linear reciprocating motion from the linear-motion input-output portion; in a case where the linear motion-rotation conversion mechanism performs the energy accumulation operation, the elastic body in the variable rigidity mechanism accumulates input energy that is input from the rotational motion input-output portion via the linear-motion input-output portion, the input energy being energy from the linear reciprocating body; and in a case where the linear motion-rotation conversion mechanism performs the energy release operation, the elastic body releases accumulated energy that is energy accumulated in the elastic body, toward the linear reciprocating body via the rotational motion input-output portion and the linear-motion input-output portion; and the rigidity variable actuator changes a rigidity of the elastic body of the variable rigidity mechanism seen from the linear motion-rotation conversion mechanism.

In the above configuration, a kinetic energy at the time when the linear reciprocating body linearly reciprocates is released again to the linear reciprocating body itself. Thus, the linear reciprocating motion of the linear reciprocating body is assisted efficiently. Accordingly, for example, drive energy of the driving device, which is required to cause the linear reciprocating body to linearly reciprocate, is reduced. Note that the kinetic energy at the time when the linear reciprocating body linearly reciprocates is accumulated in the elastic body. The apparent rigidity of the elastic body (the rigidity seen from the linear motion-rotation conversion mechanism) can be changed by the rigidity variable actuator. Accordingly, when the apparent rigidity of the elastic body is adjusted, the drive energy of the drive device, which is required to cause the linear reciprocating body to linearly reciprocate, is reduced.

In the above aspect, the elastic body may be a spiral spring; one end of the spiral spring may be connected to the rotational motion input-output portion and another end of the spiral spring may be connected to the rigidity variable actuator; and the rigidity variable actuator may be configured to turn the spiral spring around a central axis of the spiral spring so as to change an apparent spring constant seen from the linear motion-rotation conversion mechanism, the apparent spring constant being a rigidity of the spiral spring seen from the linear motion-rotation conversion mechanism.

In the above configuration, when one end of the spiral spring is turned by the rigidity variable actuator, the apparent spring constant seen from the variable rigidity mechanism is changed easily.

In the above aspect, the control device may change the apparent spring constant in real time by controlling the rigidity variable actuator to reduce drive energy that causes the linear reciprocating body to linearly reciprocate, based on a mass of the linear reciprocating body, an angular frequency at which the rotational motion input-output portion rotates in a reciprocating manner, and a current rotation angle of the rotational motion input-output portion.

In the above configuration, since the apparent spring constant is changed in real time, the drive energy for causing the linear reciprocating body to linearly reciprocate is constantly reduced.

In the above aspect, the linear-motion input-output portion and the rotational motion input-output portion in the linear motion-rotation conversion mechanism may be constituted by a screw shaft member and a nut fitted to the screw shaft member or a rack and a pinion fitted to the rack. An axis direction of the screw shaft member or a longitudinal direction of the rack may be set to be a reciprocating motion direction in which the linear reciprocating body reciprocates. The screw shaft member or the rack may linearly reciprocate together with the linear reciprocating body without rotating. The nut or the pinion may be supported by a support member so as to be rotatable without moving in the reciprocating motion direction.

In the above configuration, the linear motion-rotation conversion mechanism is realized by the screw shaft member and the nut or the rack and the pinion, that is, the linear motion-rotation conversion mechanism is realized by the simple configuration.

In the above aspect, the linear motion-rotation conversion mechanism may be constituted by a plurality of link members, a given position in a predetermined link member may serve as the linear-motion input-output portion, and a given position in a link member different from the predetermined link member may serve as the rotational motion input-output portion.

In the above configuration, the linear motion-rotation conversion mechanism is realized by a link mechanism, that is, the linear motion-rotation conversion mechanism is realized by the simple configuration.

A third aspect of the disclosure relates to a machine tool including the linear motion variable rigidity unit according to the second aspect; a reciprocation table as the linear reciprocating body that linearly reciprocates at a predetermined frequency; and a table drive device configured to cause the reciprocation table to linearly reciprocate. The linear motion variable rigidity unit is attached to the reciprocation table.

In the above configuration, the drive energy of the table drive device, which is required to cause the reciprocation table to linearly reciprocate, is reduced by the linear motion variable rigidity unit.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic side view illustrating a usage state of an assist device according to Embodiment 1 of the disclosure;

FIG. 2 is a schematic front view illustrating an output link, a variable rigidity mechanism, and so on of the assist device;

FIG. 3 is a schematic exploded perspective view illustrating the output link, the variable rigidity mechanism, and so on of the assist device;

FIG. 4 is a wiring block diagram of the assist device;

FIG. 5 is a drawing illustrating an output waveform of an angle detector of the assist device;

FIG. 6 is a drawing illustrating a method for detecting a walking frequency from the output waveform of the angle detector;

FIG. 7 is a schematic view illustrating a maximum stride angle and a stride central angle of the output link (a femoral region) at the time of an actual walking motion, and a maximum stride angle and a stride central angle of the femoral region at the time of an ideal walking motion;

FIG. 8 is a schematic enlarged view illustrating the output link of the assist device and a distance from a rotation center to a gravity center of a leg;

FIG. 9 is a schematic exploded perspective view illustrating the variable rigidity mechanism, and so on;

FIG. 10 is a flowchart illustrating an operation of the assist device;

FIG. 11 is a flowchart illustrating an operation of an assist device according to Embodiment 2 of the disclosure;

FIG. 12 is a schematic side view illustrating a usage state of an assist device according to Embodiment 3 of the disclosure;

FIG. 13 is a schematic plan view (a view seen along a line XIII-XIII in FIG. 12) illustrating an output link, a variable rigidity mechanism, and so on of the assist device;

FIG. 14 is a schematic exploded perspective view illustrating the output link, the variable rigidity mechanism, and so on of the assist device;

FIG. 15 is a wiring block diagram of the assist device;

FIG. 16 is a schematic side view illustrating a usage state of the assist device;

FIG. 17 is a schematic enlarged view illustrating the output link and so on of the assist device;

FIG. 18 is an exploded perspective view illustrating the variable rigidity mechanism and so on of the assist device;

FIG. 19 is a schematic side view illustrating a usage state of an assist device according to Embodiment 4 of the disclosure;

FIG. 20 is a side view used to calculate a virtual mass mₕ and an inertia moment J_{B} in the usage state of the assist device;

FIG. 21 is an exploded perspective view illustrating an outline shape and an assembling position of each constituent constituting a swinging joint device;

FIG. 22 is a perspective view of the swinging joint device constituted by assembling the constituents illustrated in FIG. 21;

FIG. 23 is a view illustrating a state where the swinging joint device illustrated in FIG. 22 is attached to a user (an arm of the user is not illustrated);

FIG. 24 is a view illustrating an example of a swinging state of a femoral swinging arm (a first output portion) and swinging of a lower leg swinging arm (a second output portion);

FIG. 25 is an enlarged view of a part V in FIG. 21 and is an exploded perspective view illustrating a configuration of a flat spiral spring and an apparent spring constant variable portion;

FIG. 26 is a view seen from a VI direction in FIG. 22 and is a view illustrating an arrangement of members provided coaxially with a drive axis of a drive shaft member;

FIG. 27 is a view seen in an XXVII direction in FIG. 26 and is a view illustrating a state where a changed swinging angle of a transmission output shaft member of a transmission is amplified at a predetermined speed changing ratio relative to a first swinging angle of the femoral swinging arm;

FIG. 28 is a perspective view illustrating a state where an urging torque is not generated in a flat spiral spring in a case where the swinging angle of the femoral swinging arm is zero and also illustrating a reference position of a spring support (that is, a spring fixed end) relative to the drive shaft;

FIG. 29 is a view illustrating a state where the position of the spring support relative to the drive axis is moved from the reference position by turning a rigidity adjustment member by a predetermined turning angle from the state of FIG. 28;

FIG. 30 is a view illustrating a vicinal area around a free end and a fixed end of the flat spiral spring when the femoral swinging arm swings forward from the state of FIG. 29;

FIG. 31 is a view illustrating the vicinal area around the free end and the fixed end of the flat spiral spring when the femoral swinging arm swings rearward from the state of FIG. 29;

FIG. 32 is a view illustrating input and output of a controlling portion;

FIG. 33 is a flowchart illustrating an example of a procedure of Embodiment 5 (in consideration of an influence of a gravitational force);

FIG. 34 is a schematic view illustrating Embodiment 5 (in consideration of the influence of the gravitational force);

FIG. 35 is a view illustrating an example of an energy reduction effect by Embodiment 5;

FIG. 36 is a flowchart illustrating an example of a procedure of Embodiment 6 (in consideration of an influence of a gravitational force and an influence of a change of inertia moment);

FIG. 37 is a schematic view illustrating Embodiment 6 (in consideration of the influence of the gravitational force and the influence of the change of inertia moment);

FIG. 38 is a view illustrating an example of the change of inertia moment in Embodiment 6;

FIG. 39 is a view illustrating an example of an energy reduction effect by Embodiment 6;

FIG. 40 is a flowchart illustrating an example of a procedure of Embodiment 7 (in consideration of an influence of a gravitational force and an influence of a central position of a reciprocating swing motion locus);

FIG. 41 is a schematic view illustrating Embodiment 7 (in consideration of the influence of the gravitational force and the influence of the central position of the reciprocating swing motion locus);

FIG. 42 is a perspective view of a grinding machine including a linear motion variable rigidity unit according to Embodiment 8;

FIG. 43 is a side view of the grinding machine including the linear motion variable rigidity unit according to Embodiment 8;

FIG. 44 is a side view illustrating the linear motion variable rigidity unit according to Embodiment 8 with use of a partial section;

FIG. 45 is a perspective view illustrating some component parts of the linear motion variable rigidity unit according to Embodiment 8;

FIG. 46 is a perspective view illustrating the component parts illustrated in FIG. 45 in a disassembled state;

FIG. 47 is a front view of a spiral spring in a free state;

FIG. 48 is a front view of a spiral spring, FIG. 48 illustrating a state where an inner end of the spiral spring is turned from the state of FIG. 47;

FIG. 49 is a front view of the spiral spring, FIG. 49 illustrating a state where a rigidity variable actuator is driven from the state of FIG. 48;

FIG. 50 is a front view of the spiral spring, FIG. 50 illustrating a state where the rigidity variable actuator is driven from the state of FIG. 48;

FIG. 51 is a top view of a grinding machine including a linear motion variable rigidity unit according to Embodiment 9;

FIG. 52 is a side view of the grinding machine including the linear motion variable rigidity unit according to Embodiment 9;

FIG. 53 is a top view of a grinding machine including a linear motion variable rigidity unit according to Embodiment 10;

FIG. 54 is a side view of the grinding machine including the linear motion variable rigidity unit according to Embodiment 10;

FIG. 55 is a perspective view illustrating an example in which the linear motion variable rigidity unit is applied to a machining center; and

FIG. 56 is a side view illustrating an example in which the linear motion variable rigidity unit is applied to the machining center.

### DETAILED DESCRIPTION OF EMBODIMENTS

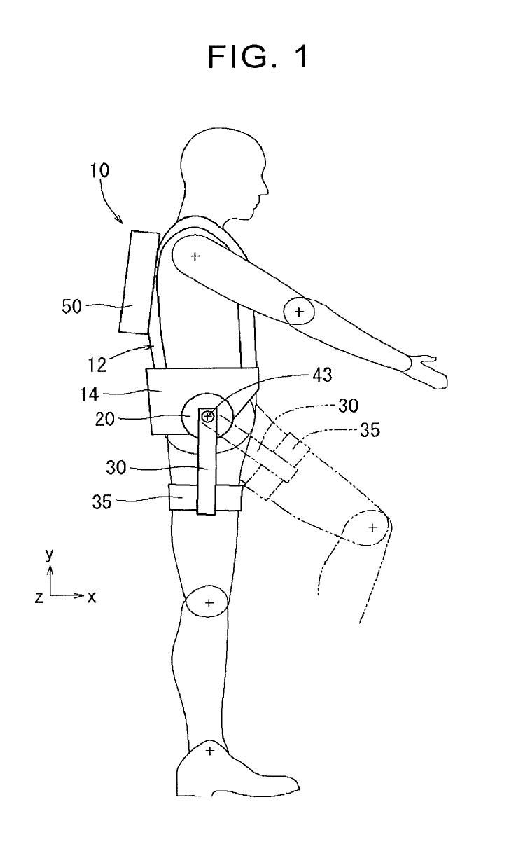

The following describes an assist device 10 according to Embodiment 1 of the disclosure based on FIGS. 1 to 10. The assist device 10 according to the present embodiment is a device that assists walk improvement of a user. Here, an x-direction, a y-direction, and a z-direction illustrated in the figures correspond to a forward direction, an upward direction, and a right-left direction with respect to a user who wears the assist device 10.

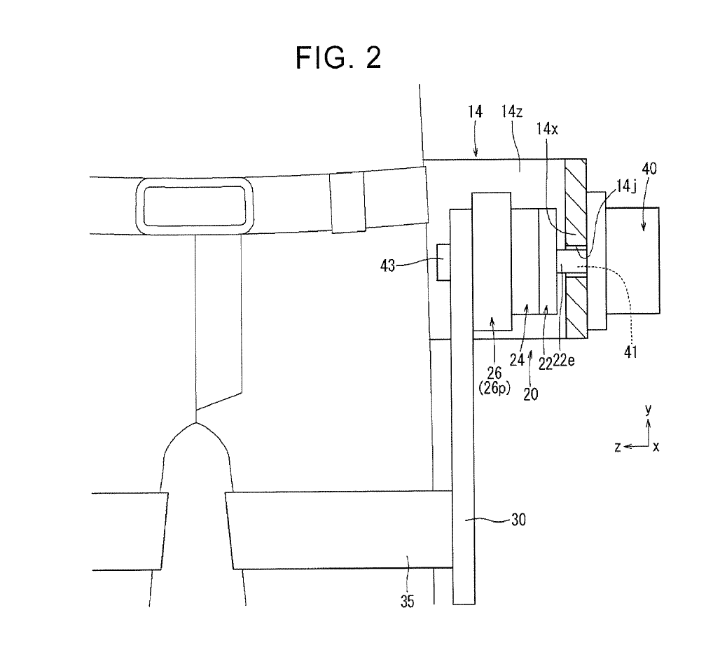

As illustrated in FIG. 1, the assist device 10 includes: an upper-body attachment member 12 put on an upper body and a lumbar part of a user; and a support frame portion 14 provided around a part of the upper-body attachment member 12 which corresponds to the lumbar part. As illustrated in FIG. 2, the support frame portion 14 includes: a back-face plate portion 14z provided so as to extend in the right-left direction on a back face of the upper-body attachment member 12; and side plate portions 14x provided on right and left sides of the back-face plate portion 14z so as to extend at substantially right angles with respect to the back-face plate portion 14z. As illustrated in FIG. 2, the right and left side plate portions 14x of the support frame portion 14 are each configured such that a shaft receiving hole 14j is formed at a position corresponding to a hip joint of the user, that is, at the substantially same position as the hip joint of the user in x,y-directions.

As illustrated in FIG. 2, a pair of right and left variable rigidity mechanisms 20 (described later) is provided inside right and left corners between the back-face plate portion 14z and the side plate portions 14x of the support frame portion 14. The variable rigidity mechanism 20 is provided along the z-direction, and an input shaft 22e of the variable rigidity mechanism 20 is passed through the shaft receiving hole 14j of the side plate portion 14x of the support frame portion 14. A rotating shaft 41 of a motor 40 fixed to an outer side of the side plate portion 14x of the support frame portion 14 is coaxially connected to the input shaft 22e of the variable rigidity mechanism 20. That is, the variable rigidity mechanism 20 is supported by the support frame portion 14 in a rotatable state around an axial center of the input shaft 22e.

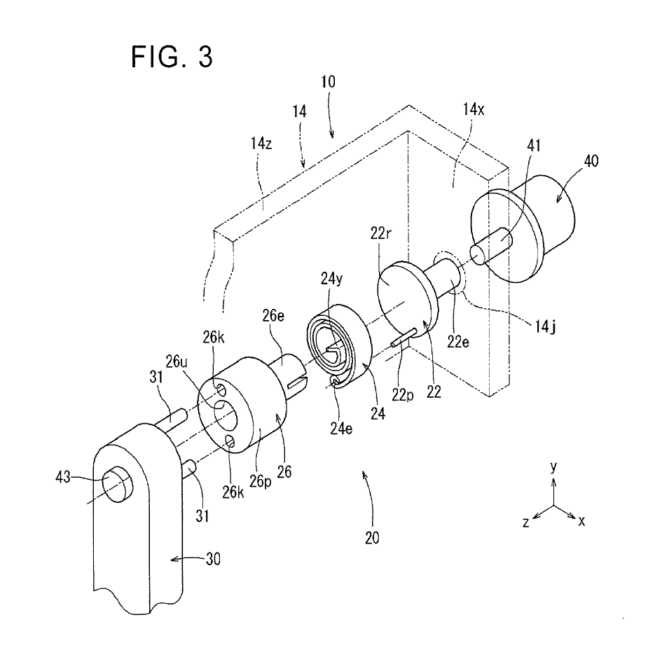

Further, as illustrated in FIGS. 2, 3, a base end (a rotation central part) of a bar-shaped output link 30 is connected to an output rotating shaft 26p of the variable rigidity mechanism 20 in a relatively non-rotatable state. That is, the rotation central part of the output link 30 is connected to a position of the shaft receiving hole 14j of the support frame portion 14, which corresponds to the hip joint of the user, via the variable rigidity mechanism 20 so as to be rotatable in an up-down direction. The output link 30 is a link disposed along an outer surface of a femoral region of the user, and is configured such that a distal end (a rotation free end) of the output link 30 is attached to the femoral region of the user by a femoral attachment member 35. This allows the output link 30 to rotate in the up-down direction together with the femoral region. That is, the upper-body attachment member 12 and the support frame portion 14 may be regarded as a body attachment member in the disclosure.

As illustrated in FIGS. 2, 3, and the like, an angle detector 43 configured to detect a swinging angle of the output link 30 is attached to the rotation central part of the output link 30. Further, as illustrated in FIG. 1 and the like, the assist device 10 includes a control box 50 attached to the back face of the upper-body attachment member 12.

The variable rigidity mechanism 20 is a mechanism configured such that an apparent rigidity thereof seen from the output link 30 can be changed, and includes an input portion 22, a spiral spring 24, and a speed reducer 26 as illustrated in FIG. 3. The input portion 22 is a part configured to transmit a rotation of the motor 40 to the spiral spring 24. The input portion 22 includes: an input shaft 22e to which the rotating shaft 41 of the motor 40 is connected in a relatively non-rotatable state; a circular plate portion 22r provided coaxially with the input shaft 22e; and a torque transmission shaft 22p provided on a peripheral edge of the circular plate portion 22r at a position on a side opposite to the input shaft 22e. The torque transmission shaft 22p of the input portion 22 is connected to an outer-peripheral-side spring end portion 24e of the spiral spring 24.

As illustrated in FIG. 3, the spiral spring 24 of the variable rigidity mechanism 20 is a spring obtained by forming a belt-shaped leaf spring in a spiral shape, and includes spring end portions 24y, 24e on a central side and on an outer peripheral side. The spiral spring 24 is configured such that a spring force is adjusted by changing a swinging angle of the outer-peripheral-side spring end portion 24e relative to the central-side spring end portion 24y. Here, a spring constant of the spiral spring 24 is set to k₁, for example. As described above, the outer-peripheral-side spring end portion 24e of the spiral spring 24 is connected to the torque transmission shaft 22p of the input portion 22 in a relatively non-rotatable state. Further, the central-side spring end portion 24y of the spiral spring 24 is connected to an input rotating shaft 26e of the speed reducer 26 in a relatively non-rotatable state. Here, the input portion 22 and the input rotating shaft 26e of the speed reducer 26 are maintained coaxially. That is, the spiral spring 24 may be regarded as an elastic body of the disclosure.

The speed reducer 26 is a member configured to amplify a rotating torque caused due to the spring force of the spiral spring 24, and transmit the amplified rotating torque to the output link 30. The speed reducer 26 includes the input rotating shaft 26e, the output rotating shaft 26p, a gear mechanism (not shown) provided between the input rotating shaft 26e and the output rotating shaft 26p, and the like. The input rotating shaft 26e and the output rotating shaft 26p of the speed reducer 26 are maintained coaxially, and when the input rotating shaft 26e rotates “n” times, the output rotating shaft 26p rotates once. Further, a torque transfer efficiency of the speed reducer 26 is set to η.

A positioning hole 26u to which a rotation center pin (not shown) of the output link 30 is fitted is formed in a center of the output rotating shaft 26p of the speed reducer 26 as illustrated in FIG. 3. Further, rotation-stop holes 26k to which rotation-stop pins 31 of the output link 30 are inserted are formed around the positioning hole 26u of the output rotating shaft 26p. Thus, the output link 30 can rotate integrally with the output rotating shaft 26p of the speed reducer 26.

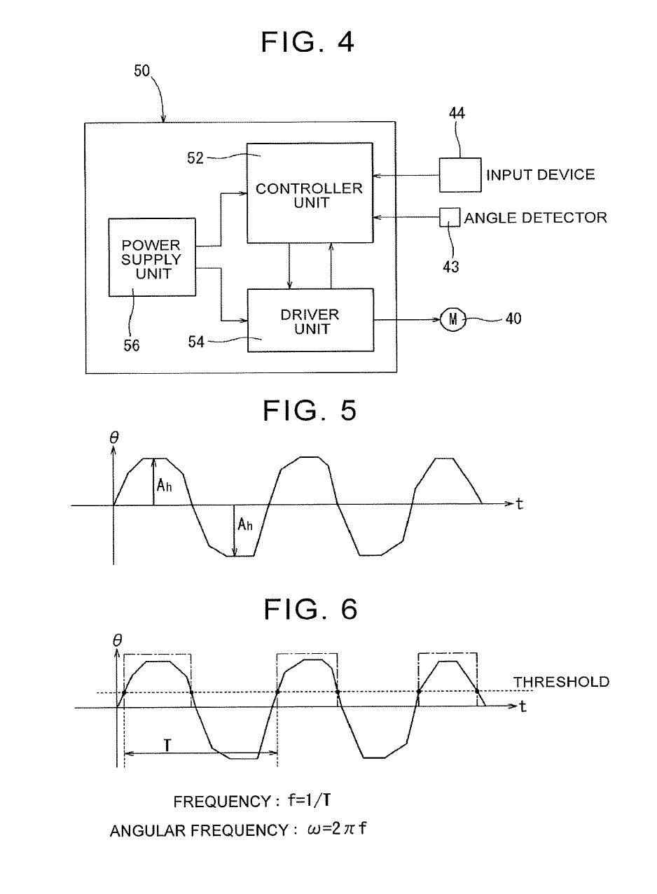

As illustrated in FIG. 1, the control box 50 is a box attached to the back face of the upper-body attachment member 12. As illustrated in FIG. 4, the control box 50 accommodates a controller unit 52, a driver unit 54, and a power supply unit 56 therein. The controller unit 52 is a unit configured to control a rotation angle θ₁ of the motor 40. The driver unit 54 is a unit configured to drive the motor 40, and the driver unit 54 operates based on a signal from the controller unit 52. The power supply unit 56 is a unit configured to supply electric power to the controller unit 52 and the driver unit 54.

As illustrated in FIG. 4, a signal of the angle detector 43 that detects a swinging angle θ of the output link 30 is input into the controller unit 52. An angle signal of the angle detector 43, namely, a signal indicative of the swinging angle θ of the output link 30 is expressed as a function of time t illustrated in FIG. 5 in the controller unit 52. As illustrated in FIG. 6, in the controller unit 52, a predetermined threshold is set, and a walking period T of the user is obtained from a difference between a time at which the signal indicative of the swinging angle θ of the output link 30 becomes larger than the predetermined threshold and a time at which the signal indicative of the swinging angle θ of the output link 30 becomes smaller than the predetermined threshold. Then, a walking frequency “f” of the user is calculated from an inverse (1/T) of the walking period T, so as to obtain an angular frequency ω(ω=2πf) from the walking frequency “f”.

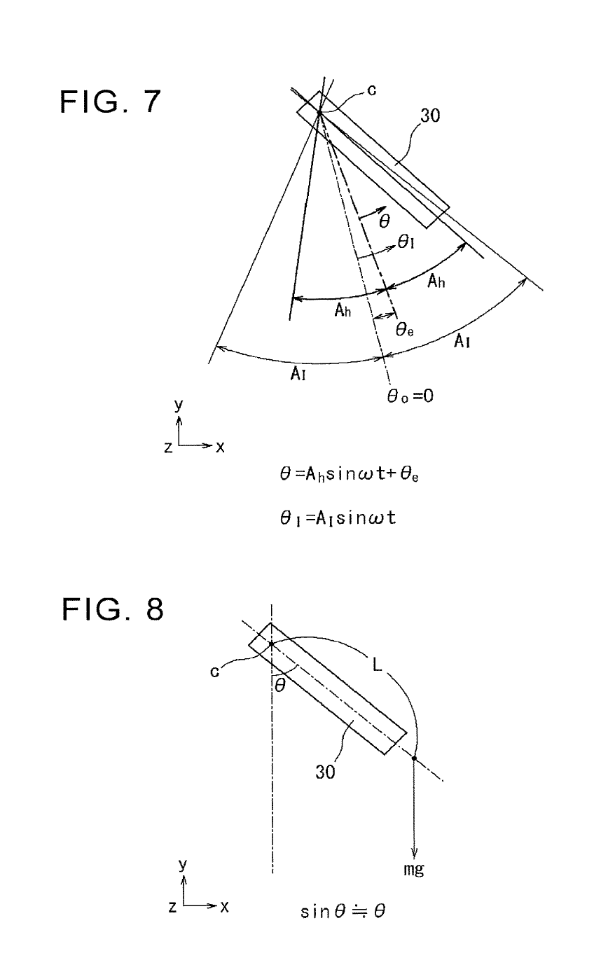

Further, as illustrated in FIG. 4, a value used for walk improvement of the user is input into the controller unit 52 from an input device 44 such as a keyboard or a dial. That is, as illustrated in FIG. 7, an ideal maximum stride angle A_{I} of the femoral region in a walking motion and an ideal angle θ₀ of a stride center (a stride central angle θ₀ (a neutral point)) of the femoral region are input to the controller unit 52 from the input device 44. Here, the stride central angle θ₀ is approximately 5° forward relative to a vertical line in general. However, in calculation of an assist torque τ (described later) applied to the output link 30, the stride central angle θ₀ is regarded as zero (θ₀=0) for convenience.

Further, the input device 44 is configured to input a gait improvement rate ε to the controller unit 52. The gait improvement rate ε is a coefficient multiplied by a difference (Aₕ−A_{I}) between an actual maximum stride angle Aₕ of the femoral region (a maximum stride angle Aₕ of the output link 30) and the ideal maximum stride angle A_{I} (see FIG. 7) of the femoral region. Here, the maximum stride angle Aₕ of the output link 30 can be obtained from the swinging angle θ of the output link 30, detected by the angle detector 43 (see FIG. 5). The gait improvement rate ε is a value set in a range of 0≦ε≦1 and is used to determine an amplitude correction gain α.

The amplitude correction gain α is expressed as α=({1−ε(Aₕ−A_{I})÷Aₕ}, and is used for calculating the assist torque τ (described later) applied to the output link 30. For example, at the time of the gait improvement rate ε=0, the walk improvement relative to the difference (Aₕ−A_{I}) in the maximum stride angle is not performed, and the amplitude correction gain α=1 is obtained. Further, at the time of the gait improvement rate ε=1, the maximum walk improvement relative to the angular difference (Aₕ−A_{I}) in the maximum stride angle is performed, and the amplitude correction gain α=A_{I}+Aₕ is obtained.

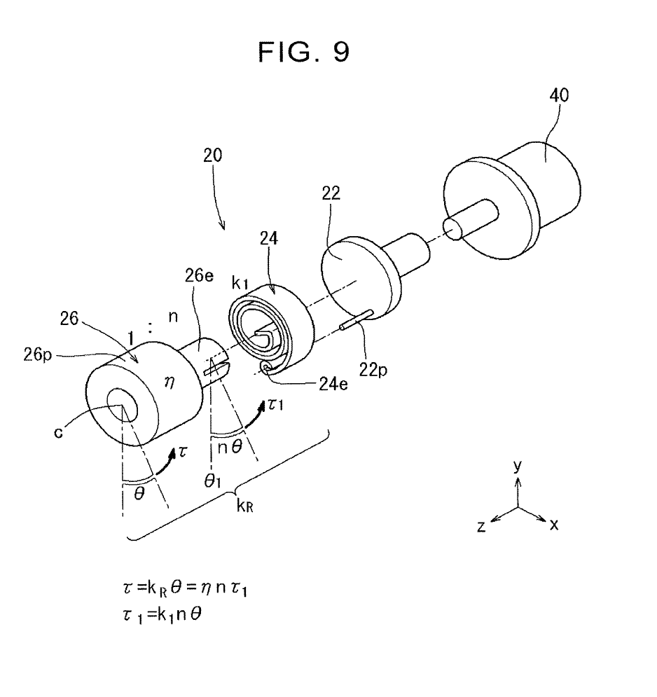

The controller unit 52 controls a rotation angle θ₁ of the motor 40 based on the detection value of the angle detector 43 and the input value from the input device 44 at the time of the walking motion of the user (described later). When the rotating shaft 41 of the motor 40 rotates by an angle θ₁, the outer-peripheral-side spring end portion 24e of the spiral spring 24 of the variable rigidity mechanism 20 also rotates by the angle θ₁, as illustrated in FIG. 9. Thus, an apparent rigidity k_{R} of the variable rigidity mechanism 20 seen from the output link 30 changes, and thus, a rotating torque τ (hereinafter referred to as the assist torque τ) applied to the output link 30 from the output rotating shaft 26p of the variable rigidity mechanism 20 is controlled. That is, the controller unit 52 may be regarded as a control device of the disclosure, and the motor 40 may be regarded as a rigidity variable actuator. Further, the angle detector 43 may be regarded as an angle detecting portion of the disclosure, and the input device 44 may be regarded as an input portion of the disclosure.

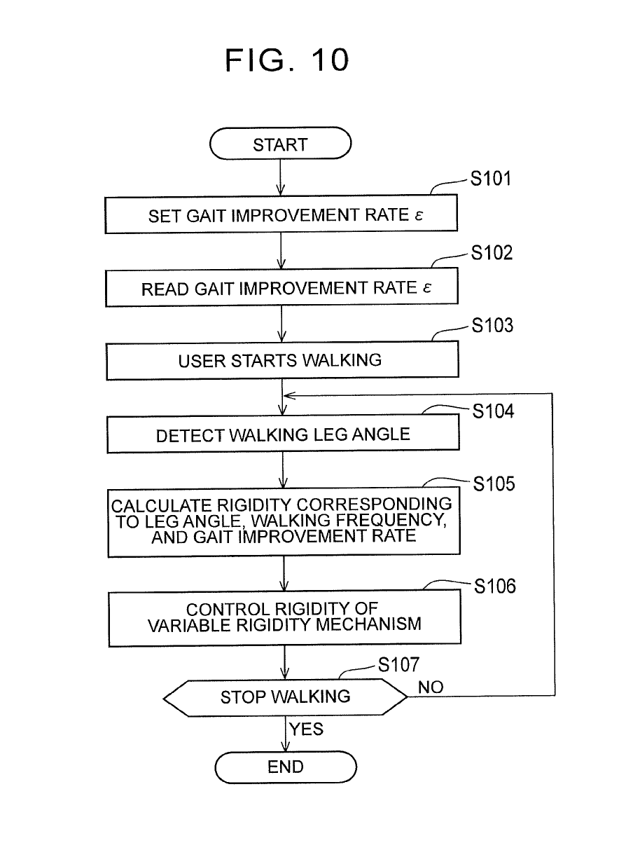

Next will be described an operation of the assist device 10 based on a flowchart of FIG. 10. Here, a process illustrated in the flowchart of FIG. 10 is performed based on a program stored in a memory (not shown) of the controller unit 52. Further, constants used for calculation or the like of the rotation angle θ₁ of the motor 40, that is, the ideal maximum stride angle A_{I} and the ideal stride central angle θ₀ of the femoral region in the walking motion are input into the controller unit 52 from the input device 44 in advance. Similarly, a mass “m” of a leg of the user, a gravity center of the leg, an inertia moment J of the leg around the hip joint, a viscosity “d” of the leg in a rotating operation, and the like are input into the controller unit 52 from the input device 44 in advance.

Before walking, a gait improvement rate ε is set first (step S101), and the gait improvement rate ε is input into the controller unit 52 from the input device 44 (step S102). Then, when a user starts walking (step S103), a signal of the angle detector 43 that detects a swinging angle of the output link 30 is input into the controller unit 52 (step S104). Thus, as illustrated in FIG. 6, the controller unit 52 obtains a walking period T with the use of the predetermined threshold, and further obtains a walking frequency “f” and an angular frequency ω. Subsequently, the controller unit 52 calculates an apparent rigidity k_{R} (an angle θ₁ of the rotating shaft 41 of the motor 40) of the variable rigidity mechanism 20, the apparent rigidity k_{R} corresponding to the swinging angle θ of the output link 30, the walking frequency “f”, the gait improvement rate ε, and the like (step S105). Note that a specific calculation method for the angle θ₁ of the rotating shaft 41 of the motor 40 will be described later. Then, the apparent rigidity k_{R} of the variable rigidity mechanism 20 is controlled, so as to adjust an assist torque τ (τ=k_{R}θ) applied to the output link 30 (step S106). The process from step S104 to step S106 is performed repeatedly during the walking. When the walking is finished (step S107), the assist device 10 enters an operation completed state (END).

Subsequently, with reference to FIGS. 8, 9, and the like, a specific calculation procedure for the angle θ₁ of the rotating shaft 41 of the motor 40 is described. Here, FIG. 8 is a view schematically illustrating a state where the femoral region and the output link 30 rotate upward by an angle θ in an actual walking motion. Note that a reference sign “c” indicates the hip joint of the user and the rotation center of the output link 30, and L indicates a distance from the rotation center “c” to a gravity center of the leg. Therefore, a torque caused due to a mass “m” of the leg around the rotation center “c” is expressed by mg×L×sin θ. Due to the rotation of the output link 30, the output rotating shaft 26p of the variable rigidity mechanism 20 rotates by the angle θ as illustrated in FIG. 9. As a result, an assist torque τ caused due to the apparent rigidity k_{R} of the variable rigidity mechanism 20 is applied to the rotation center “c” of the output link 30. The assist torque τ is expressed as τ=k_{R}×θ.

Further, a torque caused due to an inertia moment J around the hip joint is expressed as a value shown in Expression 1.

J\ddot{θ} Expression 1

A torque caused due to a viscosity “d” around the hip joint is expressed as a value shown in Expression 2.

\ddot{d}θ Expression 2

Therefore, a motion torque τ_{H} required at the time when the femoral region and the output link 30 rotate upward by the angle θ is expressed as Expression 3.

τ_{H}=J\ddot{θ}+d\ddot{θ}+k_{R}θ+mgL sin θ Expression 3

Here, when the angle θ is small, sine in Expression 3 is expressed as shown in Expression 4.

sin θ⇄θ Expression 4

Therefore, when a value of Expression 4 is substituted into Expression 3 so as to transform Expression 3, the torque τ_{H} is expressed as an expression shown in Expression 5.

τ_{H}=J\ddot{θ}+d\dot{θ}+(k_{R}+mgL)θ Expression 5

Here, the angle θ (hereinafter referred to as the angle θ of the output link 30) of the femoral region and the output link 30 at the time when the user performs the walking motion can be approximated to a sine curve as illustrated in FIG. 5. That is, the angle θ of the output link 30 can be expressed as θ=Aₕ×sin ωt+θₑ. Here, as illustrated in FIG. 7, Aₕ indicates the maximum stride angle of the output link 30 in an actual walking motion, and θₑ indicates the stride central angle of the output link 30. Further, the maximum stride angle A_{I} and the stride central angle θ₀ of the femoral region in an ideal walking motion at the same walking frequency “f” are input into the controller unit 52 in advance as described above. Therefore, when the stride central angle θ₀ is zero (θ₀=0), an angle θ₁ of the femoral region in the ideal walking motion at the same walking frequency “f” is as follows. That is, the angle θ₁ is expressed as θ₁=A_{I}×sin ωt.

Here, as illustrated in FIG. 7, a stride central angle θₑ of the output link 30 in the actual walking motion indicates a deviation angle between the stride central angle θ, of the output link 30 and an ideal stride central angle θ (θ₀=0). Further, the maximum stride angle Aₕ of the output link 30 can be expressed as a sum of the maximum stride angle A_{I} of the ideal walking motion and an angular difference Aₑ. That is, the maximum stride angle Aₕ is expressed as Aₕ=(A_{I}+Aₑ).

When the angle θ₁ of the femoral region in the ideal walking motion, i.e., θ₁=A_{I}×sin ωt, is substituted into Expression 5, a motion torque τ_{S} of the leg in an ideal walking state is obtained. That is, the motion torque τ_{S} is expressed as follows:

τ_{S}=−A_{I}JΩ²×sin ωt+A_{I}d×cos ωt+A₁×(k_{R}+mgL)×sin ωt

When this expression is transformed, the following expression is obtained:

τ_{S}=A_{I}×(k_{R}+mgL−Jω²)×sin ωt+A_{I}d×cos ωt

Thus, when the apparent rigidity k_{R} of the variable rigidity mechanism 20 seen from the output link 30 is adjusted so as to be Jω²−mgL, the motion torque τ_{S} of the leg in the ideal walking state satisfies τ_{S}=A_{I}d×cos ωt, so that a load applied to the femoral region is minimized.

Subsequently, an angle θ of the output link 30 at the time when the user actually performs a walking motion, namely, θ=Aₕ×sin ωt+θₑ=(A_{I}+Aₑ)×sin ωt+θₑ is substituted into Expression 5, a motion torque τ_{H} of the leg in an actual walking state is obtained as follows:

τ_{H}=−(A_{I}+Aₑ)Jω²×sin ωt+(A_{I}+Aₑ)d×cos ωt+(k_{R}+mgL)×{(A_{I}+Aₑ)×sin ωt+θₑ}

When this expression is transformed, the following expression is obtained:

τ_{H}=(A_{I}+Aₑ)×(k_{R}+mgL−Jω)×sin ωt+(A_{I}+Aₑ)d×cos ωt+(k_{R}+mgL)×θₑ

Here, when the apparent rigidity k_{R} of the variable rigidity mechanism 20 seen from the output link 30 is adjusted so as to be Jω²−mgL, the motion torque τ_{H} of the leg in the actual walking state satisfies τ_{H}=(A_{I}+Aₑ)d×cos ωt+(k_{R}+mgL)×θₑ, so that a load applied to the femoral region is minimized.

Further, as described above, the motion torque τₛ of the leg in the ideal walking state is expressed as τ_{S}=A_{I}d×cos ωt, and thus, the motion torque τ_{H} of the leg in the actual walking state is expressed with the motion torque τ_{S} of the leg in the ideal walking state as follows:

τ_{H}=τ_{S}+Aₑd×cos ωt+(k_{R}+mgL)×θₑ

Here, Aₑd×cos ωt is a very small value and can be regarded as substantially zero. Thus, the motion torque τ_{H} of the leg in the actual walking state is expressed as τ_{H}=τ_{S}+(k_{R}+mgL)×θₑ. Thus, even when the apparent rigidity k_{R} of the variable rigidity mechanism 20 seen from the output link 30 is adjusted to Jω²−mgL, the motion torque τ_{H} of the leg in the actual walking state is a value larger than the motion torque τₛ of the leg in the ideal walking state by (k_{R}+mgL)×θₑ.

That is, when the stride central angle θₑ of the output link 30 in the actual walking motion state deviates from the stride central angle θ₀(θ₀=0) in the ideal walking state by the angle θₑ as illustrated in FIG. 7, a load applied to the femoral region increases in accordance with the deviation angle θₑ. Here, at the time of walking, the user walks unconsciously such that a load applied to the femoral region becomes small. Because of this, the user walks such that the stride central angle of the output link approaches an ideal stride central angle of the femoral region, that is, the deviation angle θₑ decreases to zero. Therefore, the walk of the user approaches an ideal walk, and thus, walk improvement is achieved.

Next will be described a procedure for expressing the apparent rigidity k_{R} of the variable rigidity mechanism 20 seen from the output link 30 (hereinafter referred to as the apparent rigidity k_{R}) with the use of the spring constant k₁ of the spiral spring 24 and the rotation angle θ₁ of the motor 40. As illustrated in FIG. 9, a speed reducing ratio of the speed reducer 26 is n:1, and therefore, when the output link 30 and the output rotating shaft 26p of the speed reducer 26 rotate by an angle θ, the input rotating shaft 26e of the speed reducer 26 rotates by nθ. Therefore, a torque τ₁ applied to the input rotating shaft 26e of the speed reducer 26 in a state where the output link 30 and the like rotate by the angle θ is expressed as k₁×nθ, where k₁ is the spring constant of the spiral spring 24. That is, τ₁=k₁×nθ is obtained. Further, since the speed reducing ratio of the speed reducer 26 is n:1 and the efficiency is η, a rotating torque τ applied to the output rotating shaft 26p of the speed reducer 26 is expressed as τ=ηnτ₁=ηn(k₁×nθ). The rotating torque τ applied to the output rotating shaft 26p of the speed reducer 26 is the assist torque τ applied to the output link 30, and is expressed as τ=k_{R}θ, as described above. Therefore, the apparent rigidity k_{R} of the variable rigidity mechanism 20 is expressed as k_{R}=ηn²k₁.

Now a case is assumed where a neutral point of the variable rigidity mechanism 20 (the spiral spring 24) seen from a motor 40-side is rotated by the motor 40 by an angle θ₁. In this case, a torque τ₁ applied to the input rotating shaft 26e of the speed reducer 26 in a state where the output link 30 and the like rotate by an angle θ is expressed as τ₁=k₁×(nθ−θ₁). Therefore, an assist torque τ₁ applied to the output rotating shaft 26p of the speed reducer 26 can be expressed as τ=ηnτ₁=ηnk₁(nθ−θ₁)=ηn²k₁(1−θ₁/nθ)×θ. Accordingly, the apparent rigidity k_{R} of the variable rigidity mechanism 20 is expressed as k_{R}=ηn²k₁(1−θ₁/nθ). That is, by controlling the rotation angle θ₁ of motor 40, the apparent rigidity k_{R} of the variable rigidity mechanism 20 can be changed, and thus, the assist torque τ can be controlled.

Next will be described a method for performing walk improvement with the use of the gait improvement rate ε and the amplitude correction gain α. Here, the amplitude correction gain α is expressed as α=({1−ε(Aₕ−A_{I})÷Aₕ} as described above. The amplitude correction gain α is used in an expression for obtaining the apparent rigidity k_{R} of the variable rigidity mechanism 20. That is, with the use of the amplitude correction gain α, the apparent rigidity k_{R} of the variable rigidity mechanism 20 is expressed as k_{R}=ηn²k₁(1−θ₁/αn θ). Therefore, in a case of the gait improvement rate ε=1, for example, the rigidity k_{R} is expressed as k_{R}=ηn²k₁(1−θ₁/(A_{I}÷Aₕ) nθ) . . . Expression (1). Note that Expression (1) is different from Expression 1 described above. Accordingly, as illustrated in FIG. 7, when the maximum stride angle A_{I} at the time of the ideal walking is larger than the maximum stride angle Aₕ at the time of the actual walking, a value in parentheses of Expression (1) is large and the apparent rigidity k_{R} of the variable rigidity mechanism 20 is large. Therefore, the assist torque τ=k_{R}θ is adjusted to increase, so that the assist torque τ is applied in a direction where the maximum stride angle Aₕ at the time of the actual walking is increased. Further, a value of the rigidity k_{R} is changed appropriately in a zone from a time when an amplitude of a walk reaches its maximum to a time when the amplitude becomes zero, and thus, a necessary assist torque τ can be applied efficiently in a zone where the amplitude of the walk reaches its maximum from zero.

Further, when the maximum stride angle A_{I} at the time of the ideal walking is smaller than the maximum stride angle Aₕ at the time of the actual walking, the value in the parentheses of Expression (1) is small and the apparent rigidity k_{R} of the variable rigidity mechanism 20 is small. Therefore, the assist torque τ=k_{R}θ is adjusted to decrease, so that the maximum stride angle Aₕ at the time of the actual walking is decreased naturally. Further, for example, at the time of the gait improvement rate ε=0, the amplitude correction gain α=1 is obtained, so that the apparent rigidity k_{R} of the variable rigidity mechanism 20 is expressed as ηn²k₁(1−θ₁/nθ). Therefore, walk improvement based on an angular difference between the maximum stride angle A_{I} at the time of the ideal walking and the maximum stride angle Aₕ at the time of the actual walking is not performed. Further, by changing the gait improvement rate ε between 0 and 1, it is possible to adjust the degree of the walk improvement based on the angular difference between the maximum stride angle A_{I}, at the time of the ideal walking and the maximum stride angle Aₕ at the time of the actual walking.

Here, the present embodiment describes the motion of one leg at the time of the walking motion. However, phases of motions of right and left legs are shifted from each other by 180° degrees, and the motions of the legs can be regarded as the same.

In the assist device 10, the controller unit 52 (the control device) controls the motor 40 (the rigidity variable actuator) based on a detection angle detected by the angle detector 43 (the angle detecting portion) and an input value input from the input device 44 (the input device). The controller unit 52 changes the apparent rigidity k_{R} of the variable rigidity mechanism 20 such that a predetermined load is applied to the femoral region, by controlling the motor 40. Thus, the assist torque τ applied to the output link 30 is controlled. This makes it possible to reduce power consumption in comparison with a conventional assist device that applies a rotating torque of a motor in a rotation direction of an output link.

Further, when the stride central angle θₑ of the output link 30 in the actual walking motion deviates from the ideal stride central angle θ₀ (θ₀=0) of the femoral region in the walking motion, the controller unit 52 can increase the load applied to the femoral region in accordance with the deviation angle θₑ. In general, at the time of walking, a user walks unconsciously such that a load applied to the femora region becomes small. Because of this, the user walks such that the stride central angle θₑ of the output link approaches the ideal stride central angle θ₀ (θ₀=0) of the femoral region. That is, a walk of the user approaches an ideal walk, so that walk improvement is achieved.

Further, the input device 44 is configured to input the maximum stride angle A_{I} of the femoral region in the ideal walking motion to the controller unit 52. The controller unit 52 changes the apparent rigidity k_{R} of the variable rigidity mechanism 20 such that the maximum stride angle Aₕ of the output link 30 in the actual walking motion approaches the ideal maximum stride angle A_{I}, by controlling the motor 40. Therefore, the walk of the user approaches an ideal walk, and thus, walk improvement is achieved. Further, since the gait improvement rate s can be input into the controller unit 52, it is possible to adjust the walk improvement in accordance with a condition of a body of the user such that the walk improvement is performed immediately or the walk improvement is performed gently.

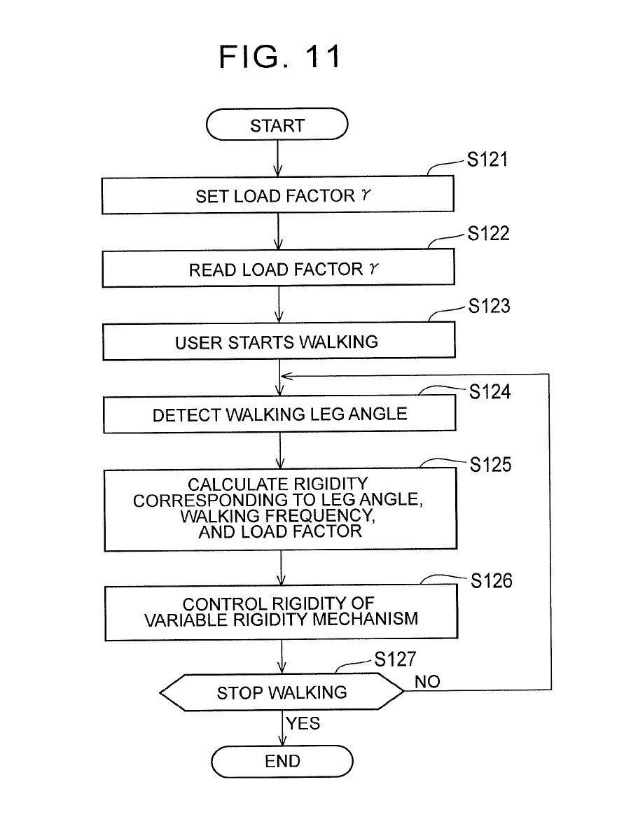

Next will be described an assist device 10 according to Embodiment 2 of the disclosure based on FIG. 11 and the like. The assist device 10 according to the present embodiment is a device configured to assist a walking training or the like of a user. Here, a device configuration of the assist device 10 according to the present embodiment is the same as the device configuration of the assist device 10 described in Embodiment 1, so a description thereof is omitted. In the assist device 10 according to the present embodiment, a load factor γ, which is a coefficient that determines a degree of a load applied to a femoral region in a walking training or the like, is used. Here, the load factor γ is a value of 0 or more (0≦γ). Note that, in the assist device 10 according to the present embodiment, the walk improvement described in Embodiment 1 is not performed, so that the gait improvement rate ε is set to 0 (ε=0), and thus, the amplitude correction gain α is set to 1 (α=1).

First, a load factor γ is set before walking (step S121 in FIG. 11), and the load factor γ is input into a controller unit 52 from an input device 44 (step S122). Then, when a user starts walking (step S123), a signal of an angle detector 43 that detects a swinging angle of an output link 30 is input into the controller unit 52 (step S124). Thus, as illustrated in FIG. 6, the controller unit 52 obtains a walking period T with the use of the predetermined threshold, and further obtains a walking frequency “f” and an angular frequency ω. Subsequently, the controller unit 52 calculates an apparent rigidity k_{R} (an angle θ₁ of a rotating shaft 41 of a motor 40) of a variable rigidity mechanism 20, the apparent rigidity k_{R} corresponding to the swinging angle θ of the output link 30, the walking frequency “f”, the load factor γ, and the like (step S125). Note that a specific calculation method for the angle θ₁ of the rotating shaft 41 of the motor 40 will be described later. Then, the apparent rigidity k_{R} of the variable rigidity mechanism 20 is controlled so as to adjust an assist torque τ (τ=k_{R}θ) applied to the output link 30 (step S126). The process from step S124 to step S126 is performed repeatedly during the walking. When the walking is finished (step S127), the assist device 10 enters an operation completed state (in other words, the operation of the assist device 10 ends).

Next will be described a procedure for obtaining the apparent rigidity k_{R} of the variable rigidity mechanism 20 with the use of the load factor γ. As illustrated in FIG. 8, in an actual walking motion, a motion torque τ_{H} required at the time when a leg is rotated upward by an angle θ is expressed as Expression 6 as described in Embodiment 1.

τ_{H}=J\ddot{θ}+d\dot{θ}+(k_{R}+mgL)θ Expression 6

Further, a swinging angle θ of the output link 30 in the actual walking motion is assumed based on FIG. 5 as follows. θ=Aₕ×sin ωt. Note that Aₕ indicates a maximum stride angle of the output link 30, as described above. Further, since walk improvement is not considered, a stride central angle θₑ is zero (θₑ=0).

When the swinging angle θ of the output link 30 is substituted into Expression 6, the motion torque τ_{H} of the leg in an actual walking state is as follows:

τ_{H}=−AₕJω²×sin ωt+Aₕd×cos ωt+Aₕ×(k_{R}+mgL)×sin ωt

When this expression is transformed, the following expression is obtained:

τ_{H}=Aₕ×(k_{R}+mgL−Jω²)×sin ωt+Aₕd×cos ωt

Subsequently, a target motion torque of the leg in the actual walking state is assumed to be τ_{H0}, and the target motion torque τ_{H0} is expressed with the use of the load factor γ as follows. That is, the target motion torque τ_{H0} is expressed as τ_{H0}=γAₕ×(mgL−Jω²)×sin ωt+Aₕd×cos ωt. When the motion torque τ_{H} of the leg in the actual walking state is set to be equal to the target motion torque τ_{H0}, Aₕ×(k_{R}+mgL−Jω²)=γAₕ×(mgL−Jω²) is obtained. When this expression is transformed, the following is obtained: k_{R}=(γ−1)×(mgL−Jω²) . . . Expression (2).
Note that Expression (2) is different from Expression 2 described above.

Here, for example, a case of the load factor γ=0 is assumed. In this case, when γ=0 is substituted into Expression (2), k_{R}=−(mgL−Jω²) is obtained. When this expression is substituted into the expression of the motion torque τ_{H} of the leg in the actual walking state, that is, τ_{H}=Aₕ×(k_{R}+mgL−Jω²)×sin ωt+Aₕd×cos ωt, τ_{H}=Aₕd×cos ωt is obtained, and thus, the motion torque τ_{H} of the leg in the actual walking state is minimized. That is, the load applied to the femoral region is reduced due to an action of the variable rigidity mechanism 20. Subsequently, in a case of the load factor γ=1, when γ=1 is substituted into Expression (2), k_{R}=0 is obtained. That is, the apparent rigidity k_{R} of the variable rigidity mechanism 20 seen from the output link 30 is zero, which causes a state where the variable rigidity mechanism 20 does not operate. In this case, the motion torque τ_{H} of the leg is expressed as τ_{H}=Aₕ×(mgL−Jω²)×sin ωt+Aₕd×cos ωt. That is, the motion torque τ_{H} of the leg is larger than the motion torque τ_{H} at the minimum by Aₕ×(mgL−Jω²)×sin ωt, and thus, the load applied to the femoral region is increased.

Subsequently, in a case of the load factor γ=2, when γ=2 is substituted into Expression (2), k_{R}=(mgL−Jω²) is obtained. In this case, the motion torque τ of the leg is expressed as τ_{H}=Aₕ×2(mgL−Jω²)×sin ωt+Aₕd×cos ωt. That is, the motion torque τ_{H} of the leg is larger than the motion torque TH at the minimum by Aₕ×2(mgL−Jω²)×sin ωt, and thus, the load applied to the femoral region is further increased due to the operation of the variable rigidity mechanism 20. That is, by setting the load factor γ appropriately, it is possible to adjust the degree of the load applied to the femoral region in the walking training or the like.

Here, as described in Embodiment 1, the apparent rigidity k_{R} of the variable rigidity mechanism 20 seen from the output link 30 can be expressed with the spring constant k₁ of the spiral spring 24 of the variable rigidity mechanism 20 and the rotation angle θ₁ of the motor 40. That is, the apparent rigidity k_{R} can be expressed as k_{R}=ηn²k₁(1−θ₁/nθ). Therefore, when the rotation angle θ₁ of the motor 40 is controlled so as to satisfy θ₁=(n−k_{R}/ηnk₁)×θ, the apparent rigidity k_{R} can be adjusted to control the assist torque τ(τ=k_{R}θ) applied to the output link 30.

Here, the disclosure is not limited to the above embodiments, and various modifications can be made without departing from the scope of the disclosure. For example, the present embodiments deal with an example in which the assist device 10 is used for the walk improvement or the walking training. However, the assist device 10 can be used for other trainings such as a squat training. Further, the present embodiments deal with an example in which the spiral spring 24 is used as an elastic body of the variable rigidity mechanism 20. However, instead of the spiral spring 24, a coiled spring can be used or a rubbery elastic body can be used. Further, the present embodiments deal with an example in which the speed reducer 26 is used in the variable rigidity mechanism 20, but the speed reducer 26 can be omitted depending on strength of the spring. Further, the present embodiments deal with an example in which the variable rigidity mechanisms 20 and the output links 30 are provided on right and left sides, but they may be provided only on one side depending on a type of the training.

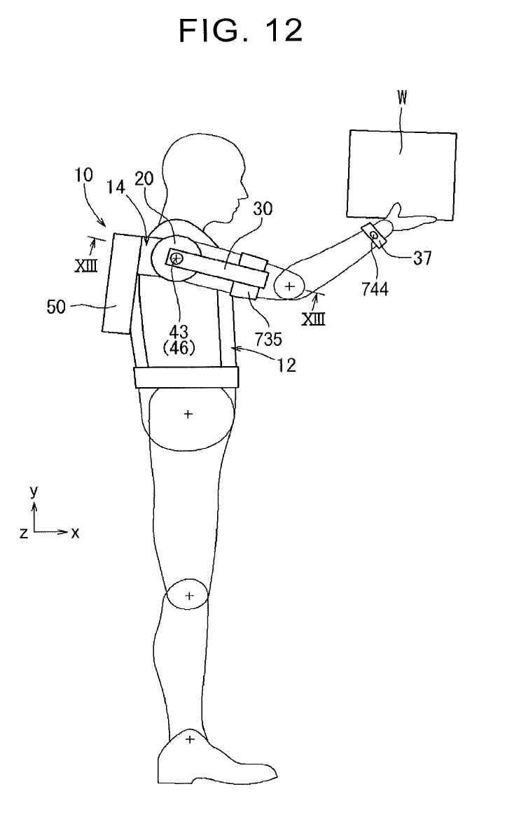

The following describes an assist device 10 according to Embodiment 3 of the disclosure based on FIGS. 12 to 18. The assist device 10 of the present embodiment is a device configured to assist an upward rotation of an upper arm at the time when a user lifts a burden W. Here, an x-direction, a y-direction, and a z-direction illustrated in the figures correspond to a forward direction, an upward direction, and a leftward direction with respect to a user who wears the assist device 10.

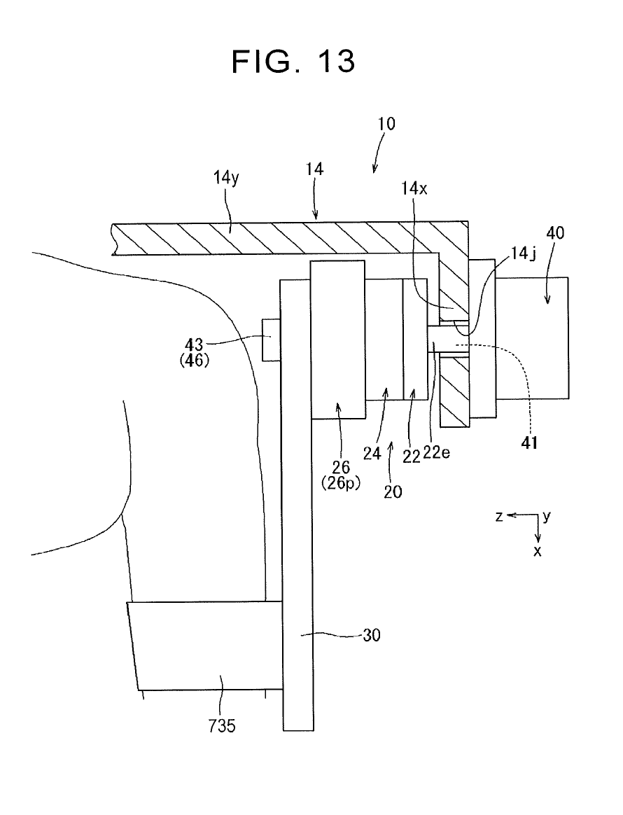

As illustrated in FIG. 12, the assist device 10 includes: an upper-body attachment member 12 put on an upper body of a user; and a support frame portion 14 provided around an upper part of a back face of the upper-body attachment member 12. As illustrated in FIG. 13, the support frame portion 14 includes: a cross beam portion 14y provided on the upper part of the back face of the upper-body attachment member 12 so as to extend in the right-left direction; and side plate portions 14x provided on right and left sides of the cross beam portion 14y so as to extend at substantially right angles with respect to the cross beam portion 14y. As illustrated in FIG. 13, the side plate portions 14x of the support frame portion 14 are each configured such that a shaft receiving hole 14j is formed at a position corresponding to a shoulder joint of the user, that is, at substantially the same position as the shoulder joint of the user in the x,y-directions.

As illustrated in FIG. 13, a pair of right and left variable rigidity mechanisms 20 (described later) is provided inside right and left corners between the cross beam portion 14y and the side plate portions 14x of the support frame portion 14. The variable rigidity mechanism 20 is provided along the z-direction, and an input shaft 22e of the variable rigidity mechanism 20 is passed through the shaft receiving hole 14j of the side plate portion 14x of the support frame portion 14. A rotating shaft 41 of a motor 40 fixed to an outer side of the side plate portion 14x of the support frame portion 14 is coaxially connected to the input shaft 22e of the variable rigidity mechanism 20. That is, the variable rigidity mechanism 20 is supported by the support frame portion 14 in a rotatable state around an axial center of the input shaft 22e.

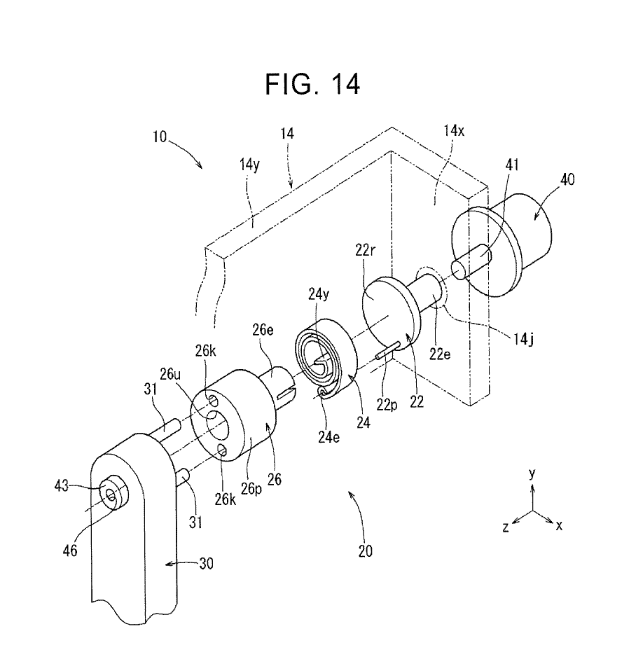

Further, as illustrated in FIGS. 13, 14, a base end (a rotation central part) of a bar-shaped output link 30 is connected to an output rotating shaft 26p of the variable rigidity mechanism 20 in a relatively non-rotatable state. That is, the rotation central part of the output link 30 is connected to a position of the shaft receiving hole 14j of the support frame portion 14, which corresponds to the shoulder joint of the user, via the variable rigidity mechanism 20 so as to be rotatable in the up-down direction. The output link 30 is a link disposed along an outer surface of an upper arm of the user, and is configured such that a distal end (a rotation free end) of the output link 30 is attached to the upper arm of the user by an upper-arm attachment member 735. That is, the upper-body attachment member 12 and the support frame portion 14 may be regarded as a body attachment member in the disclosure.

As illustrated in FIGS. 13, 14, and the like, an angle detector 43 configured to detect a swinging angle of the output link 30 and a second acceleration sensor 46 are attached to the rotation central part of the output link 30. Further, as illustrated in FIG. 12, the assist device 10 includes a wrist attachment member 37, and a first acceleration sensor 744 is attached to the wrist attachment member 37. Further, as illustrated in FIG. 12 and the like, the assist device 10 includes a control box 50 attached to the back face of the upper-body attachment member 12.

The variable rigidity mechanism 20 is a mechanism configured such that an apparent rigidity thereof seen from the output link 30 can be changed, and the variable rigidity mechanism 20 includes an input portion 22, a spiral spring 24, and a speed reducer 26 as illustrated in FIG. 14. The input portion 22 is a part configured to transmit a rotation of the motor 40 to the spiral spring 24. The input portion 22 includes: an input shaft 22e to which the rotating shaft 41 of the motor 40 is connected in a relatively non-rotatable state; a circular plate portion 22r provided coaxially with the input shaft 22e; and a torque transmission shaft 22p provided on a peripheral edge of the circular plate portion 22r at a position on a side opposite to the input shaft 22e. The torque transmission shaft 22p of the input portion 22 is connected to an outer-peripheral-side spring end portion 24e of the spiral spring 24.

As illustrated in FIG. 14, the spiral spring 24 of the variable rigidity mechanism 20 is a spring obtained by forming a belt-shaped leaf spring in a spiral shape, and includes spring end portions 24y, 24e on a central side and on an outer peripheral side. The spiral spring 24 is configured such that a spring force is adjusted by changing a swinging angle of the outer-peripheral-side spring end portion 24e relative to the central-side spring end portion 24y. Here, a spring constant of the spiral spring 24 is set to k₁, for example. As described above, the outer-peripheral-side spring end portion 24e of the spiral spring 24 is connected to the torque transmission shaft 22p of the input portion 22 in a relatively non-rotatable state. Further, the central-side spring end portion 24y of the spiral spring 24 is connected to an input rotating shaft 26e of the speed reducer 26 in a relatively non-rotatable state. Here, the input portion 22 and the input rotating shaft 26e of the speed reducer 26 are maintained coaxially. That is, the spiral spring 24 may be regarded as an elastic body of the disclosure.

The speed reducer 26 is a member configured to amplify a rotating torque caused due to the spring force of the spiral spring 24, and to transmit the amplified rotating torque to the output link 30. The speed reducer 26 includes the input rotating shaft 26e, the output rotating shaft 26p, a gear mechanism (not shown) provided between the input rotating shaft 26e and the output rotating shaft 26p, and the like. The input rotating shaft 26e and the output rotating shaft 26p of the speed reducer 26 are maintained coaxially, and when the input rotating shaft 26e rotates n times, the output rotating shaft 26p rotates once. Further, a torque transfer efficiency of the speed reducer 26 is set to η.

A positioning hole 26u to which a rotation center pin (not shown) of the output link 30 is fitted is formed in a center of the output rotating shaft 26p of the speed reducer 26 as illustrated in FIG. 14. Further, rotation-stop holes 26k into which rotation-stop pins 31 of the output link 30 are inserted are formed around the positioning hole 26u of the output rotating shaft 26p. Thus, the output link 30 can rotate integrally with the output the rotating shaft 26p of the speed reducer 26.

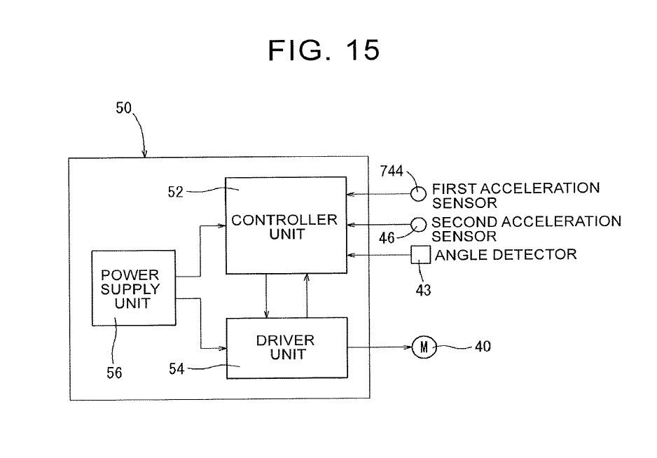

As illustrated in FIG. 12, the control box 50 is a box attached to the back face of the upper-body attachment member 12. As illustrated in FIG. 15, the control box 50 accommodates a controller unit 52, a driver unit 54, and a power supply unit 56 therein. The controller unit 52 is a unit configured to control a rotation angle of the motor 40. The driver unit 54 is a unit configured to drive the motor 40, and the driver unit 54 operates based on a signal from the controller unit 52. The power supply unit 56 is a unit configured to supply electric power to the controller unit 52 and the driver unit 54.

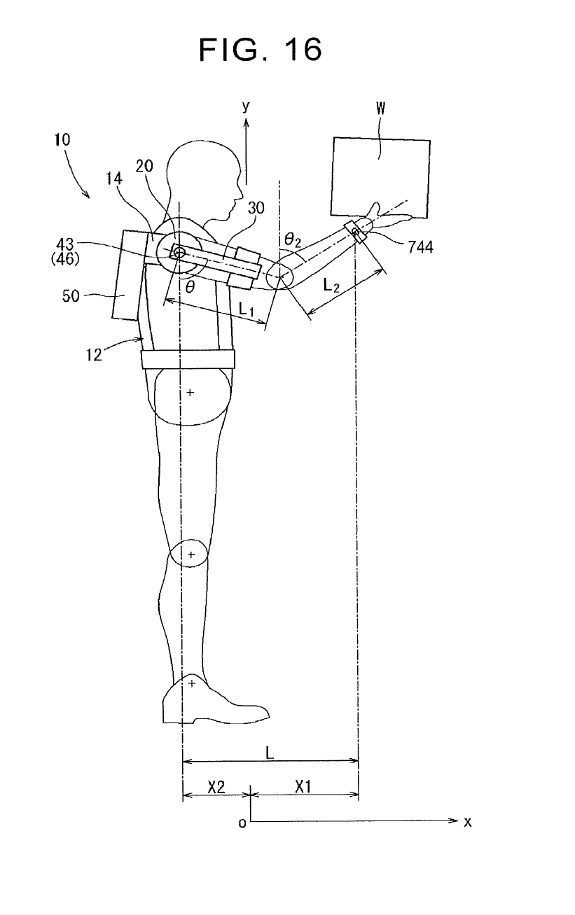

As illustrated in FIG. 15, signals from the first acceleration sensor 744 attached to the wrist and the second acceleration sensor 46 attached to the rotation central part of the output link 30 are input into the controller unit 52. The controller unit 52 performs a double integration on x-components of detection values of the first acceleration sensor 744 and the second acceleration sensor 46 so as to take a difference therebetween, thereby calculating a distance L (see FIG. 16), in the x-direction, between the rotation central part of the output link 30 and the wrist. Further, a signal of the angle detector 43 that detects a swinging angle θ of the output link 30 is input into the controller unit 52. Further, a signal of a load current I of the motor 40 is input into the controller unit 52 from the driver unit 54. The controller unit 52 calculates a mass mw or the like of a burden W carried by the user from the signal of the load current I of the motor 40. Note that the driver unit 54 or the like is provided with a sensor configured to measure the load current I so that the load current I can be measured.

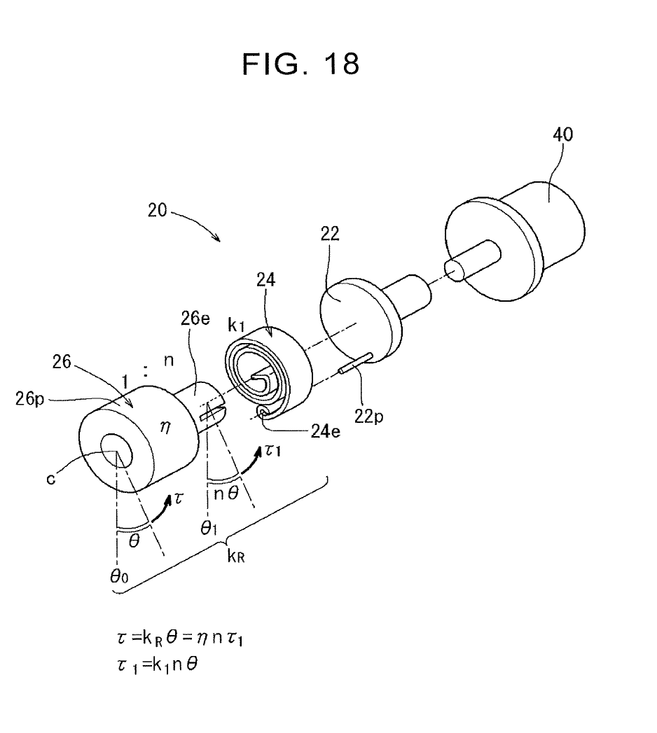

The controller unit 52 controls a rotation angle θ₁ of the motor 40 based on values of the distance L between the rotation central part of the output link 30 and the wrist, the swinging angle θ of the output link 30, the mass mw of the burden W, and the like such that a work load of the user is minimized. When the rotating shaft 41 of the motor 40 rotates by an angle θ₁, the outer-peripheral-side spring end portion 24e of the spiral spring 24 of the variable rigidity mechanism 20 also rotates by the angle θ₁, as illustrated in FIG. 18 and the like. Thus, an apparent rigidity k_{R} of the variable rigidity mechanism 20 seen from the output link 30 changes, and thus, a rotating torque τ (hereinafter referred to as an assist torque τ) applied to the output link 30 from the output rotating shaft 26p of the variable rigidity mechanism 20 is controlled.

That is, the controller unit 52 may be regarded as a control device of the disclosure, and the motor 40 may be regarded as a rigidity variable actuator of the disclosure. Further, the first acceleration sensor 744, the second acceleration sensor 46, and the controller unit 52 may be regarded as a distance measuring portion of the disclosure, and the controller unit 52 may be regarded as a calculation portion in the distance measuring portion of the disclosure.

Next will be described a procedure for calculating the rotation angle θ₁ of the motor 40 in the assist device 10. Here, a program for calculating the rotation angle θ₁ of the motor 40 is stored in a memory (not shown) of the controller unit 52. As illustrated in FIG. 16, a length of the upper arm of the user is L₁, and a length of a forearm is L₂. Further, a mass of the upper arm is m₁, and a mass of the forearm is m₂. The values are input into the controller unit 52 in advance. In this state, an angle of the upper arm, that is, an angle (an angle relative to a vertical line) θ of the output link 30 of the assist device 10 is first detected by the angle detector 43. Further, a distance L (hereinafter referred to as a torque radius L), in the x-direction, between the rotation central part of the output link 30 and the wrist is calculated based on the x-components of the detection values of the first acceleration sensor 744 and the second acceleration sensor 46. That is, as shown in a calculation expression of Expression 7, the torque radius L is obtained by performing a double integration on a detection value x₁ of the first acceleration sensor 744 and a detection value x₂ of the second acceleration sensor 46 to obtain a difference therebetween.

L=x₁−x2=∫∫\ddot{x}₁dt−∫∫\ddot{x}₂dt Expression 7

Next will be described a procedure for obtaining a virtual mass mₕ of the upper arm and the forearm to be intensively applied to a position of the wrist, as a preparation for calculation of the rotation angle θ₁ of the motor 40. As illustrated in FIG. 16, when an angle of the upper arm is θ (a detection value of the angle detector 43) and an angle of the forearm is θ₂, the torque radius L is expressed as a sum of L₁×sin θ and L₂× sin θ₂, where L₁ indicates the length of the upper arm and L₂ indicates the length of the forearm. That is, L=L₁×sin θ+L₂×sin θ₂ is obtained. Accordingly, the angle θ₂ of the forearm is expressed as θ₂=sin⁻¹((L−L₁×sin θ)÷L₂). When a rotating torque caused due to a gravitational force applied to a rotation center of the output link 30 is τ_{G}, the rotating torque τ_{G} is expressed as τ_{G}=virtual mass mₕg×torque radius L. Further, when a distance from the shoulder joint of the upper arm to a gravity center is ½L₁ and a distance from an elbow joint of the forearm to a gravity center is ½L₂, the rotating torque τ_{G} is expressed as a sum of m₁g×½L₁×sin θ and m₂g×(L₁×sin θ+½L₂×sin θ₂). Accordingly, the virtual mass mₕ is expressed as mₕ=(m₁× ½L₁×sin θ+m₂×(L₁×sin θ+½L₂×sin θ₂))÷L.

Next will be described a procedure for obtaining a mass mw of the burden W from the load current I of the motor 40. When a torque constant is κ, a generated torque τ_{M} of the motor is expressed as τ_{M}=torque constant κ×load current I. Further, a generated torque τ_{M} of the motor at the time of lifting the burden W is expressed as a sum of a rotating torque To for lifting the arm, expressed as τ_{G}=(virtual mass mₕg×torque radius L), and a rotating torque τ_{W} for lifting the burden W, expressed as τ_{W}=(mass m_{W}g of burden W×torque radius L). Therefore, (rotating torque τ_{W} for lifting burden W)=(generated torque τ_{M} of motor)−(rotating torque τ_{G} for lifting arm) is obtained. That is, (mass m_{W}g of burden W×torque radius L)=(torque constantκ×load current I)−(virtual mass mₕg×torque radius L) is obtained. Accordingly, the mass m_{W} of the burden W is expressed as m_{W}=(κ×I−mₕg×L)÷L. Further, a mass “m” intensively applied to the wrist is expressed as m=(virtual mass mₕ+mass mw of burden W).

Next will be described a procedure for obtaining an inertia moment J at the time when the upper arm having a mass m₁ and the forearm having a mass m₂ are rotated around the shoulder joint. A distance from the shoulder joint of the upper arm to the gravity center is assumed to be ½ of the length L₁ of the upper arm. Similarly, a distance from the elbow joint of the forearm to the gravity center is assumed to be ½ of the length L₂ of the forearm. In this case, coordinates of the gravity center of the upper arm, with a center of the shoulder joint serving as an origin, are as follows: L_{1g}=(L_{1gx},L_{1gy})=(½×L₁×sin θ, −½×L₁×cos θ) Here, L₁, is a distance from the center of the shoulder joint (the origin) to the gravity center of the upper arm. Further, coordinates of the gravity center of the forearm, with the center of the shoulder joint serving as an origin, are as follows:

L_{2g}=(L_{2gx},L_{2gy})=(L₁×sin θ+½×L₂×sin θ₂,−L₁×cos θ+½×L₂×cos θ₂)

Here, L_{2g} is a distance from the center of the shoulder joint (the origin) to the gravity center of the forearm.

Coordinates of a gravity center of a whole arm are expressed with the coordinates of the gravity center of the upper arm and the coordinates of the gravity center of the forearm as follows. That is, the coordinates of the gravity center of the whole arm are expressed as L=(L_{gx}, L_{gy})=((m₁L_{1gx}+m₂L₂ₚ)/(m₁+m₂), (m₁L_{1gy}+m₂L_{2gy})/(m₁+m₂)). Here, |L_{g}| is obtained as a distance from the center of the shoulder joint (the origin) to the gravity center of the whole arm according to Expression 8.

L=\sqrt{L_{gx}²+L_{gy}²} Expression 8

When it is assumed that a uniform rod having a mass (m₁+m₂) is rotated, the inertia moment J around the shoulder joint is expressed as the following expression according to the parallel axis theorem.

Inertia Moment J= 1/12×(m₁+m₂)×(2|L|)²+(m₁+m₂)×(|L_{g}|)²

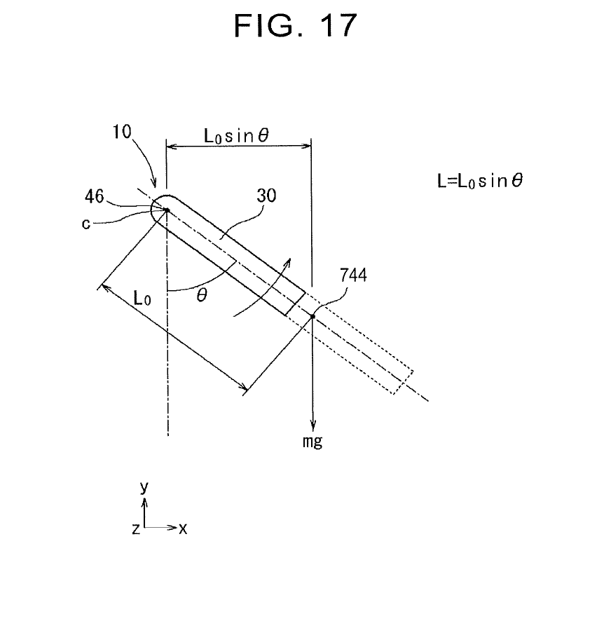

Next will be described a procedure for calculating the rotation angle θ₁ of the motor 40 more specifically, based on FIGS. 17 and 18. As illustrated in FIG. 17, the following calculation is performed, assuming that a linear distance on an xy plane from the rotation center C of the output link 30 to the wrist (the first acceleration sensor 744) is L₀ and the mass “m” is intensively applied to a position of the wrist. The mass “m” is expressed as m=(virtual mass mₕ+mass mw of burden W) as described above. In this state, a torque τ necessary to rotate the upper arm and the output link 30 upward by the angle θ is calculated.

A torque caused due to the inertia moment J around the shoulder joint is a value shown in Expression 9.

J\ddot{θ} Expression 9

Further, when a viscosity of the user in a rotating operation is “d”, a torque caused due to the viscosity “d” is a value shown in Expression 10.

d\dot{θ} Expression 10

Further, as illustrated in FIG. 18, when an apparent rigidity of the variable rigidity mechanism 20 seen from the output link 30 is k_{R}, a torque τ at the time when the output rotating shaft 26p of the variable rigidity mechanism 20 rotates by the angle θ from a neutral point θ₀ is expressed as τ=k_{R}×(θ−θ₀). Note that the neutral point θ₀ is an angle at which the variable rigidity mechanism 20 does not generate a torque. Further, a torque caused due to the mass “m” is expressed as mg×L₀×sin θ. Therefore, the torque T necessary to rotate the upper arm and the output link 30 upward by the angle θ is expressed as Expression 11.

T=J\ddot{θ}+d\dot{θ}+k_{R}(θ−θ₀)+mgL₀ sin θ Expression 11

Then, a sum total of energy E of a system is obtained. First, energy caused due to the inertia moment J is expressed as Expression 12.

½J\dot{θ}² Expression 12

Further, elastic energy of the variable rigidity mechanism 20 is expressed as ½×k_{R}×(θ−θ₀)². Further, potential energy is expressed as mg×L₀×(1−cos θ). Therefore, the sum total of the energy E of the system is expressed by Expression 13.

E=½J\dot{θ}2+½k_{R}(θ−θ₀)²+mgL₀(1−cos θ) Expression 13

Subsequently, a condition for minimizing the energy E of the system is obtained. The condition for minimizing the energy E of the system is a condition that a value obtained by differentiating the energy E with respect to time is zero. Therefore, an expression shown in Expression 13 is differentiated. When Expression 13 is differentiated, Expression 14 is obtained.

$$\begin{matrix}\frac{dE}{dt} = J \dot{θ} \ddot{θ} + {k}_{R} ( θ - {θ}_{0} ) \dot{θ} + {mgL}_{0} sin θ \dot{θ} \\ = \{ J \ddot{θ} + {k}_{R} ( θ - {θ}_{0} ) + {mgL}_{0} sin θ \} \dot{θ} = 0\end{matrix} \qquad Expression 14$$

Thus, the condition for minimizing the energy E of the system is as shown in Expression 15.

J\ddot{θ}+k_{R}(θ−θ₀)+mgL₀ sin θ=θ Expression 15

When Expression 15 is transformed to obtain a neutral point θ₀ of the output rotating shaft 26p of the variable rigidity mechanism 20, Expression 16 is obtained.

$${θ}_{0} = θ + \frac{1}{{k}_{R}} ( J \ddot{θ} + {mgL}_{0} sin θ ) \qquad Expression 16$$

That is, by adjusting the neutral point θ₀ to the angle shown in Expression 16, the energy E of the system can be minimized. That is, a work load of the user can be minimized.

Next will be described a procedure for expressing the apparent rigidity k_{R} of the variable rigidity mechanism 20 seen from the output link 30 (hereinafter referred to as the apparent rigidity k_{R}) with the use of an actual spring constant k₁ of the spiral spring 24. Here, the calculation is performed first, assuming that the neutral point θ₀ is held at an origin (θ₀=0). As illustrated in FIG. 18, a speed reducing ratio of the speed reducer 26 is n:1, and therefore, when the output link 30 and the output rotating shaft 26p of the speed reducer 26 rotate by an angle θ, the input rotating shaft 26e of the speed reducer 26 rotates by nθ. Therefore, a torque τ₁ applied to the input rotating shaft 26e of the speed reducer 26 in a state where the output link 30 and the like rotate by the angle θ is expressed as k₁×nθ, where k₁ indicates a spring constant of the spiral spring 24. That is, τ₁=k₁×nθ is obtained. Further, the speed reducing ratio of the speed reducer 26 is n:1 and the efficiency is η, and therefore, a rotating torque τ applied to the output rotating shaft 26p of the speed reducer 26 is expressed as τ=ηnτ₁=ηn(k₁×nθ). The rotating torque τ applied to the output rotating shaft 26p of the speed reducer 26 is the assist torque τ applied to the output link 30, and is expressed as τ=k_{R}θ, as described above (see Expression 11). Therefore, the apparent rigidity k_{R} of the variable rigidity mechanism 20 is expressed as k_{R}=ηn²k₁.

Now a case is assumed where a neutral point of the variable rigidity mechanism 20 (the spiral spring 24) seen from a motor 40-side is rotated by the motor 40 by an angle θ₁. In this case, a torque τ₁ applied to the input rotating shaft 26e of the speed reducer 26 in a state where the output link 30 and the like rotate by an angle θ can be expressed as τ₁=k₁×(nθ+θ₁). Therefore, an assist torque t applied to the output rotating shaft 26p of the speed reducer 26 can be expressed as τ=ηnk₁(nθ+θ₁)=ηn²k₁(1+θ₁/nθ)×θ. Accordingly, the apparent rigidity k_{R} of the variable rigidity mechanism 20 is expressed as k_{R}=ηn²k₁(1+θ₁/nθ). That is, by controlling the rotation angle θ₁ of the motor 40, the apparent rigidity k_{R} of the variable rigidity mechanism 20 can be changed, and thus, the assist torque τ can be controlled.

As described above, since the neutral point of the variable rigidity mechanism 20 seen from the motor 40-side is moved by the angle θ₁, the neutral point θ₀ of the output rotating shaft 26p of the variable rigidity mechanism 20 is expressed as θ₁=nθ₀. When the expression is substituted into the expression of the apparent rigidity k_{R}, k_{R}=ηn²k₁(1+θ₀/θ) is obtained. When this expression is substituted into Expression 16, Expression 17 is obtained as follows.

$${θ}_{0} = θ + \frac{1}{η {n}^{2} {k}_{1} ( 1 + \frac{{θ}_{0}}{θ} )} ( J \ddot{θ} + {mgL}_{0} sin θ ) \qquad Expression 17$$

Then, when both sides of Expression 17 are multiplied by θ₀ and transformed, Expression 18 is obtained.

$${{θ}_{0}}^{2} = {θ}^{2} + \frac{1}{η {n}^{2} {k}_{1}} ( J \ddot{θ} + {mgL}_{0} sin θ ) θ \qquad Expression 18$$

Further, when Expression 18 is transformed, Expression 19 is obtained.

$${θ}_{0} = \pm θ \sqrt{1 + \frac{1}{η {n}^{2} {k}_{1}} ( J \frac{\ddot{θ}}{θ} + \frac{{mgL}_{0} sin θ}{θ} )} \qquad Expression 19$$

Here, as described above, L₀ indicates the linear distance from the rotation center C of the output link 30 to the wrist (the first acceleration sensor 744). Therefore, L₀×sin θ is equal to a torque radius L obtained from the first acceleration sensor 744 at the wrist and the second acceleration sensor 46 of the output link 30. Accordingly, when L₀×sin θ of Expression 19 is replaced with L, an expression shown as Expression 20 is obtained.

$${θ}_{0} = \pm θ \sqrt{1 + \frac{1}{η {n}^{2} {k}_{1}} ( J \frac{\ddot{θ}}{θ} + \frac{mgL}{θ} )} \qquad Expression 20$$

Here, a neutral point θ₁ of the spiral spring 24 of the variable rigidity mechanism 20 seen from the motor 40-side is expressed as nθ₀, and thus, Expression 20 can be rewritten as shown in Expression 21.

$${θ}_{1} = n {θ}_{0} = \pm n θ \sqrt{1 + \frac{1}{η {n}^{2} {k}_{1}} ( J \frac{\ddot{θ}}{θ} + \frac{mgL}{θ} )} \qquad Expression 21$$

The controller unit 52 of the assist device 10 controls the rotation angle of the motor 40 to θ₁. Thus, the outer-peripheral-side spring end portion 24e of the spiral spring 24 of the variable rigidity mechanism 20 rotates so as to have the angle θ₁. As a result, the apparent rigidity k_{R} of the variable rigidity mechanism 20 seen from the output link 30 is adjusted such that the energy E of the system is minimized, and thus, the assist torque τ applied to the output link 30 from the output rotating shaft 26p of the variable rigidity mechanism 20 is controlled. That is, when the user lifts the burden W, the assist torque τ of the variable rigidity mechanism 20 is applied to the output link 30 in a direction where the upper arm is lifted up. Thus, a work load of the user is reduced.

In the assist device 10, the controller unit 52 (the control device) controls the motor 40 (the rigidity variable actuator) based on the swinging angle θ of the output link 30 and the distance L (the torque radius L) between the rotation center C of the output link 30 and a position where the user receives the mass of the burden W. Further, the controller unit 52 changes the apparent rigidity k_{R} of the variable rigidity mechanism 20 seen from the output link 30 such that a load applied to the user is minimized, by controlling the motor 40. That is, the controller unit 52 can change the apparent rigidity k_{R} of the variable rigidity mechanism 20 seen from the output link 30 by the motor 40 during an operation of the assist device 10. Therefore, in comparison with a conventional assist device in which a rigidity of an elastic body is manually adjusted, it is possible to perform an assists operation with high efficiency. Further, since the apparent rigidity k_{R} of the variable rigidity mechanism 20 is controlled so as to control the assist torque τ applied to the output link 30, it is possible to reduce power consumption in comparison with a conventional assist device that applies a rotating torque of a motor in a rotation direction of an output link.

Further, the torque radius L is calculated with the use of the first acceleration sensor 744 and the second acceleration sensor 46, and thus, it is possible to measure the torque radius L continuously during the assist operation. Further, since the apparent rigidity of the variable rigidity mechanism 20 seen from the output link 30 is changed by changing the rotation angle of the outer-peripheral-side spring end portion 24e of the spiral spring 24, it is possible to relatively easily perform a control that changes the rigidity of the variable rigidity mechanism 20.

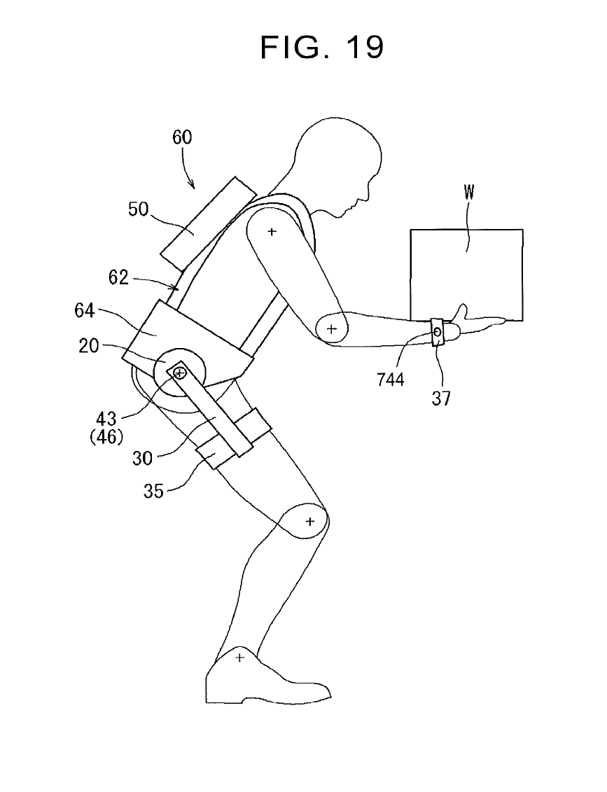

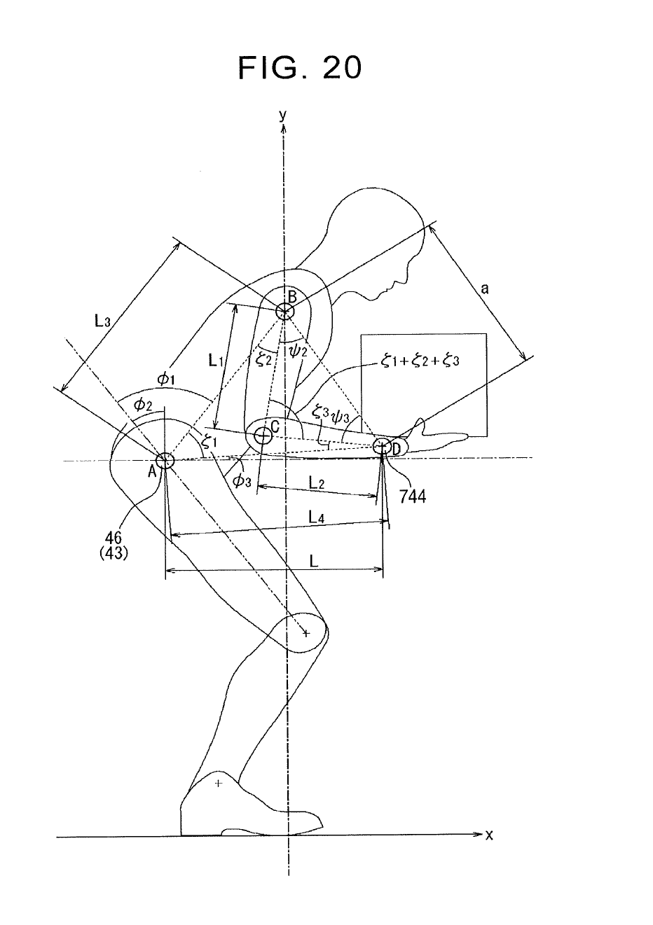

Next will be described an assist device 60 according to Embodiment 4 based on FIGS. 19, 20. The assist device 60 of Embodiment 4 is configured such that a rotation center of an output link 30 is held at a position corresponding to a hip joint of a user and a rotation free end of the output link 30 is attached to a femoral region. Here, a variable rigidity mechanism 20, a control box 50, a first acceleration sensor 744, a second acceleration sensor 46, and an angle detector 43 in the assist device 60 of Embodiment 4 are the same as those used in the assist device 10 of Embodiment 3, and thus, the same reference signs are assigned to them and descriptions thereof are omitted. The assist device 60 of Embodiment 4 includes an upper-body attachment member 62, and a support frame portion 64 is provided in the upper-body attachment member 62 at a position around a waist. Further, the variable rigidity mechanism 20 is provided in the support frame portion 64 at a position corresponding to the hip joint. Further, the output link 30 is connected to an output rotating shaft 26p of the variable rigidity mechanism 20.

Similarly to the case of the assist device 10 according to Embodiment 3, the assist device 60 according to Embodiment 4 calculates a torque radius L from x-components of detection values of the first acceleration sensor 744 and the second acceleration sensor 46. Further, a mass me intensively applied to a position of a wrist, that is, m_{B}=(virtual mass mₕ+mass m_{W} of burden W) is obtained, and an inertia moment J_{B} around the hip joint is calculated.

First described is a procedure for obtaining a virtual mass mₕ. As illustrated in FIG. 20, a quadrangle that connects a hip joint A, a shoulder joint B, an elbow joint C, and a wrist D is assumed, a length of a side AB is L₃, a length of a side DA is L₄, an angle formed between the side AB and the side DA is ζ₁, an angle formed between the side AB and a side BC is ζ₂, and an angle formed between a side CD and the side DA is ζ₃. Further, an angle formed between the femoral region and the side AB is φ₁, an angle formed between the femoral region and a y-axis is φ₂, and an angle formed between the side DA and an x-axis is φ₃. Further, an angle formed by a line segment connecting the shoulder joint to the wrist and the side BC is ψ₂, and an angle formed by the line segment connecting the shoulder joint to the wrist and the side CD is ψ₃. The length L₄ of the side DA is obtained according to Expression 22 with the use of an x-component and a y-component of the first acceleration sensor 744, and an x-component and a y-component of the second acceleration sensor 46.

L₄=(∫∫\ddot{x}₁dt−∫∫\ddot{x}₂dt)²+(∫∫ÿ₁dt−∫∫ÿ₂dt)² Expression 22

Further, φ₁ is obtained from a value of the angle detector 43 at the hip joint. Further, φ₂ is a rotation angle of the hip joint with respect to an xy coordinate system, and is obtained according to Expression 23 with the use of an angular acceleration component of the second acceleration sensor 46 around a z-axis.

φ₂=∫∫\ddot{φ}₂^{dt} Expression 23

Further, φ₃ is obtained according to Expression 24 with the use of the x-component and the y-component of the first acceleration sensor 744, and the x-component and the y-component of the second acceleration sensor 46.

$${φ}_{3} = {tan}^{- 1} ( \frac{\int \int {\ddot{y}}_{1} dt - \int \int {\ddot{y}}_{2} dt}{\int \int {\ddot{x}}_{1} dt - \int \int {\ddot{x}}_{2} dt} ) \qquad Expression 24$$

Further, ζ₁ is obtained according to Expression 25 with the use of φ₁, φ₂, and φ₃.

$${ζ}_{1} = \frac{π}{2} - ( {φ}_{1} - {φ}_{2} ) - {φ}_{3} \qquad Expression 25$$

When the theorem of cosines is applied to a triangle ABD, a length “a” of a line segment BD is obtained according to Expression 26.

a=L₃²+L₄²−2L₃L₄ cos ζ₁ Expression 26

Further, when the theorem of cosines is applied to a triangle BCD, ψ₂ and ψ₃ are obtained according to Expression 27.

$$\begin{matrix}{L}_{2}^{2} = {a}^{2} + {L}_{1}^{2} - 2 {aL}_{1} cos {ψ}_{2} ⇒ {ψ}_{2} = {cos}^{- 1} ( \frac{{a}^{2} + {L}_{1}^{2} - {L}_{2}^{2}}{2 {aL}_{1}} ) & Expression 27 \\ {L}_{1}^{2} = {a}^{2} + {L}_{2}^{2} - 2 {aL}_{2} cos {ψ}_{3} ⇒ {ψ}_{3} = {cos}^{- 1} ( \frac{{a}^{2} + {L}_{2}^{2} - {L}_{1}^{2}}{2 {aL}_{2}} ) & \end{matrix}$$

Then, when the theorem of sine is applied to the triangle ABD, ζ₁ and ζ₃ are obtained according to Expression 28.

$$\begin{matrix}\frac{sin {ζ}_{1}}{a} = \frac{sin ( {ζ}_{2} + {ψ}_{2} )}{{L}_{4}} = \frac{sin ( {ζ}_{3} + {ψ}_{3} )}{{L}_{3}} & Expression 28 \\ ⇒ {ζ}_{2} = {sin}^{- 1} ( \frac{{L}_{4}}{a} sin {ζ}_{1} ) - {ψ}_{2} , \\ {ζ}_{3} = {sin}^{- 1} ( \frac{{L}_{3}}{a} sin {ζ}_{1} ) - {ψ}_{3} & \end{matrix}$$

When a distance from the hip joint to a gravity center is assumed L_{3g}, a torque τ₃ generated in the hip joint due to a mass m₃ of an upper body including a head is obtained according to Expression 29.

τ₃=m₃gL_{3g} cos(ζ₁+φ₃)=m₃gL′₃∵L₃′=L_{3g} cos(ζ₁+φ₃) Expression 29

A torque τ generated in the hip joint due to a mass of an upper arm is obtained according to Expression 30.

τ₁=m₁g└L₃ cos(ζ₁+φ₃)+L₁g cos {ζ₁+φ₃−(π−ζ₂)}┘=m₁gL₁′∵L₁′=L₃ cos(ζ₁+φ₃)+L₁g cos {ζ₁+φ₃−(π−ζ₂)} Expression 30

Further, a torque τ₂ generated in the hip joint due to a mass of a forearm is obtained according to Expression 31.

τ₂=m₂g└L₃ cos(ζ₁+φ₃)+L₁ cos {ζ₁+φ₃−(π−ζ₂)}+L_{2g} cos {ζ₁+φ₃−(π−ζ₂)+(π−(ζ₁+ζ₂+ζ₃))}┘=m₂gL₂′∵L₂′=L₃ cos(ζ₁+φ₃)+L₁ cos {ζ₁+φ₃−(π−ζ₂)}+L_{2g} cos {ζ₁+φ₃−(π−ζ₂)+(π−(ζ₁+ζ₂+ζ₃))} Expression 31

Thus, when the torques generated by the upper body, the upper arm, and the forearm are assumed to be equal to a torque generated by a virtual mass mₕ at the time when it is assumed that a mass concentrates on a wrist portion, the virtual mass mₕ is obtained according to Expression 32.

$${m}_{h} gL = {τ}_{1} + {τ}_{2} + {τ}_{3} = {m}_{1} {gL}_{1}^{′} + {m}_{2} {gL}_{2}^{′} + {m}_{3} {gL}_{3}^{′} \\ {m}_{h} = \frac{{m}_{1} {L}_{1}^{′} + {m}_{2} {L}_{2}^{′} + {m}_{3} {L}_{3}^{′}}{L} \qquad Expression 32$$

Next will be described a procedure for obtaining an inertia moment J_{B} around the hip joint. When rotation angles of the hip joint, the shoulder joint, and the elbow joint relative to the x-axis are θ₃, θ₄, and θ₅, θ₃, θ₄, and θ₅ are obtained according to Expression 33.

θ₃=ζ₁+φ₃

θ₄=ζ₁+φ₃−(π−ζ₂)

θ₅=ζ₁+φ₃−(π−ζ₂)+{π−(ζ₁+ζ₂+ζ₃)} Expression 33

When a distance from the hip joint of the upper body to a gravity center is assumed to be ½L₃, coordinates of gravity centers of the upper body, the upper arm, and the forearm with a center of the hip joint serving as an origin are expressed as Expression 34.

L_{3g}=(L_{3gx},L_{3gy})=(½L₃ cos θ₃,½L₃ sin θ₃)

L_{1g}=(L_{1gx},L_{1gy})=(L₃ cos θ₃+½L₁ cos θ₄,L₃ sin θ₃+½L₁ sin θ₄)

L_{2g}=(L_{2gx},L_{2gy})=(L₃ cos θ₃+L₁ cos θ₄+½L₂ cos θ₅,L₃ sin θ₃+L₁ sin θ₄+½L₂ sin θ₅) Expression 34

Accordingly, gravity center coordinates of an entire part including the upper body, the upper arm, and the forearm, i.e., L_{ga}=(L_{gax}, L_{gay}), are expressed as Expression 35.

$${L}_{gax} = \frac{{m}_{3} {L}_{3 gx} + {m}_{1} ( {L}_{3 x} + {L}_{1 gx} ) + {m}_{2} ( {L}_{3 x} + {L}_{1 x} + {L}_{2 gx} )}{{m}_{1} + {m}_{2} + {m}_{3}} \\ {L}_{gay} = \frac{{m}_{3} {L}_{3 gy} + {m}_{1} ( {L}_{3 y} + {L}_{1 gy} ) + {m}_{2} ( {L}_{3 y} + {L}_{1 y} + {L}_{2 gy} )}{{m}_{1} + {m}_{2} + {m}_{3}} \qquad Expression 35$$

Here, a distance from the center of the hip joint to the gravity center of the entire part including the upper body, the upper arm, and the forearm is obtained by Expression 36.

|L_{ga}|=\sqrt{L_{gax}²+L_{gay}²} Expression 36

Accordingly, when it is assumed that a uniform rod of a mass (m₁+m₂+m₃) is rotated, the inertia moment J_{B} around the hip joint is calculated according to the parallel axis theorem by Expression 37.

$${J}_{B} = \frac{1}{12} ( {m}_{1} + {m}_{2} + {m}_{3} ) {( 2 \vert {L}_{ga} \vert )}^{2} + ( {m}_{1} + {m}_{2} + {m}_{3} ) {\vert {L}_{ga} \vert}^{2} \qquad Expression 37$$

When the mass m_{B} (virtual mass mₕ+mass mw of burden), the inertia moment J_{B}, and the like are obtained as described above, a torque τ necessary to rotate the upper body upward around the hip joint is calculated based on the angle θ of the output link 30 and the torque radius L. As described in Embodiment 3, the torque τ is obtained according to Expression 38.

T=J_{B}\ddot{θ}+d\dot{θ}+k_{R}(θ−θ₀)+mBgL₀ sin θ Expression 38

Further, a sum total of energy E of a system is obtained. The sum total of the energy E is expressed as Expression 39 as described in Embodiment 3.

E=½J_{B}\dot{θ}²+½k_{R}(θ−θ₀)²+m_{B}gL₀(1−cos θ) Expression 39

Subsequently, in order to obtain a condition for minimizing the sum total of the energy E of the system, a differential calculation is performed on the energy E with respect to time as shown in Expression 40, so as to obtain a condition under which a differential value is zero.

$$\begin{matrix}\frac{d E}{d t} = {J}_{B} \dot{θ} \ddot{θ} + {k}_{R} ( θ - {θ}_{0} ) \dot{θ} + {m}_{B} {gL}_{0} sin θ \dot{θ} \\ = \{ {J}_{B} \ddot{θ} + {k}_{R} ( θ - {θ}_{0} ) + {m}_{B} {gL}_{0} sin θ \} \dot{θ} = 0\end{matrix} \qquad Expression 40$$

Then, similarly to Embodiment 3, a rotation angle θ₁ of the motor 40 is calculated from the condition under which the sum total of the energy E of the system is minimized. The rotation angle θ₁ is expressed as Expression 41.

$${θ}_{1} = n {θ}_{0} = \pm n θ \sqrt{1 + \frac{1}{η {n}^{2} {k}_{1}} ( {J}_{B} \frac{\ddot{θ}}{θ} + \frac{{m}_{B} gL}{θ} )} \qquad Expression 41$$

The controller unit 52 of the assist device 60 performs a control such that the rotation angle of the motor 40 is θ₁, that is, the outer-peripheral-side spring end portion 24e of the spiral spring 24 of the variable rigidity mechanism 20 has the angle θ₁. As a result, the apparent rigidity k_{R} of the variable rigidity mechanism 20 seen from the output link 30 is adjusted, and thus, the assist torque τ applied to the output link 30 from the output rotating shaft 26p of the variable rigidity mechanism 20 is controlled. That is, when the user lifts the burden W, the assist torque τ of the variable rigidity mechanism 20 is applied to the output link 30 in a direction where the femoral region becomes upright. Thus, a work load of the user is reduced.

Here, the disclosure is not limited to the above embodiments, and various modifications may be made without departing from the scope of the disclosure. For example, the embodiments deal with an example in which the distance L (the torque radius L) from the wrist to the rotation center C of the output link 30 is obtained with the use of the first acceleration sensor 744 and the second acceleration sensor 46. However, for example, an angle detector may be attached to an elbow joint, and the torque radius L may be obtained from the angle detector, the angle detector 43 of the output link 30, and the lengths of the upper arm and the forearm. Further, the embodiments deal with an example in which the spiral spring 24 is used as an elastic body of the variable rigidity mechanism 20. However, instead of the spiral spring 24, a coiled spring can be used or a rubbery elastic body can be used. Further, the embodiments deal with an example in which the speed reducer 26 is used in the variable rigidity mechanism 20, but the speed reducer 26 can be omitted depending on intensity of the spring. Further, the embodiments deal with an example in which the mass mw of the burden W is obtained by calculation from the load current I of the motor 40. However, the mass mw can be measured in advance and input into the controller unit 52. Further, the embodiments deal with an example in which the variable rigidity mechanisms 20 and the output links 30 are provided on right and left sides, but they may be provided only on one side.

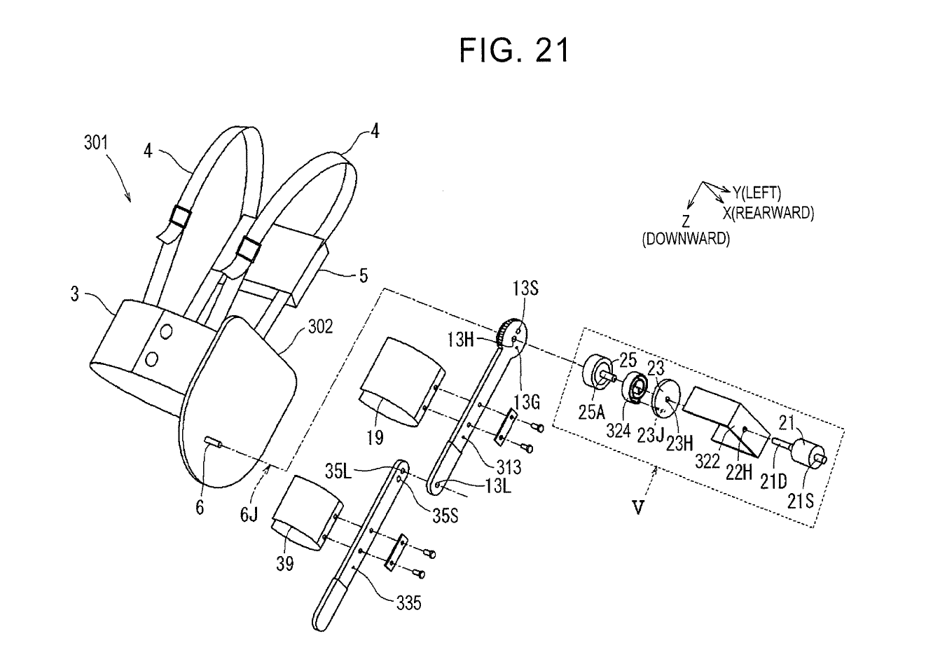

Next will be sequentially described an overall structure of a swinging joint device 301 to carry out the disclosure with reference to the drawings. Note that, when an X-axis, a Y-axis, and a Z-axis are described in each figure, the X-axis, the Y-axis, and the Z-axis are orthogonal to each other, and a Z-axis direction indicates a vertically downward direction, an X-axis direction indicates a rearward direction with respect to a user (the user who wears the swinging joint device), and a Y-axis direction indicates a left direction with respect to the user, unless otherwise specified. Note that, in the present specification, a “femoral swinging arm 313” illustrated in FIG. 21 may be regarded as a “first output portion,” and a “lower leg swinging arm 335” may be regarded as a “second output portion.” Further, an “electric motor 21” may be regarded as a “rigidity adjustment electric motor.” Further, the following description deals with an example in which a drive shaft member 6 is a projecting member, but the drive shaft member 6 may be a projecting shaft or may have a recessed shape (a hole shape) that supports a shaft. Accordingly, a description of “around the drive shaft member 6” has the same meaning as “around a drive axis 6J as a central axis of the drive shaft member 6” or “around a swing center.” Note that the “drive axis 6J” may be regarded as the “drive shaft.” Further, a “shaft 25A” of a transmission 25 may be regarded as a “first output portion-side input-output shaft portion.” Further, the “electric motor 21” may be regarded as the “rigidity adjustment electric motor”. A “rigidity adjustment member 23” and the “electric motor 21” may be regarded as an “apparent spring constant variable portion.” Further, a “flat spiral spring 324” may be regarded as an “elastic body.” Further, “rigidity” indicates a torque per unit angle displacement that is necessary to swing the femoral swinging arm 313.

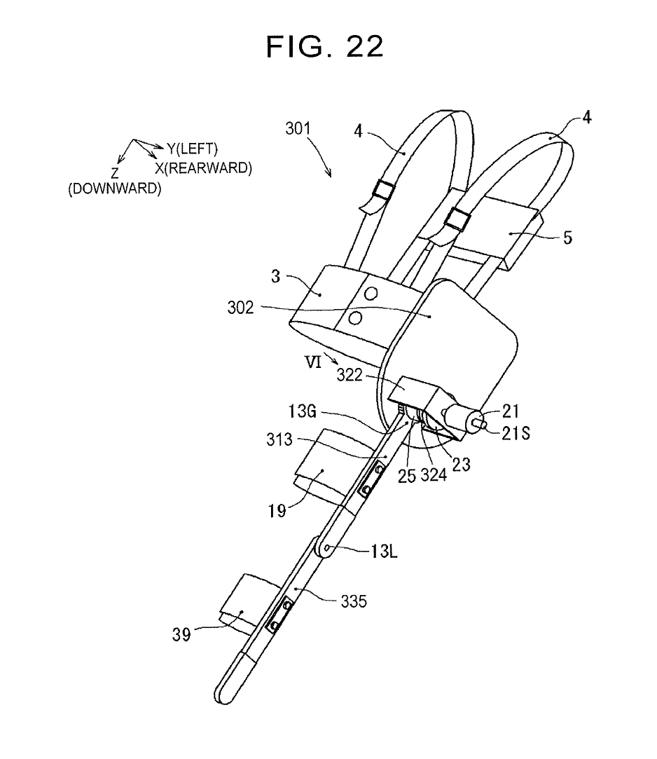

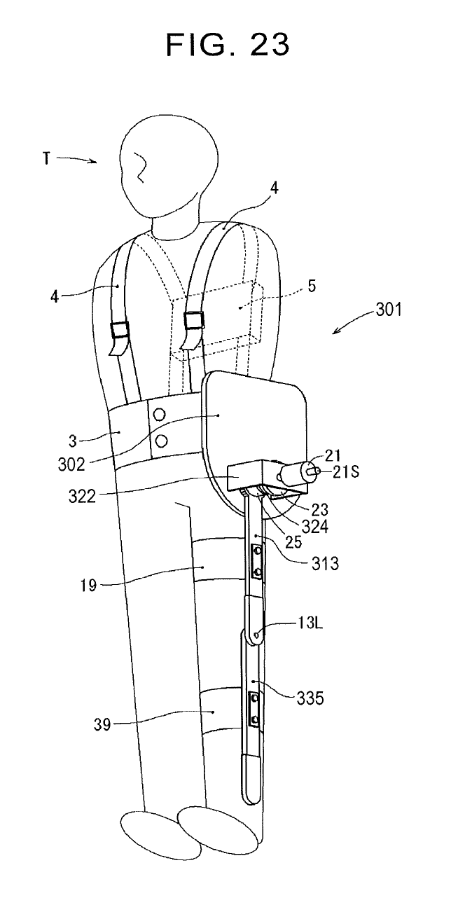

An overall configuration of the swinging joint device 301 is described with reference to FIGS. 21 to 24. The swinging joint device 301 is attached to one leg of the user or both legs of the user, so as to assist a walking motion, a running motion, or the like of the user. The following deals with an example in which the swinging joint device 301 is attached to a left leg of the user. As illustrated in FIG. 21, the swinging joint device 301 is constituted by a user attachment portion indicated by reference signs 302, 3, 4, 5, 6, and the like, a femoral swinging portion indicated by reference signs 313, 19, and the like, a rigidity adjustment portion indicated by reference signs 21, 322, 23, 324, 25, and the like, and a lower leg swinging portion indicated by reference signs 335, 39, and the like. Note that FIG. 21 is an exploded perspective view illustrating a shape and an assembling position of each constituent of the swinging joint device 301. FIG. 22 illustrates the swinging joint device 301 in a state where the constituents are assembled. Further, FIG. 23 illustrates a state where the swinging joint device 301 is attached to a user, and FIG. 24 illustrates an example of swinging of the femoral swinging arm 313 and the lower leg swinging arm 335.

The user attachment portion constituted by a base portion 302, a waist attachment portion 3, a shoulder belt 4, a control unit 5, a drive shaft member 6 and the like will be described with reference to FIGS. 21 to 24. The base portion 302 is a member fixed to the waist attachment portion 3 and serving as a base (substrate) that holds the femoral swinging portion, the rigidity adjustment portion, and the lower leg swinging portion. Further, the drive shaft member 6 extending in substantially parallel to the Y-axis is attached to the base portion 302 at a position corresponding to a side of a hip joint of the user who wears the swinging joint device 301. Note that the drive shaft member 6 is passed through a through-hole 13H of the femoral swinging arm 313. Note that the drive axis 6J indicates a central axis (a swing center axis) of the drive shaft member 6.

The waist attachment portion 3 is a member wound around a waist of the user and fixed to the waist of the user, and is configured to be adjustable in accordance with a size around the waist of the user. Further, the base portion 302 is fixed to the waist attachment portion 3 such that one end and the other end of the shoulder belt 4 are connected to the waist attachment portion 3.

The shoulder belt 4 is configured such that one end thereof is connected to a front-face side of the waist attachment portion 3, the other end thereof is connected to a back-face side of the waist attachment portion 3, and a length thereof is adjustable. The control unit 5 is attached to the shoulder belt 4. The user puts the shoulder belt 4 on his/her shoulder by adjusting the length of the shoulder belt 4, so that the user can carry the control unit 5 on the back like a backpack.

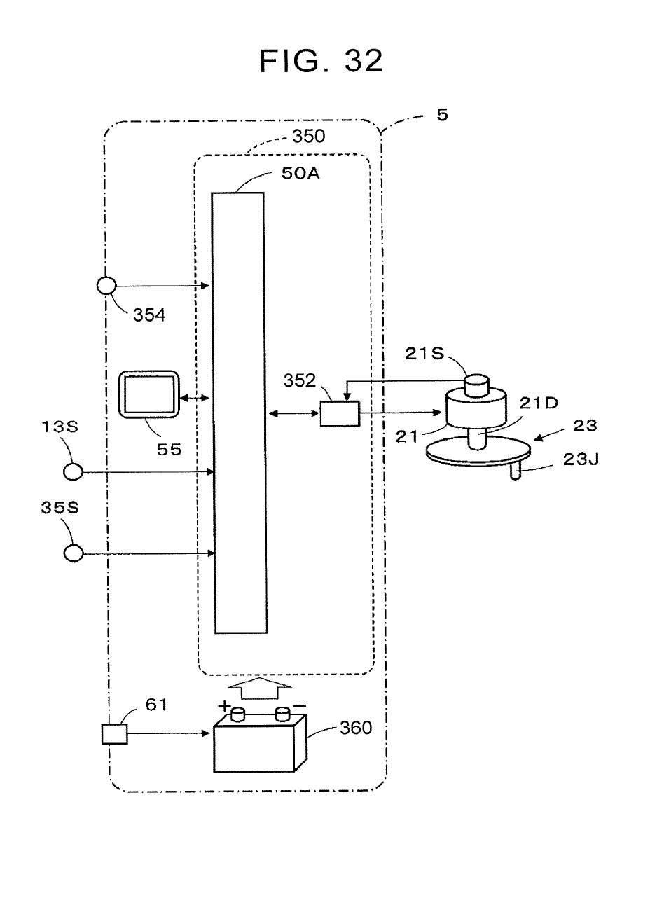

As illustrated in FIG. 32, the control unit 5 accommodates therein a controlling portion 350 that controls the electric motor 21, a battery 360 that supplies electric power to the controlling portion 350 and the electric motor 21, and the like. Note that the controlling portion 350 will be described later with reference to FIG. 32.

The femoral swinging portion constituted by the femoral swinging arm 313, a femoral attachment portion 19, and the like will be described with reference to FIGS. 21 to 24. The femoral swinging arm 313 is constituted by a circular plate portion 13G and an arm portion extending downward from the circular plate portion 13G. A through-hole 13H is formed in a center of the circular plate portion 13G, and the drive shaft member 6 is passed through the through-hole 13H. Accordingly, the femoral swinging arm 313 is supported such that the femoral swinging arm 313 swings around the drive shaft member 6. Further, the through-hole 13H of the femoral swinging arm 313 is disposed at a position corresponding to a side of the hip joint of the user, and a link hole 13L provided in a bottom end of the femoral swinging arm 313 is disposed at a position corresponding to a side of a knee joint of the user. Note that a downwardly extending length of the femoral swinging arm 313 is adjustable, and the user can adjust the position of the link hole 13L in the up-down direction in accordance with the position of his/her knee joint.

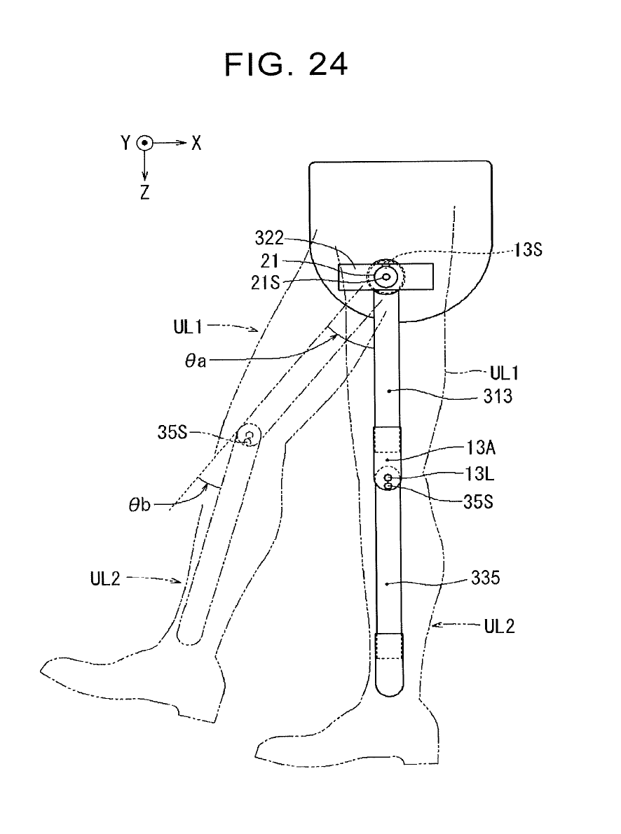

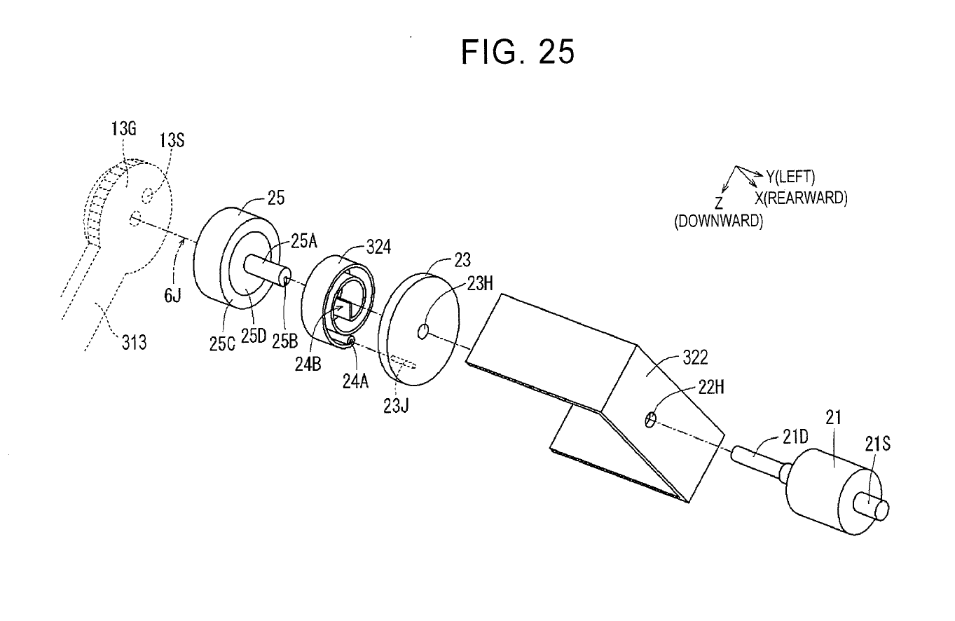

Further, the femoral attachment portion 19 is attached to the femoral swinging arm 313 such that the femoral attachment portion 19 is disposed to cover a femoral region (i.e., disposed around a thigh) of the user, which makes it easy to attach the femoral swinging arm 313 to the femoral region of the user. Further, the circular plate portion 13G is fixed to an input-output portion 25C (see FIG. 25) of the transmission 25, and the input-output portion 25C of the transmission 25 swings together with the femoral swinging arm 313. Accordingly, the input-output portion 25C of the transmission 25 swings around the drive axis 6J at the same angle as a swinging angle of the femoral swinging arm 313. Further, the femoral swinging arm 313 is provided with a first angle detecting portion 13S (e.g., an encoder) that can detect a first swinging angle that is a swinging angle of the femoral swinging arm 313 relative to the base portion 302 (or the drive shaft member 6).

The lower leg swinging portion constituted by the lower leg swinging arm 335, a lower leg attachment portion 39, and the like will be described with reference to FIGS. 21 to 24. A link hole 35L that is connected to the link hole 13L in the bottom end of the femoral swinging arm 313 is formed in the lower leg swinging arm 335. Note that a downwardly extending length of the lower leg swinging arm 335 is adjustable so as to be appropriate for a lower leg of the user. Further, the lower leg attachment portion 39 is attached to the lower leg swinging arm 335 such that the lower leg attachment portion 39 is disposed to cover the lower leg (i.e., disposed around a calf) of the user, which makes it easy to attach the lower leg swinging arm 335 to the lower leg of the user. Further, the lower leg swinging arm 335 is provided with a second angle detecting portion 35S (e.g., an encoder) that can detect a second swinging angle that is a swinging angle of the lower leg swinging arm 335 relative to the femoral swinging arm 313.

An operation of the swinging joint device 301 put on the user will be described with reference to FIG. 24. With reference to FIG. 24, an operation of the femoral swinging arm 313 attached to a femoral region UL1 of the user and an operation of the lower leg swinging arm 335 attached to a lower leg UL2 of the user will be described. Note that, in FIG. 24, positions of the femoral swinging arm 313 and the lower leg swinging arm 335, as indicated by solid lines, are assumed to be initial positions (positions at which the user stands still in an upright state) of the respective arms.

When the user swings the femoral region UL1 forward, the femoral swinging arm 313 is swung forward from its initial position by an angle θₐ. Further, a swinging angle of the lower leg swinging arm 335 relative to the femoral swinging arm 313 is an angle θ_{b}. At this time, a swing of the femoral region which requires a large torque is decreased appropriately so as to reduce a load of the user, by adjusting a turning angle of a fixed end of the flat spiral spring 324 with the use of the electric motor 21 as will be described later. Further, energy of a forward swing of the femoral region UL1 is accumulated in the flat spiral spring 324 while the turning angle of the fixed end of the flat spiral spring 324 is adjusted with the use of the electric motor 21. Further, while the turning angle of the fixed end of the flat spiral spring 324 is adjusted with the use of the electric motor 21, the energy accumulated in the flat spiral spring 324 is released so as to be used for a rearward swing of the femoral region UL1. Similarly, energy at the time of swinging the femoral region UL1 rearward is accumulated in the flat spiral spring 324 so as to be used for a forward swing of the femoral region UL1.

Thus, the swinging joint device 301 alternately repeats the following modes: an energy accumulation mode in which energy is accumulated by a swing motion of a moving body (in this case, the femoral swinging arm 313 and the femoral region UL1 of the user, and the lower leg swinging arm 335 and the lower leg UL2 of the user); and an energy release mode in which the energy thus accumulated is released so as to assist the swing motion of the moving body. Next will be described the rigidity adjustment portion including the flat spiral spring 324.

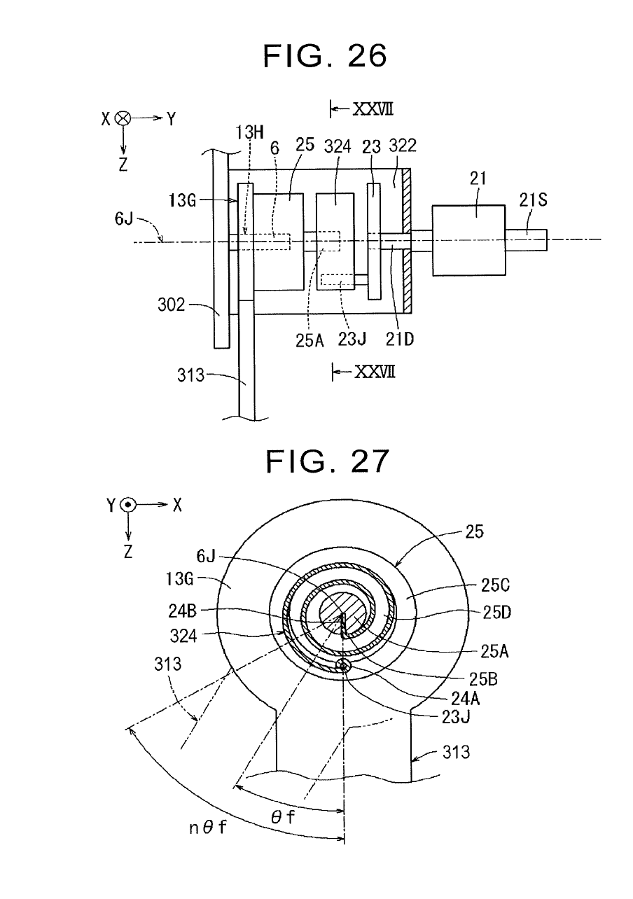

The rigidity adjustment portion constituted by the electric motor 21, a bracket 322, a rigidity adjustment member 23, the flat spiral spring 324, the transmission 25, and the like will be described with reference to FIGS. 21 to 23 and FIGS. 25 to 27. The bracket 322 is a member that fixes the electric motor 21 to the base portion 302, and is provided with a through-hole 22H through which a rotating shaft of the electric motor 21 is passed so as to be fixed to the base portion 302. Further, as illustrated in FIGS. 21, 26, the through-hole 13H of the circular plate portion 13G of the femoral swinging arm 313, the shaft 25A of the transmission 25, a central axis of the flat spiral spring 324, a through-hole 23H of the rigidity adjustment member 23, the through-hole 22H of the bracket 322, and an output shaft 21D of the electric motor 21 are disposed coaxially with the drive axis 6J.

As illustrated in FIG. 25, the transmission 25 (a speed reducer) is configured such that the input-output portion 25C is fixed to the circular plate portion 13G of the femoral swinging arm 313. Based on a preset speed changing ratio (n), the transmission 25 outputs an output turning angle nθ obtained by multiplying an input turning angle θ input to the input-output portion 25C by “n”, as a turning angle of the shaft 25A. Accordingly, as illustrated in FIG. 27, the transmission 25 includes the shaft 25A configured to swing by a changed swinging angle (nθ_{f}) that is changed at a predetermined speed changing ratio (n) at the time when the femoral swinging arm 313 swings by a first swinging angle (θ_{f}). Further, as illustrated in FIG. 25, a spring free end insertion groove 25B is formed in the shaft 25A. The spring free end insertion groove 25B is a groove extending in a drive-axis-6J direction so as to fix a free end 24B of the flat spiral spring 324. Note that, when the shaft 25A is turned by an angle θ by an urging torque from the flat spiral spring 324, the transmission 25 turns the femoral swinging arm 313 by a turning angle θ·(1/n).

The flat spiral spring 324 is configured such that an elastic body such as a spring material is wound in a spiral manner around a predetermined shaft. As illustrated in FIG. 25, one end, which is an end portion disposed in the vicinity of a central part of the winding, is the free end 24B, and the other end, which is an end portion disposed at a position distanced from the central part of the winding, is a fixed end 24A. Note that, in FIG. 25, the free end 24B is fixed to the spring free end insertion groove 25B of the shaft 25A, and the fixed end 24A is fixed to a spring support 23J of the rigidity adjustment member 23.

The through-hole 23H through which the output shaft 21D in a distal end of the electric motor 21 is passed is formed in the rigidity adjustment member 23 such that the rigidity adjustment member 23 is supported by the output shaft 21D. The rigidity adjustment member 23 is fixed to the base portion 302 via the bracket 322 and the electric motor 21. Further, the spring support 23J that supports the fixed end 24A of the flat spiral spring 324 is provided on a surface of the rigidity adjustment member 23, which faces the flat spiral spring 324, at a position distanced from the drive axis 6J. For example, the spring support 23J is a shaft-shaped member extending along a drive-axis 6J direction, and is passed through a tubular portion formed in the flat spiral spring 324 at a position of the fixed end 24A. The rigidity adjustment member 23 is turned by the electric motor 21 around the drive axis 6J, so as to change the position of the fixed end 24A of the flat spiral spring 324 in a circumferential direction. Thus, the rigidity adjustment member 23 is supported around the drive axis 6J in a turnable manner and is turned around the drive axis 6J by a predetermined turning angle, and thus, a position of the spring support 23J relative to the drive axis 6J is moved around the drive axis 6J in the circumferential direction by the predetermined turning angle.

The output shaft 21D is provided in a distal end of the electric motor 21. Further, a speed reducer may be provided in the output shaft 21D. The output shaft 21D is passed through the through-hole 22H of the bracket 322 such that the electric motor 21 is fixed to the bracket 322 and the bracket 322 is fixed to the base portion 302. Further, a driving signal and electric power are supplied to the electric motor 21 from the battery and the controlling portion accommodated in the control unit 5. The electric motor 21 turns the rigidity adjustment member 23 around the drive axis 6J relative to the bracket 322 (that is, the base portion 302), and thus, the position of the fixed end 24A of the flat spiral spring 324 can be moved in the circumferential direction. Further, the electric motor 21 is provided with a rotation angle detecting portion 21S such as an encoder. The rotation angle detecting portion 21S outputs, to the controlling portion, a signal in accordance with a rotation angle of the shaft of the electric motor 21. The controlling portion 350 can detect a turning angle of the rigidity adjustment member 23 based on a detection signal from the rotation angle detecting portion 21S. Note that an angle detecting portion (an angle sensor) configured to detect a turning angle of the rigidity adjustment member 23 relative to the bracket 322 may be provided in the bracket 322 or the base portion 302. Further, the electric motor 21 is controlled by the controlling portion 350, and the position of the fixed end 24A is maintained at a predetermined position. Further, a mechanical brake, or the like may be provided so as to maintain the position of the fixed end 24A without sending an electric current to the electric motor 21. Further, the position of the fixed end 24A may be maintained at the predetermined position by the speed reducer provided in the output shaft 21D.

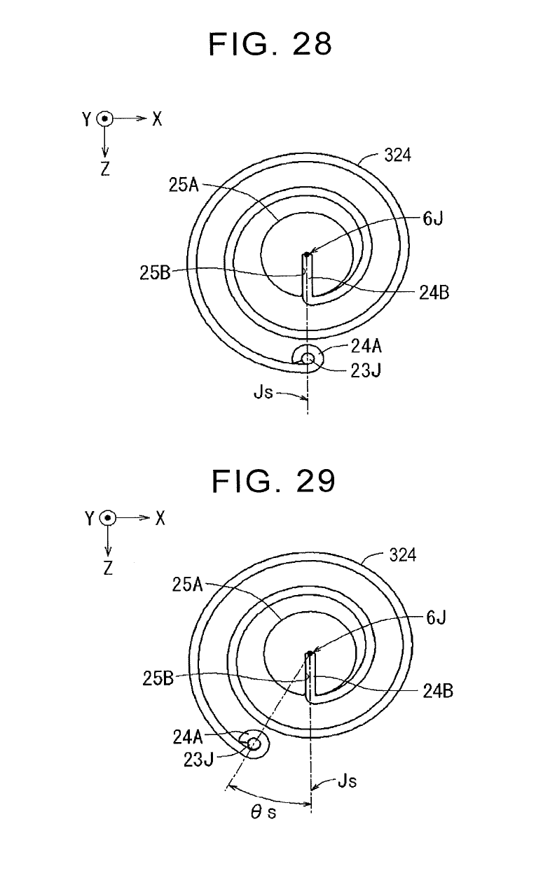

The position of the fixed end 24A of the flat spiral spring 324 and a rigidity adjustment angle θₛ will be described with reference to FIGS. 28 to 31. FIG. 28 illustrates an example in which a user T illustrated in FIG. 23 is in an upright state, a swinging angle of the femoral swinging arm 313 is zero, and an urging torque of the flat spiral spring 324 is zero. When the fixed end 24A of the flat spiral spring 324 is disposed at a position in the example of FIG. 28, an urging torque around the drive axis 6J in a clockwise direction and an urging torque around the drive axis 6J in a “counter”-clockwise direction are not generated in the free end 24B. A reference line Js illustrated in FIG. 28 is a virtual straight line passing through the drive axis 6J and the spring free end insertion groove 25B, in a case where the position of the fixed end 24A is adjusted (a turning angle of the rigidity adjustment member 23 is adjusted) so as not to generate an urging torque in the free end 24B at the time when a swinging angle of the femoral swinging arm 313 is zero. The reference line Js indicates a reference turning angle position of the shaft 25A. Further, the position of the fixed end 24A (the spring support 23J) illustrated in the example of FIG. 28 is assumed to be a reference position of the fixed end 24A (the spring support 23J) of the flat spiral spring 324. Note that, for a brief description, the example of FIG. 28 is an example in which, when the swinging angle of the femoral swinging arm 313 is zero, the reference line Js extends along a vertical direction and the fixed end 24A is disposed on the reference line Js.

Further, FIG. 29 illustrates a state where the electric motor 21 is driven from the state in FIG. 28 to change the position of the fixed end 24A of the flat spiral spring 324 to a position moved by a rotation angle (θₛ) from the reference position in the clockwise direction along a circumferential direction. This state is referred to as a “state where a clockwise rigidity adjustment angle θₛ is given to the flat spiral spring 324.” In this state, even if the swinging angle of the femoral swinging arm 313 is zero in an upright state of the user T, an urging torque of the flat spiral spring 324 is applied to the shaft 25A due to a clockwise rigidity adjustment angle θₛ, and the urging torque is applied to the femoral swinging arm 313 from the shaft 25A via the transmission 25.

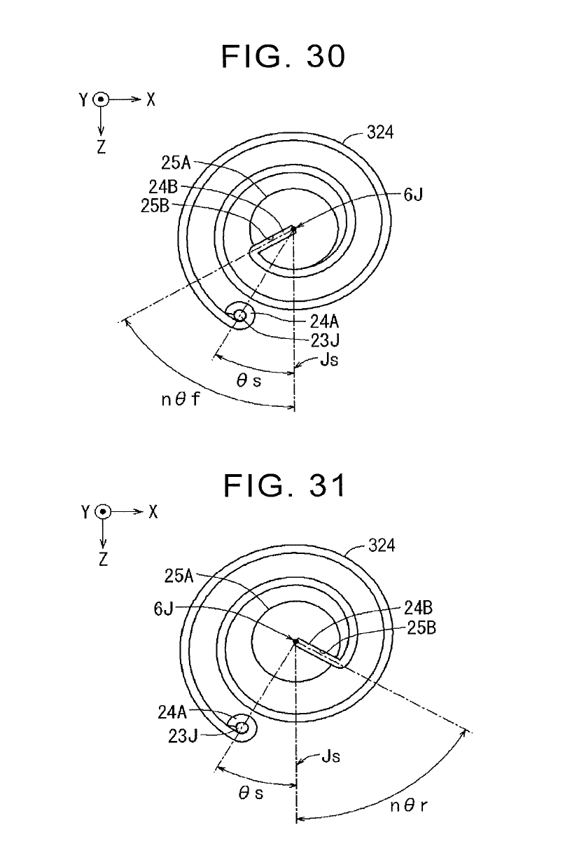

Further, FIG. 30 illustrates an example in which the femoral swinging arm 313 is swung by a swinging angle θ_{f} in the clockwise direction in a state where the “clockwise rigidity adjustment angle θₛ” illustrated in FIG. 29 is given. In a case where the speed changing ratio of the transmission 25 is assumed to be “n”, when the femoral swinging arm 313 swings by the swinging angle θ_{f} in the clockwise direction, the shaft 25A of the transmission 25 swings by the swinging angle nθ_{f} in the clockwise direction. That is, in the example illustrated in FIG. 30, a “counter”-clockwise urging torque corresponding to an angle (nθ_{f}−θₛ) obtained by subtracting the rigidity adjustment angle θₛ from the swinging angle nθ_{f} is generated in the flat spiral spring 324.

Further, FIG. 31 illustrates an example in which the femoral swinging arm 313 is swung by a swinging angle θᵣ in the “counter”-clockwise direction in a state where the “clockwise rigidity adjustment angle θₛ” illustrated in FIG. 29 is given. In a case where the speed changing ratio of the transmission 25 is assumed to be “n”, when the femoral swinging arm 313 swings by the swinging angle θᵣ in the “counter”-clockwise direction, the shaft 25A of the transmission 25 swings by the swinging angle nθᵣ in the “counter”-clockwise direction. That is, in the example illustrated in FIG. 31, a clockwise urging torque corresponding to an angle (nθᵣ+θₛ) obtained by adding the rigidity adjustment angle θₛ to the swinging angle nθᵣ is generated in the flat spiral spring 324. An apparent spring constant variable portion that changes an apparent spring constant seen from the femoral swinging arm 313 is constituted by the transmission 25 (the transmission 25 may be omitted), the flat spiral spring 324, the rigidity adjustment member 23, and the electric motor 21 (the rigidity adjustment electric motor), which are described above. The apparent spring constant variable portion changes the rigidity around the drive axis 6J. Thus, the “rigidity” indicates a torque per unit angle displacement that is necessary to swing the femoral swinging arm 313, and the apparent spring constant of the flat spiral spring 324 seen from the femoral swinging arm 313 is related to the torque. Accordingly, an “apparent rigidity of an elastic body (the flat spiral spring 324) seen from the femoral swinging arm 313” is the “apparent spring constant of the flat spiral spring 324 seen from the femoral swinging arm 313,” and the spring constant is regarded as a kind of the rigidity. Then, the rigidity of the elastic body is changed so that its energy can be stored optimally, and the energy thus stored can be released optimally. Further, an “apparent rigidity varying unit that changes the apparent rigidity of the elastic body seen from the femoral swinging arm 313” is the “apparent spring constant variable portion that changes the apparent spring constant of the flat spiral spring 324 seen from the femoral swinging arm 313.”

With reference to FIG. 32, the following describes input-output of the controlling portion 350. The control unit 5 accommodates the controlling portion 350 and the battery 360 therein. Further, the control unit 5 is provided with an activation switch 354, a touch panel 55 as an input-output portion, a charging connector 61 for the battery 360, and the like. Further, the controlling portion 350 (a control device) includes a CPU 50A, a motor driver 352, and the like. Note that a storage device that stores a program for executing a process in the controlling portion 350, various measurement results, and the like is also provided, but not illustrated herein.

As will be described later, the controlling portion 350 obtains a target rigidity adjustment angle, which is a rotation angle of the rigidity adjustment member 23 at which the apparent spring constant of the flat spiral spring 324 seen from the femoral swinging arm 313 becomes an optimum value, and outputs a driving signal to the electric motor 21 through the motor driver 352. The electric motor 21 rotates the rigidity adjustment member 23 via the output shaft 21D based on the driving signal from the controlling portion 350. Further, a rotation speed and a rotational amount of the shaft of the electric motor 21 are detected by the rotation angle detecting portion 21S, and a detection signal thereof is input into the motor driver 352 and is input into the CPU 50A via the motor driver 352. The CPU 50A performs a feedback control so that an actual rotation angle of the rigidity adjustment member 23 based on the detection signal from the rotation angle detecting portion 21S approaches the target rigidity adjustment angle.

Further, a detection signal from the first angle detecting portion 13S and a detection signal from the second angle detecting portion 35S are input into the controlling portion 350. The controlling portion 350 can detect a first swinging angle of the femoral swinging arm 313 relative to the base portion 302 based on the detection signal from the first angle detecting portion 13S. Further, the controlling portion 350 can detect a second swinging angle of the lower leg swinging arm 335 relative to the femoral swinging arm 313 based on the detection signal from the second angle detecting portion 35S.

The activation switch 354 is a switch configured to activate the controlling portion 350. Further, the touch panel 55 is a device configured to input a height, a weight, and the like of the user and to display a setting state. Further, the charging connector 61 is a connector to which a charging cable is connected at the time of charging the battery 360.

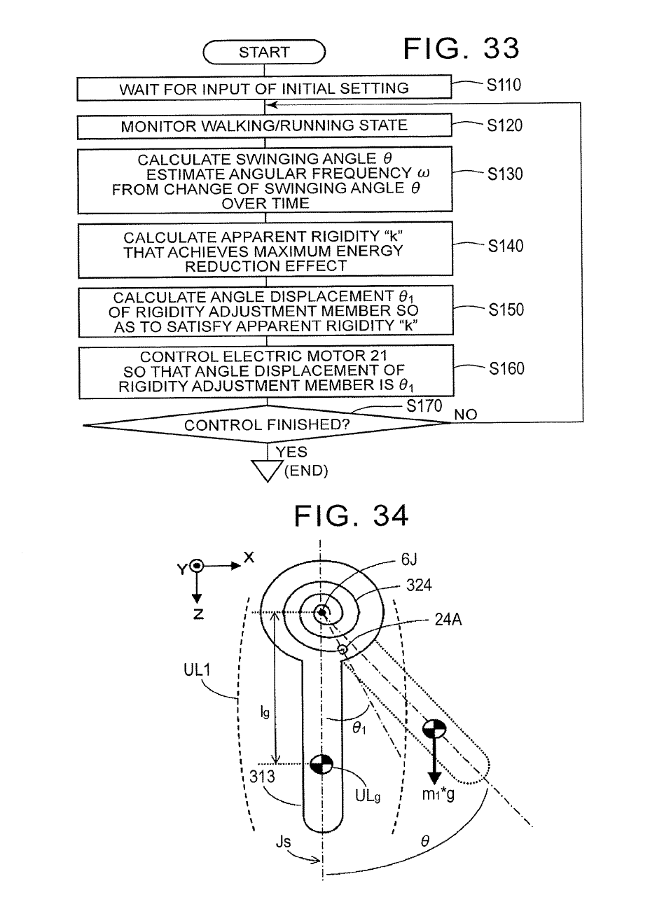

Next will be described an example of a procedure for a controlling portion according to Embodiment 5 in consideration of an influence of a gravitational force applied to a moving body (a femoral swinging arm 313+a femoral region UL1+a lower leg UL2 (see FIG. 24)), which is a lower limb of a user including the femoral swinging arm 313, with reference to FIGS. 33 to 35. Note that a swinging joint device according to Embodiment 5 does not particularly require the lower leg swinging arm 335 in the configuration illustrated in FIGS. 21 to 24. In a case where the lower leg swinging arm 335 is omitted, a mass m₁ of the moving body should be a “mass of the femoral swinging arm 313+the femoral region UL1+the lower leg UL2.” In a case where the lower leg swinging arm 335 is not omitted, the mass m₁ of the moving body should be a “mass of the femoral swinging arm 313+the femoral region UL1+the lower leg swinging arm 335+the lower leg UL2.”

Subsequently, the following describes a procedure of the controlling portion 350 with the use of a flowchart illustrated in FIG. 33. When a user operates an activation switch of a control unit, the controlling portion proceeds to step S110.

The controlling portion waits for input of an initial setting from the user via a touch panel (i.e., the controlling portion waits for the user to input the initial setting via the touch panel) in step S110. When the controlling portion determines that a height and a weight are input from the user, the controlling portion proceeds to step S120. Note that, in a case where the controlling portion does not receive any input from the user even after a predetermined time, the controlling portion, for example, sets a preset standard height and standard weight, and then proceeds to step S120.

In step S120, the controlling portion measures a walking state (or a running state) of the user during a predetermined period, and stores, in a storage device, a detection signal from a first angle detecting portion 13S as measurement data in association with a measurement time. After the controlling portion collects the measurement data during a predetermined number of steps or a predetermined period of time, the controlling portion proceeds to step S130.

In step S130, the controlling portion calculates a first swinging angle θ and the like of the femoral swinging arm from the measurement data based on the detection signal from the first angle detecting portion 13S. Then, the controlling portion estimates an angular frequency ω and the like from a change of the first swinging angle θ over time, and then proceeds to step S140.

In step S140, based on the height and weight of the user, which are input in step S110, and the first swinging angle θ of the femoral swinging arm, the angular frequency ω of the femoral swinging arm, and the like, which are calculated in step S130, the controlling portion calculates an apparent spring constant k of a flat spiral spring 324 at which a maximum energy reduction effect is obtained, and then, the controlling portion proceeds to step S150. Note that a detailed calculation procedure for the apparent spring constant k of the flat spiral spring 324 will be described later.

In step S150, the controlling portion calculates a rotation angle θ₁ (a rotation angle of the rigidity adjustment member 23) of an electric motor 21 so as to satisfy the apparent spring constant k of the flat spiral spring 324, and proceeds to step S160. Note that a detailed calculation procedure for the rotation angle θ₁ (a rotation angle of a rigidity adjustment member 23) of the electric motor 21 will be described later.

In step S160, the controlling portion controls the electric motor 21 so that the rotation angle of the rigidity adjustment member 23 is θ₁, and then proceeds to step S170.

In step S170, the controlling portion monitors a walking state (or a running state), and determines whether or not the user wants to stop assistance for the walking motion (or running motion). When it is determined that the user wants to stop the assistance (Yes), the controlling portion stops the control, and when it is determined that the user does not want to stop the assistance (No), the controlling portion returns to step S120.

Next will be described a calculation method for the apparent rigidity k of the flat spiral spring seen from the moving body and the rotation angle θ₁ of the electric motor 21. The following description is made with the following definitions. Note that the following l_{g}, J₁, and m₁ are estimated by the controlling portion 350 based on the input height, weight, and the like of the user. Further, c₁, k₁, n, η are set in the controlling portion 350 in advance. Here, τ indicates a driving torque (Nm) around the drive axis 6J illustrated in FIG. 34. τ₁ indicates a motor torque (Nm) of the electric motor 21. J₁ indicates an inertia moment (kgm²) of the moving body. c₁ indicates a viscosity coefficient (Nms/rad) of the moving body. k indicates an apparent rigidity (spring constant) (Nm/rad) of the flat spiral spring 324 seen from the moving body. k₁ indicates an original spring constant (Nm/rad) of the flat spiral spring 324. m₁ indicates a mass (kg) of the moving body. g indicates gravitational acceleration (m/s²). I_{g} indicates a distance (m) from the drive axis 6J as a swing center to a gravity center UL_{g} of the moving body. θ indicates a swinging angle of the moving body (a displacement angle of the femoral swinging arm 313) (rad). |θ| indicates an amplitude (rad) of a displacement angle of the moving body. θ′ indicates a torsional amount (rad) of the flat spiral spring 324. θ₁ indicates a rotation angle of the electric motor 21 (a rotation angle of the rigidity adjustment member 23) (rad). ω indicates an angular frequency (rad/s) of the moving body. t indicates a time (s). n indicates a speed reducing ratio of the transmission 25. η indicates an efficiency of the transmission 25.

An equation of motion of the moving body can be expressed as Expression 42. When the 5-order Taylor expansion is used for Expression 42, Expression 43 can be obtained as follows.

$$\begin{matrix}τ = {J}_{1} \ddot{θ} + {c}_{1} \dot{θ} + k θ + {m}_{1} {gl}_{g} sin θ & Expression 42 \\ τ = {J}_{1} \ddot{θ} + {c}_{1} \dot{θ} + k θ + {m}_{1} {gl}_{g} ( θ - \frac{{θ}^{3}}{3 !} + \frac{{θ}^{5}}{5 !} ) & Expression 43\end{matrix}$$

Here, when Expression 44 is satisfied, Expression 45 can be obtained as follows.

$$\begin{matrix}\dot{θ} = \frac{a}{d} sin ω t , d = {c}_{1} & Expression 44 \\ τ = ( {J}_{1} ω - \frac{1}{ω} ( k + {m}_{1} {gl}_{g} ( 1 - \frac{{( - \frac{a}{{c}_{1} ω} cos ω t )}^{2}}{3 !} + \frac{{( - \frac{a}{{c}_{1} ω} cos ω t )}^{4}}{5 !} ) ) ) \frac{a}{{c}_{1}} cos ω t + a sin ω t & Expression 45\end{matrix}$$

Further, the displacement angle θ of the femoral swinging arm 313 and the amplitude |θ| of the displacement angle of the moving body can be expressed as Expression 46 and Expression 47 as follows. Further, Expression 48 can be obtained from Expression 44 and Expression 47.

$$\begin{matrix}θ = \int \dot{θ} dt = - \frac{a}{{c}_{1} ω} cos ω t & Expression 46 \\ \vert θ \vert = a / ( d ω ) & Expression 47 \\ a = \vert θ \vert {c}_{1} ω & Expression 48\end{matrix}$$

Further, when Expression 48 is substituted into Expression 45, Expression 49 can be obtained as follows.

$$τ = ( {J}_{1} ω - \frac{1}{ω} ( k + {m}_{1} {gl}_{g} ( 1 - \frac{{( - \vert θ \vert cos ω t )}^{2}}{3 !} + \frac{{( - \vert θ \vert cos ω t )}^{4}}{5 !} ) ) ) \vert θ \vert ω cos ω t + {c}_{1} \vert θ \vert ω sin ω t = A \vert θ \vert ω cos ω t + B \vert θ \vert ω sin ω t \qquad Expression 49$$

In this case, a torque amplitude can be expressed as Expression 50 as follows. In order to minimize |τ| in Expression 50, A=0 should be satisfied in Expression 50, and when the apparent rigidity at that time is assumed to be k, Expression 51 is established as follows. Expression 52 can be obtained from Expression 51.

$$\begin{matrix}\vert τ \vert = \sqrt{{A}^{2} {\vert θ \vert}^{2} {ω}^{2} + {B}^{2} {\vert θ \vert}^{2} {ω}^{2}} . & Expression 50 \\ {J}_{1} ω - \frac{1}{ω} ( k + {m}_{1} {gl}_{g} ( 1 - \frac{{( - \vert θ \vert cos ω t )}^{2}}{3 !} + \frac{{( - \vert θ \vert cos ω t )}^{4}}{5 !} ) ) = 0 & Expression 51 \\ k = {J}_{1} {ω}^{2} - {m}_{1} {gl}_{g} ( 1 - \frac{{( - \vert θ \vert cos ω t )}^{2}}{3 !} + \frac{{( - \vert θ \vert cos ω t )}^{4}}{5 !} ) & Expression 52\end{matrix}$$

Here, when it is assumed that forces are balanced, t at the time when the flat spiral spring is seen from the moving body can be expressed as Expression 53. Further, τ at the time when the moving body is seen from the flat spiral spring can be expressed as Expression 54.

τ=kθ Expression 53

τ=ηnτ₁ Expression 54

A torque τ₁ that occurs in the input shaft of the speed reducer can be expressed by Expression 55 as follows. Here, when it is assumed that the electric motor 21 is rotated to rotate the fixed end of the flat spiral spring by θ₁, Expression 56 can be obtained as follows. Further, when Expression 56 is substituted into Expression 55, Expression 57 can be obtained as follows.

τ₁=k₁θ′ Expression 55

θ′=nθ−θ₁ Expression 56

τ₁=k₁(nθ−θ₁) Expression 57

When Expression 57 is substituted into Expression 54, Expression 58 can be obtained. Consequently, Expression 59 and Expression 60 can be obtained from Expression 58 and Expression 53.

τ=ηnk₁(nθ−θ₁)=ηn²k₁[1−θ₁/(nθ)]θ Expression 58

k=ηn²k₁[1−θ₁/(nθ)] Expression 59

θ₁=nθ[1−k/(ηn²k₁)] Expression 60

Accordingly, in step S140 in the flowchart illustrated in FIG. 33, the apparent rigidity k is calculated based on Expression 59, and in step S150, the rotation angle θ₁ of the rigidity adjustment member 23 is calculated based on a calculation result of k and Expression 60. Thus, by adjusting the rotation angle θ₁ at the position of the fixed end 24A of the flat spiral spring 324 in real time so that the apparent rigidity k is satisfied with respect to the first swinging angle θ of the femoral swinging arm 313, it is possible to reduce a load (energy of walking or running) of the user. The first swinging angle θ changes from moment to moment.

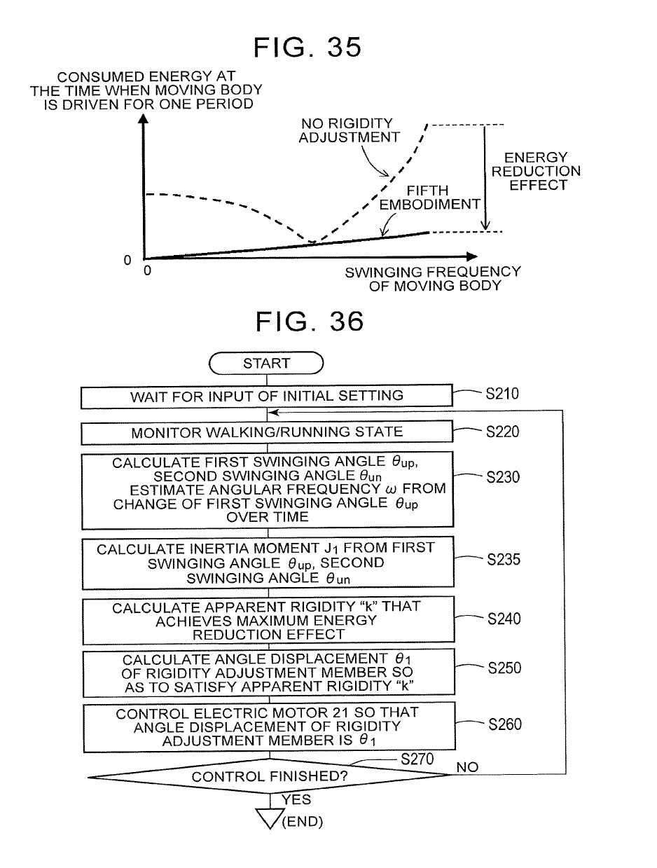

Note that FIG. 35 illustrates examples of characteristics at the time when rigidity adjustment is not performed and at the time when rigidity adjustment described in Embodiment 5 is performed, in a case where a horizontal axis indicates a swinging frequency of the moving body and a vertical axis indicates consumed energy at the time when the moving body is driven for one period. By performing the rigidity adjustment (adjustment in consideration of an influence of a gravitational force) of Embodiment 5, it is possible to obtain an energy reduction effect in accordance with the swinging frequency of the moving body.

Next will be described an example of a procedure of a controlling portion according to Embodiment 6 in consideration of an influence of a gravitational force applied to a moving body (a femoral swinging arm 313+a femoral region UL1+a lower leg swinging arm 335+a lower leg UL2 (see FIG. 24)), which is a lower limb of a user including the femoral swinging arm 313, and an influence of a change of inertia moment applied to the moving body, with reference to FIGS. 36 to 39. Note that the swinging joint device according to Embodiment 6 requires the femoral swinging arm 313 and the lower leg swinging arm 335 in the configuration illustrated in FIG. 21, and the following moving body indicates “the femoral swinging arm 313+the femoral region UL1+the lower leg swinging arm 335+the lower leg UL2.” Further, a femoral region mass nm indicates a “mass of the femoral swinging arm 313+the femoral region UL1,” and a lower leg mass mᵤₙ indicates a “mass of the lower leg swinging arm 335+the lower leg UL2.”

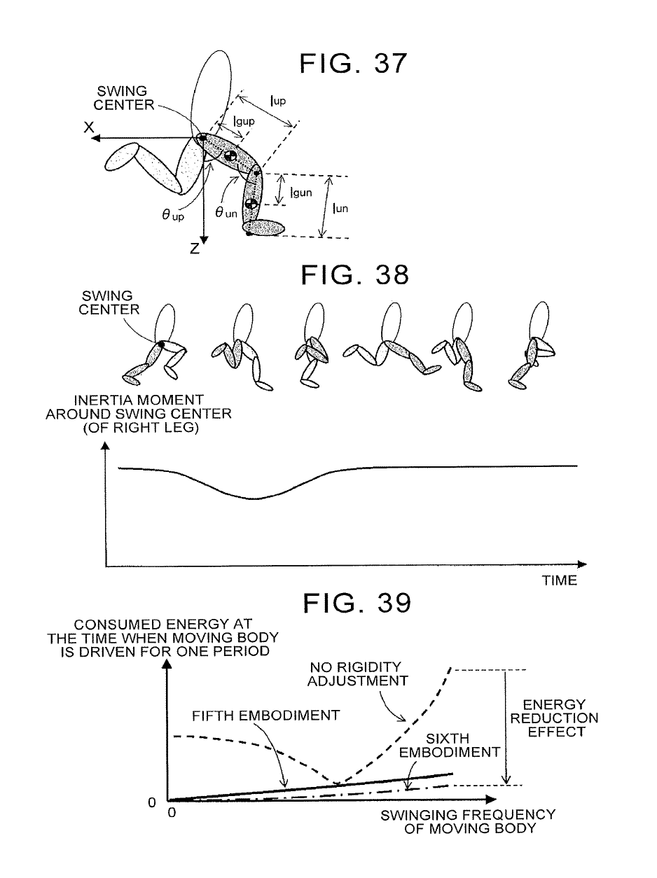

At the time of walking of a user who wears the swinging joint device, a second swinging angle (a swinging angle θᵤₙ in FIG. 37), which is a bending angle of a knee, is at or around approximately 180 degrees (°), and a change of the second swinging angle is small, and a fluctuation of an inertia moment of the moving body (around a swing center) is also small, and thus, an influence of a change of the inertia moment does not need to be considered particularly. However, at the time of running of the user who wears the swinging joint device, the second swinging angle, which is the bending angle of the knee, greatly changes between approximately a few degrees (°) to approximately 180 degrees (°) as illustrated in FIG. 38, and thus, the fluctuation of the inertia moment of the moving body is large (at the time when the knee is bent more greatly, the inertia moment fluctuates greatly). Accordingly, in consideration of the fluctuation of the inertia moment, it is possible to obtain a larger energy reduction effect as illustrated in FIG. 39.

Next will be described a procedure of the controlling portion 350 with reference to a flowchart illustrated in FIG. 36. When a user operates the activation switch of the control unit, the controlling portion proceeds to step S210.

The controlling portion waits for input of an initial setting from the user via a touch panel in step S210. Note that step S210 is similar to step S110 illustrated in FIG. 33, so a detailed description thereof is omitted.

In step S220, the controlling portion measures a walking state (or a running state) of the user during a predetermined period, and stores, in a storage device, a detection signal from a first angle detecting portion 13S and a detection signal from a second angle detection portion 35S as measurement data in association with a measurement time. After the controlling portion collects the measurement data during a predetermined number of steps or a predetermined period of time, for example, the controlling portion proceeds to step S230.

In step S230, the controlling portion calculates a first swinging angle θᵤₚ (see FIG. 37) of the femoral swinging arm from the measurement data based on the detection signal from the first angle detecting portion 13S, and calculates a second swinging angle θᵤₙ, (see FIG. 37) of the lower leg swinging arm relative to the femoral swinging arm from the measurement data based on the detection signal from the second angle detecting portion 35S. Then, the controlling portion estimates an angular frequency ω and the like from a change of the first swinging angle θᵤₚ over time, and then proceeds to step S235.

In step S235, the controlling portion calculates an inertia moment J₁ based on the first swinging angle θᵤₚ and the second swinging angle θᵤₙ, and then proceeds to step S240. Note that a detailed calculation procedure for the inertia moment J₁ will be described later.

In step S240, based on a height and a weight of the user, which are input in step S210, and the first swinging angle θᵤₚ of the femoral swinging arm, the angular frequency ω of the femoral swinging arm, and the second swinging angle θᵤₙ of the lower leg swinging arm, which are calculated in step S230, the inertia moment J₁ calculated in step S235, and the like, the controlling portion calculates an apparent spring constant k of a flat spiral spring 324 at which a maximum energy reduction effect is obtained, and then, the controlling portion proceeds to step S250. Note that a detailed calculation procedure for the apparent spring constant k of the flat spiral spring 324 will be described later.

In step S250, the controlling portion calculates a rotation angle θ₁ (a rotation angle of a rigidity adjustment member 23) of an electric motor 21 so as to satisfy the apparent spring constant k of the flat spiral spring 324, and proceeds to step S260. Note that a detailed calculation procedure for the rotation angle θ₁ (a rotation angle of the rigidity adjustment member 23) of the electric motor 21 will be described later.

In step S260, the controlling portion controls the electric motor 21 so that the rotation angle of the rigidity adjustment member 23 is θ₁, and then proceeds to step S270.

In step S270, the controlling portion monitors a walking state (or a running state), and determines whether or not the user wants to stop assistance for the walking motion (or running motion). When it is determined that the user wants to stop the assistance (Yes), the controlling portion stops the control, and when it is determined that the user does not want to stop the assistance (No), the controlling portion returns to step S220.

A calculation method for the inertia moment J₁ will be described below with the following definition. Note that the following lₛ, lᵤₚ, lᵤₙ, l_{gun}, m₁, mᵤₚ, mᵤₙ, for example, are estimated by the controlling portion 350 based on the input height, weight, and the like of the user. Further, c₁, k₁, n, η are set in the controlling portion 350 in advance. Here, τ indicates a driving torque (Nm) around a swing center illustrated in FIG. 37. τ indicates a motor torque (Nm) of the electric motor 21. J₁ indicates an inertia moment of the moving body (kgm²). c₁ indicates a viscosity coefficient (Nms/rad) of the moving body. k indicates an apparent rigidity (a spring constant) (Nm/rad) of the flat spiral spring 324 seen from the moving body. k₁ indicates an original spring constant (Nm/rad) of the flat spiral spring 324. m₁ indicates a mass (=mᵤₚ+mᵤₙ) (kg) of the moving body (the femoral region of the user+the femoral swinging arm+the lower leg of the user+the lower leg swinging arm). mᵤₚ indicates a mass (kg) of “the femoral region of the user+the femoral swinging arm.” mᵤₙ indicates a mass (kg) of “the lower leg of the user+the lower leg swinging arm.” g indicates gravitational acceleration (m/s²). l_{g} indicates a distance (m) from the swing center to a gravity center of a whole moving body. lᵤₚ indicates a distance (m) from the swing center to a knee joint (a connecting portion between the femoral swinging arm and the lower leg swinging arm). lᵤₙ indicates a distance (m) from the knee joint to a bottom end of the lower leg. l_{gup} indicates a distance (m) from the swing center to a gravity center of “the femoral region of the user+the femoral swinging arm.” l_{gun} indicates a distance (m) from the knee joint to a gravity center of “the lower leg of the user+the lower leg swinging arm.” θᵤₚ indicates a first swinging angle (a displacement angle of the femoral swinging arm 313 and a thigh raising angle) (rad). θᵤₙ indicates a second swinging angle (an angle of the lower leg swinging arm relative to the femoral swinging arm and a knee bending angle) (rad). |θ| indicates an amplitude (rad) of the first swinging angle. θ′ indicates a torsional amount (rad) of the flat spiral spring 324. θ₁ indicates a rotation angle (a rotation angle of the rigidity adjustment member 23) (rad) of the electric motor 21. ω indicates an angular frequency (rad/s) of the moving body. t indicates a time (s). n indicates a speed reducing ratio of the transmission 25. η indicates an efficiency of the transmission 25.

As illustrated in FIG. 37, a direction vertically downward is set to a Z-direction and a direction directed toward a rear side relative to a user is set to a an X-axis direction. When the swing center in FIG. 37 is assumed to be an origin (0, 0), a coordinate l_{gupx}, in the X-axis direction, of a gravity center of “the femoral region+the femoral swinging arm” relative to the swing center and a coordinate l_{gupz}, in the Z-axis direction, of the gravity center can be expressed as Expression 61 and Expression 62.

l_{gupx}=−l_{gup} sin θᵤₚ Expression 61

l_{gupz}=−l_{gup} cos θᵤₚ Expression 62

Further, a coordinate l_{gunx}, in the X-axis direction, of a gravity center of “the lower leg+the lower leg swinging arm” relative to the swing center and a coordinate l_{gunz}, in the Z-axis direction, of the gravity center can be expressed as Expression 63 and Expression 64.

l_{gunx}=−lᵤₚ sin θᵤₚ+l_{gun} sin(θᵤₚ+θᵤₙ) Expression 63

l_{gunz}=lᵤₚ cos θᵤₚ−l_{gun} cos(θᵤₚ+θᵤₙ) Expression 64

Thus, an X-coordinate l_{gx} of a gravity center of the whole moving body “the femoral region+the femoral swinging arm+the lower leg+the lower leg swinging arm” relative to the swing center and a Z-coordinate l_{gz} of the gravity center can be expressed as Expression 65 and Expression 66.

l_{gx}=−(l_{gupx}mᵤₚ+l_{gunx}mᵤₙ)/(mᵤₚ+mᵤₙ) Expression 65

l_{gx}=−(l_{gupz}mᵤₚ+l_{gunz}mᵤₙ)/(mᵤₚ+mᵤₙ) Expression 66

Further, the inertia moment J of the whole moving body around the swing center is obtained on the assumption that an elongated uniform rod with a length l_{g} and a mass (mᵤₚ+mᵤₙ) is rotated from an end. At this time, the inertia moment J can be derived from the parallel axis theorem according to Expression 67. Note that Expression 68 is also established.

J=( 1/12)(mᵤₚ+mᵤₙ)(2l_{g})²+(mᵤₚ+mᵤₙ)(l_{g})² Expression 67

l_{g}=\sqrt{[(lgx)2+(lgz)2]} Expression 68

Next will be described a calculation method for the apparent rigidity k of the flat spiral spring seen from the moving body and the rotation angle θ₁ of the electric motor 21. J in Expression 67 is assumed to be J₁ and is substituted for J₁ in Expression 42 in Embodiment 5. That is, by substituting J of Expression 67 for J₁ in Expression 52 in Embodiment 5, the apparent rigidity k of the flat spiral spring can be obtained. Further, when an obtained value of the apparent rigidity k is substituted into Expression 60 in Embodiment 5, the rotation angle θ₁ of the electric motor 21 can be obtained.

Accordingly, in step S240 in the flowchart illustrated in FIG. 36, the apparent rigidity k is calculated as described above, and in step S250, the rotation angle θ₁ of the rigidity adjustment member 23 is calculated based on the calculated “k” and Expression 60. Thus, by adjusting the rotation angle θ₁ at the position of the fixed end 24A of the flat spiral spring 324 in real time so that the apparent rigidity k is satisfied with respect to the first swinging angle θᵤₚ of the femoral swinging arm 313 and the second swinging angle θᵤₙ of the lower leg swinging arm 335, it is possible to reduce a load (energy for walking or running) of the user. The first swinging angle θᵤₚ and the second swinging angle θᵤₙ change from moment to moment.

Note that FIG. 39 illustrates examples of characteristics at the time when rigidity adjustment is not performed, at the time when the rigidity adjustment described in Embodiment 5 is performed, and at the time when the rigidity adjustment described in Embodiment 6 is performed, in a case where a horizontal axis indicates a swinging frequency of the moving body and a vertical axis indicates consumed energy at the time when the moving body is driven for one period. By performing the rigidity adjustment of Embodiment 6 (in consideration of an influence of a gravitational force and an influence of a change of inertia moment), it is possible to obtain an even larger energy reduction effect as compared to a case of performing the rigidity adjustment (the adjustment in consideration of an influence of a gravity force) of Embodiment 5.

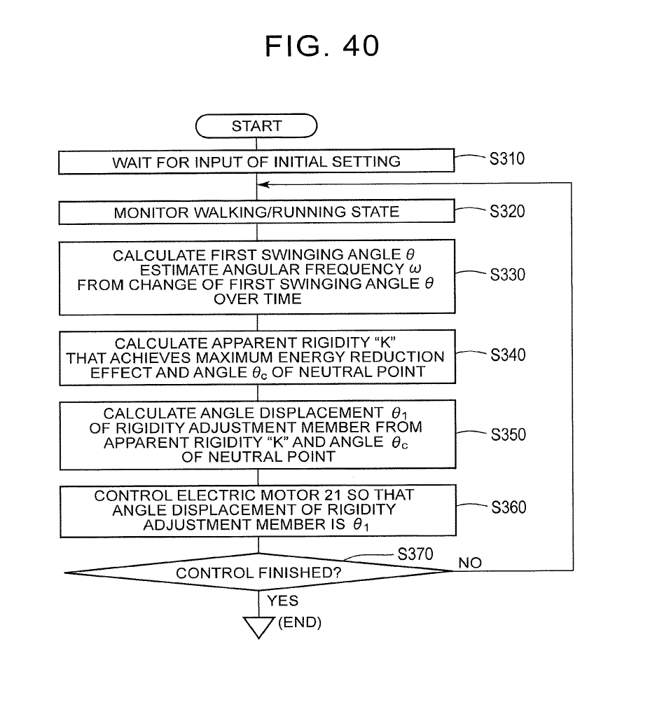

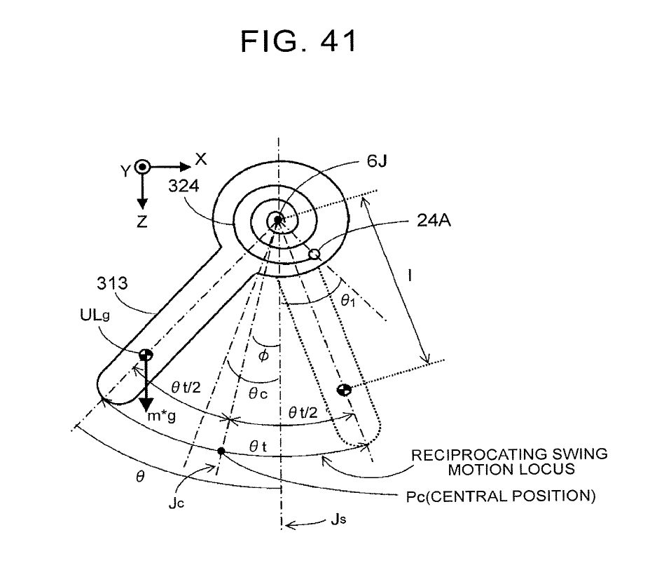

Next will be described an example of a procedure of a controlling portion according to Embodiment 7 in consideration of an influence of a gravitational force applied to a moving body (a femoral swinging arm 313+a femoral region UL1+a lower leg UL2 (see FIG. 24)), which is a lower limb of a user including the femoral swinging arm 313, and an influence of a central position of a reciprocating swing motion locus (a neutral point of a flat spiral spring) with reference to FIGS. 40 and 41. Note that a swinging joint device according to Embodiment 7 does not particularly require the lower leg swinging arm 335 in the configuration illustrated in FIGS. 21 to 24. In a case where the lower leg swinging arm 335 is omitted, a mass m₁ of the following moving body should be assumed to be a “mass of the femoral swinging arm 313+the femoral region UL1+the lower leg UL2.” In a case where the lower leg swinging arm 335 is not omitted, the mass m₁ of the moving body should be assumed to be a “mass of the femoral swinging arm 313+the femoral region UL1+the lower leg swinging arm 335+the lower leg UL2.”

At the time of walking of the user who wears the swinging joint device, generally, a central position Pc (see FIG. 41) of the reciprocating swing motion locus of the femoral swinging arm 313 is different from a position of a reference line Js that extends vertically downward, and is disposed at a position inclined toward a front side relative to the user by a central angle φ (approximately 2 to 3 degrees (°) in general). Accordingly, in consideration of an influence of the central angle φ, it is possible to obtain a larger energy reduction effect. Note that, as illustrated in FIG. 41, the central angle φ is an angle formed by a virtual straight line Jc connecting a swing center (a drive axis 6J) and a central position Pc with respect to a gravitational acceleration direction, and is an angle formed between the virtual straight line Jc and the reference line Js in the example of FIG. 41.

Next will be described a procedure of the controlling portion 350 with reference to a flowchart illustrated in FIG. 40. When a user operates an activation switch of a control unit, the controlling portion proceeds to step S310.

The controlling portion waits for input of an initial setting from the user via a touch panel in step S310. Note that step S310 is similar to step S110 illustrated in FIG. 33, so a detailed description thereof is omitted.

In step S320, the controlling portion measures a walking state (or a running state) of the user during a predetermined period, and stores, in a storage device, a detection signal from a first angle detecting portion 13S as measurement data in association with a measurement time. After the controlling portion collects the measurement data during a predetermined number of steps or a predetermined period of time, the controlling portion proceeds to step S330.

In step S330, the controlling portion calculates a first swinging angle θ (see FIG. 41) of the femoral swinging arm from the measurement data based on the detection signal from the first angle detecting portion 13S. Then, the controlling portion estimates an angular frequency ω and the like from a change of the first swinging angle θ over time, and then proceeds to step S340.

In step S340, based on a height and a weight of the user, which are input in step S310, and the first swinging angle θ of the femoral swinging arm, the angular frequency ω of the femoral swinging arm, and the like, which are calculated in step S330, the controlling portion calculates an apparent spring constant K of a flat spiral spring 324 at which a maximum energy reduction effect is obtained, and an angle θ_{c} of a neutral point of the flat spiral spring 324 (a position where the flat spiral spring generates no torque), and then, the controlling portion proceeds to step S350. Note that a detailed calculation procedure for the apparent spring constant K of the flat spiral spring 324 and the angle θ_{c} of the neutral point will be described later.

In step S350, the controlling portion calculates a rotation angle θ₁ (a rotation angle of a rigidity adjustment member 23) of an electric motor 21 so as to satisfy the apparent spring constant K of the flat spiral spring 324, and proceeds to step S360. Note that a detailed calculation procedure for the rotation angle θ₁ (the rotation angle of the rigidity adjustment member 23) of the electric motor 21 will be described later.

In step S360, the controlling portion controls the electric motor 21 so that the rotation angle of the rigidity adjustment member 23 is θ₁, and then proceeds to step S370.

In step S370, the controlling portion monitors a walking state (or a running state), and determines whether or not the user wants to stop assistance for the walking motion (or running motion). When it is determined that the user wants to stop the assistance (Yes), the controlling portion stops the control, and when it is determined that the user does not want to stop the assistance (No), the controlling portion returns to step S320.

Next will be described a calculation method for the apparent rigidity K of the flat spiral spring seen from the moving body and an angle θ_{C} of the neutral point. The description is made with the following definition as illustrated in FIG. 41. Note that the following l, J, and m are estimated by the controlling portion 350 based on the input height, weight, and the like of the user. Further, c, k₁, n, η are set in the controlling portion 350 in advance. τ indicates a driving torque (Nm) around the drive axis 6J. τ₁ indicates a motor torque (Nm) of the electric motor 21. J indicates an inertia moment (kgm²) of the moving body. c indicates a viscosity coefficient (Nms/rad) of the moving body. K indicates an apparent rigidity (a spring constant) (Nm/rad) of the flat spiral spring 324 seen from the moving body. k₁ indicates an original spring constant (Nm/rad) of the flat spiral spring 324. m indicates a mass (kg) of the moving body. g indicates gravitational acceleration [m/s²]. l indicates a distance (m) from the drive axis 6J as a swing center to a gravity center UL_{g} of the moving body. θ indicates a swinging angle (a displacement angle of the femoral swinging arm 313) (rad) of the moving body. |θ| indicates an amplitude (rad) of the displacement angle of the moving body. θ′ indicates a torsional amount (rad) of the flat spiral spring 324. θ₁ indicates a rotation angle (a rotation angle of the rigidity adjustment member 23) (rad) of the electric motor 21. θ_{c} is a virtual angle set so as to calculate θ₁, and indicates an angle (rad) of the neutral point (a virtual position when the flat spiral spring outputs no torque) of the flat spiral spring. φ indicates a central angle (rad), which is an angle of a central position of the reciprocating swing motion locus of the moving body. Pc indicates the central position of the reciprocating swing motion locus of the moving body. ω indicates an angular frequency (rad/s) of the moving body. t indicates a time (s). n indicates a speed reducing ratio of the transmission 25. η indicates an efficiency of the transmission 25.

When a driving torque is assumed to be T, a dynamics of an output link (the femoral swinging arm) in consideration of the angle θₑ of the neutral point of the flat spiral spring is given by Expression 69 as follows. Here, for simplification, when sin θ approximates to θ such that sin θ≈θ, Expression 69 is rewritten to Expression 70 as follows.

T=J\ddot{θ}+c\dot{θ}+K(θ−θc)+mgl sin θ Expression 69

T=J\ddot{θ}+c\dot{θ}+K(θ−θc)+mglθ Expression 70

In order to minimize energy of a system in Expression 70, Expression 71 should be established as follows.

J\ddot{θ}+K(θ−θₑ)+mglθ=θ Expression 71

Here, when α=(K+mgl)/J and β=Kθₑ/J are satisfied, Expression 71 can be rewritten to Expression 72 as follows. Further, when a homogeneous equation is established such that the right side of Expression 72 is set to 0, Expression 73 is obtained as follows.

\ddot{θ}+αθ=β Expression 72

\ddot{θ}+αθ=0 Expression 73

When 0=eλt is substituted into Expression 73 to obtain a solution of a characteristic equation, a solution shown in Expression 74 can be obtained as follows. Accordingly, a fundamental solution of the homogeneous equation is Expression 75 as follows.

λ=±\sqrt{(αi)} Expression 74

θ=e^{\sqrt{α}it},e^{-\sqrt{α}it} Expression 75

Then, when a solution is obtained at the time when the right side is not 0, Expression 76 is obtained from the Wronski determinant. When this is solved to obtain a particular solution, Expression 77 is derived as follows.

$$\begin{matrix}W ( t ) = \vert \begin{matrix}{e}^{\sqrt{α} it} & {e}^{- \sqrt{α} it} \\ \sqrt{α} {e}^{\sqrt{α} it} & - \sqrt{α} {e}^{- \sqrt{α} it}\end{matrix} \vert = - 2 \sqrt{α} i & Expression 76 \\ θ = - {e}^{\sqrt{α} it} \int \frac{{e}^{- \sqrt{α} it} \cdot β}{W ( t )} dt + {e}^{- \sqrt{α} it} \int \frac{{e}^{\sqrt{α} it} \cdot β}{W ( t )} dt = \frac{β}{α} = \frac{K}{K + mgl} {θ}_{c} & Expression 77\end{matrix}$$

Accordingly, a general solution of a inhomogeneous equation is given according to Expression 78 as follows.

$$θ = {A}_{1} {e}^{\sqrt{α} it} + {A}_{2} {e}^{- \sqrt{α} it} + \frac{K}{K + mgl} {θ}_{c} = ( {A}_{1} + {A}_{2} ) cos \sqrt{α} t + i ( {A}_{1} - {A}_{2} ) sin \sqrt{α} t + \frac{K}{K + mgl} {θ}_{c} \qquad Expression 78$$

Here, when A₁=A₂=A/2 is satisfied, Expression 78 can be rewritten to Expression 79 as follows.

$$\begin{matrix}θ = A cos \sqrt{α} t + \frac{K}{K + mgl} {θ}_{c} \\ = A cos \sqrt{\frac{K + mgl}{J}} t + \frac{K}{K + mgl} {θ}_{c}\end{matrix} \qquad Expression 79$$

A reciprocating swing motion can be expressed as Expression 80 as follows. Further, Expression 79 and Expression 80 indicate the same motion. In view of this, from these expressions, the apparent rigidity K of the flat spiral spring seen from the moving body and the angle θ_{c} of the position of the neutral point of the flat spiral spring are expressed as Expression 81 and Expression 82. Note that Expression 81 can be obtained from [(K+mgl)/J]=ω according to Expression 79. Further, Expression 82 can be obtained from [K/(K+mgl)]θ_{c}=φ according to Expression 79.

θ=|θ| cos ωt+φ Expression 80

K=Jω²−mgl Expression 81

θ_{c}=[1+mgl/K]φ Expression 82

A calculation method for the rotation angle θ₁ of the electric motor 21 will be described. When a speed reducing ratio of a transmission is n, an efficiency of the transmission is η, and an original spring constant of the flat spiral spring is k₁, and when it is assumed that forces are balanced, a driving torque τ of the output link (the femoral swinging arm) can be expressed as Expression 83 and Expression 84 as follows. Note that Expression 53 of Embodiment 5 shows θ_{c}=0.

τ=K(θ−θ_{c}) Expression 83

τ=ηnτ₁ Expression 84

Here, τ₁ is a torque that occurs on an input side (an electric motor 21-side) of the transmission and can be expressed as Expression 85 with a rotation angle θ of the output link (the femoral swinging arm) and the rotation angle θ₁ of the rigidity adjustment member 23 (the rotation angle of the electric motor 21) as follows.

τ₁=k₁(nθ−θ₁) Expression 85

When Expression 85 is substituted into Expression 84, Expression 86 can be obtained.

τ=ηnk₁(nθ−θ₁) Expression 86

From Expression 86 and Expression 83, 0₁ can be expressed as shown in Expression 87 as follows.

θ₁=n(θ−θ_{c})[1−K/(ηn²k₁)]+nθ_{c}=nθ[1−K/(ηn²k₁)]+(Kθₑ)/(ηn²k₁) Expression 87

From Expression 82 and Expression 87, Expression 88 can be obtained as follows.

θ₁=nθ[1−K/(ηn²k₁)]+[φ/(ηnk₁)](K+mgl) Expression 88

Accordingly, in step S340 in the flowchart illustrated in FIG. 40, the apparent rigidity K is calculated based on Expression 81, and the angle θ_{c} of the neutral point is calculated based on the calculated K and Expression 82. Then, in step S350, the rotation angle θ₁ of the rigidity adjustment member 23 is calculated based on the apparent rigidity K, the angle θ_{c} of the neutral point, Expression 88, and Expression 82. Thus, by adjusting the rotation angle θ₁ of the position of the fixed end 24A of the flat spiral spring 324 in real time so that the apparent rigidity K is satisfied with respect to the first swinging angle θ of the femoral swinging arm 313, it is possible to reduce a load (energy for walking or running) of the user. The first swinging angle θ changes from moment to moment.

Embodiment 5 describes a method in consideration of an influence of a gravitational force (i.e., a gravitational influence). Further, Embodiment 7 considers the gravitational influence and the influence of the central position of the reciprocating swing motion locus (the neutral point of the flat spiral spring). However, in a case where only the central position of the reciprocating swing motion locus is taken into consideration, the rotation angle θ₁ should be calculated by assuming that mgl sin θ of the right side in Expression 69 is zero and eliminating a term related to the gravitational influence. Further, Embodiment 6 considers the gravitational influence and the influence of the change of inertia moment. However, in a case where only the influence of the change of inertia moment is taken into consideration, the rotation angle θ₁ should be calculated by assuming that a second term in the right side in Expression 52 is zero and eliminating a term related to the gravitational influence. Further, when the method in consideration of only the central position is applied to Embodiment 6, the gravitational influence, the influence of the change of inertia moment, and the influence of the central position can be taken into consideration, and accordingly, an even larger energy reduction effect can be obtained. Further, when the term related to the gravitational influence is eliminated from the method in consideration of the gravitational influence, the influence of the change of inertia moment, and the influence of the central position, it is possible to obtain a method in consideration of the influence of the change of inertia moment and the influence of the central position. Thus, it is possible to obtain a larger energy reduction effect as compared to a conventional technique, when the apparent rigidity (spring constant) of the flat spiral spring seen from the femoral swinging arm is adjusted based on the first swinging angle and at least one of a gravitational force that acts on the moving body in accordance with the first swinging angle (the gravitational influence), an inertia force that acts on the moving body in accordance with the first swinging angle and a motion state of the moving body state (the influence of the change of inertia moment), and the central position of the reciprocating swing motion locus of the femoral swinging arm (the influence of the central position).

Various modifications, additions, and deletions may be made to the structure, the configuration, the shape, the appearance, the procedure, the computing equation, and the like of the swinging joint device of the disclosure without departing from the scope of the disclosure.

The purpose of the swinging joint device described in each embodiment is not limited to assisting a swing motion (walking or running) of the lower limb of the user. The swinging joint device in each embodiment is applicable to various objects such as various instruments or devices that perform a periodic swing motion with the use of an electric motor or the like.

Further, in the embodiments, the transmission 25 is provided between the femoral swinging arm 313 and the flat spiral spring 324, so as to indirectly connect the flat spiral spring 324 to the femoral swinging arm 313. However, the transmission 25 may be omitted and the femoral swinging arm 313 and the flat spiral spring 324 may be connected directly.

Further, the embodiments deal with an example in which the flat spiral spring 324 is used as an elastic body, but various elastic bodies can be used instead of the flat spiral spring 324. For example, another elastic body such as a helically wound extensible spring, leaf spring, or wave spring may be usable. Further, rubber, elastomer such as resin, an elastic body using liquid such as oil or gas may be used. The elastic body may be changed in accordance with a momentum of an object (motion) for which energy should be stored or an amount of energy to be stored. In a case where the amount of energy to be stored is relatively small, it is effective to use elastomer. Further, with regard to a motion such as walking or running of the user, it is effective to use a flat spiral spring in view of its relatively large storage amount of energy, a magnitude of a spring constant (rigidity) or the like, easiness in adjustment, and the like. Further, the flat spiral spring is also advantageous in terms of cost.

The swinging joint device has been described as a device for a left leg of a user. However, the swinging joint device may additionally include a base portion for a right leg (symmetric to the base portion 302), a femoral swinging portion for the right leg (symmetric to members indicated by reference signs 313, 19, and the like), a rigidity adjustment portion for the right leg (symmetric to members indicated by reference signs 21, 322, 23, 324, 25, and the like), and a lower leg swinging portion for the right leg (symmetric to members indicated by reference signs 335, 39, and the like) such that the control unit 5 assists the walking motion (or running motion) of both legs of the user.

Further, according to the above embodiments, in walking or running of the user, the apparent rigidity varying unit is controlled in consideration of the influences of a gravitational force, an inclination posture of the user, and an inertia force, from a time when a frequency of a periodic swing motion is low at a low speed immediately after the walking or running starts to a time when the frequency of the periodic swing motion is high at a high speed after the speed of the walking or running is increased. This makes it possible to perform an optimum control on the frequency of the swing motion (a frequency of the moving body). When the frequency of the swing motion is low, the gravitational influence increases. In this regard, it is possible to perform a control in consideration of the gravitational influence. Meanwhile, as the frequency of the swing portion increases, the gravitational influence decreases, and the influence of the inertia force increases. In this regard, it is possible to perform a control in consideration of the influence of the inertia force. Further, it is also possible to perform a control in accordance with a degree of the inclination posture of the user, and thus, an effective energy reduction effect can be obtained.

Embodiment 8 for carrying out the disclosure will be described below with reference to the drawings. The present embodiment describes a linear motion variable rigidity unit included in a grinding machine, by taking the grinding machine as an example of a machine tool. Note that when an X-axis, a Y-axis, and Z-axis are described in the figures, the X-axis, the Y-axis, and the Z-axis are orthogonal to each other.

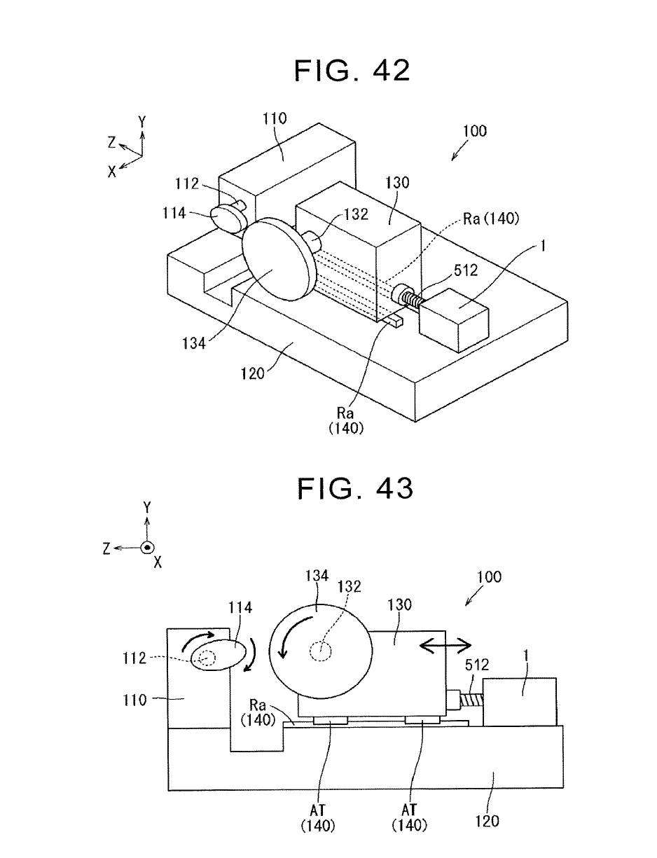

A grinding machine 100 illustrated in FIGS. 42 and 43 includes an object support base 110, a table support base 120, a reciprocation table 130 (a linear reciprocating body), a table drive device 140, and a linear motion variable rigidity unit 1. The object support base 110 and the table support base 120 are disposed adjacently to each other in the Z-axis. The object support base 110 includes an object support shaft 112 extending in the X-axis direction. A grinding object 114 is attached to a distal end of the object support shaft 112. The grinding object 114 is supported so as to be rotatable around the object support shaft 112. A sectional shape of the grinding object 114 seen from the X-axis direction is a non-perfect circle. Note that, as a method of supporting the grinding object 114, the grinding object 114 may be supported from both sides of the grinding object 114 by a chuck, a center, and the like.

The reciprocation table 130 is disposed on the table support base 120. The reciprocation table 130 linearly reciprocates along rails Ra extending in the Z-axis direction. By the linear reciprocating motion, the reciprocation table 130 moves closer to or moves away from the object support base 110. The reciprocation table 130 includes a grindstone 134. The grindstone 134 is supported by a grindstone support shaft 132 extending in the X-axis direction from the reciprocation table 130, so as to be rotatable around the grindstone support shaft 132. The grindstone 134 grinds the grinding object 114 when the reciprocation table 130 moves close to the object support base 110. Note that sliders AT facing the rails Ra are attached to a bottom face of the reciprocation table 130.

The table drive device 140 is a linear motor, for example, and is configured by applying a magnetic field to the rails Ra and the sliders AT. The table drive device 140 causes the reciprocation table 130 to linearly reciprocate at a predetermined frequency ω (a predetermined period T). Drive energy of the table drive device 140 for causing the reciprocation table 130 to linearly reciprocate is minimized by assistance provided by the after-mentioned linear motion variable rigidity unit 1.

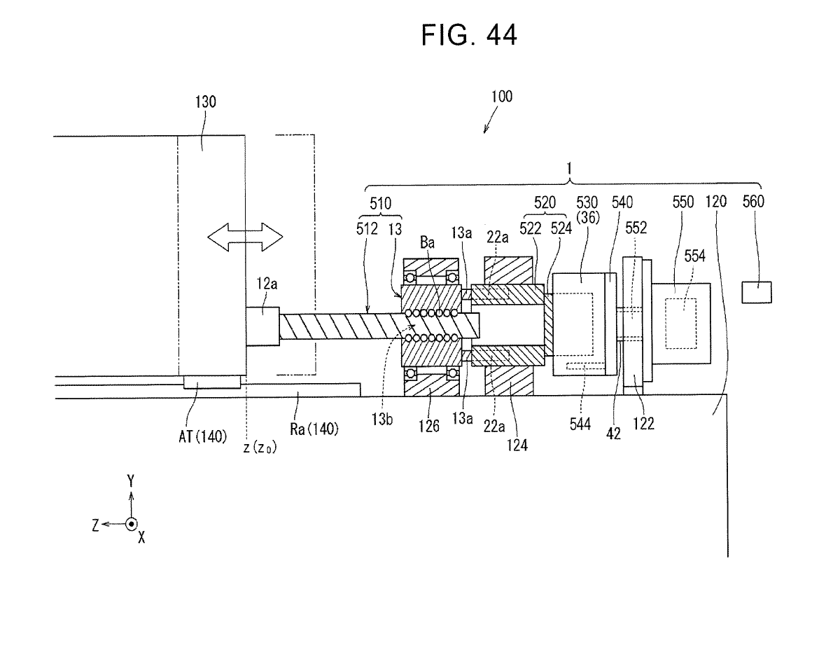

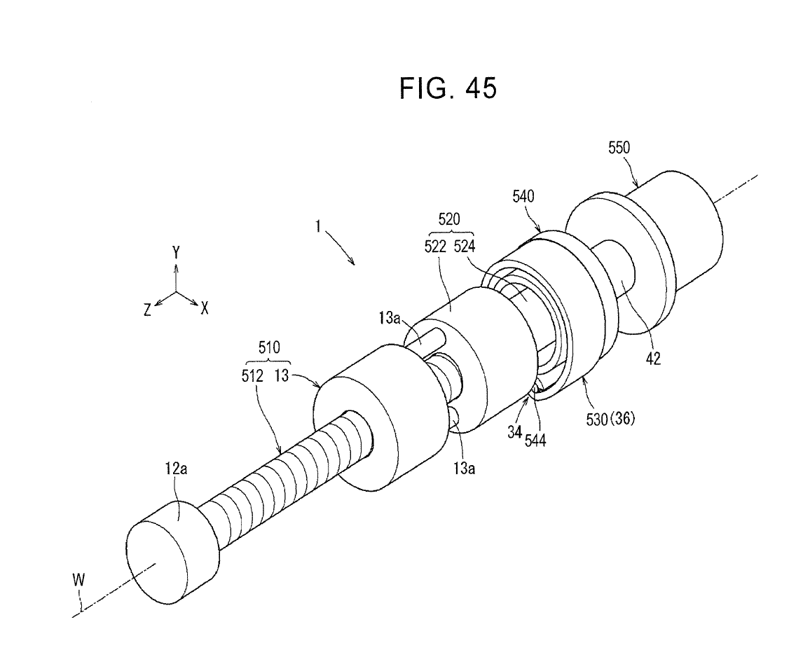

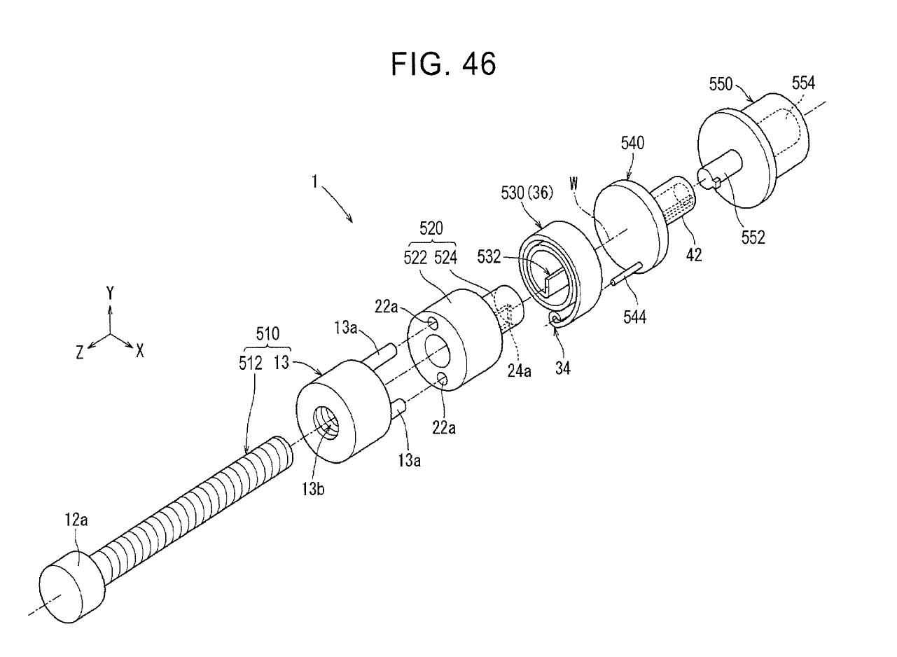

The linear motion variable rigidity unit 1 is attached to the reciprocation table 130, and more specifically, attached to the reciprocation table 130 at a position on a side opposite to the object support base 110 in the Z-axis direction. Note that the linear motion variable rigidity unit 1 is covered with a cover in FIGS. 42 and 43. The linear motion variable rigidity unit 1 (see FIGS. 44 to 46) includes: a linear motion-rotation conversion mechanism 510 including a screw shaft member 512 (a linear-motion input-output portion) and a nut 13 (a rotational motion input-output portion); a speed reducer 520; a variable rigidity mechanism 36 including a spiral spring 530 (an elastic body); a turning member 540; a rigidity variable actuator 550; a control device 560; and a support member constituted by the table support base 120. Note that, in FIGS. 45, 46, the control device 560 and the table support base 120 are omitted. As illustrated in FIGS. 44 to 46, the nut 13, the speed reducer 520, the spiral spring 530, the turning member 540, and the rigidity variable actuator 550 are disposed sequentially from the reciprocation table 130-side in the Z-axis direction. Further, the screw shaft member 512, a through-hole 13b of the nut 13, an input-output cylinder 522 and an input-output shaft 524 of the speed reducer 520, the spiral spring 530, a cylindrical portion 42 of the turning member 540, and a motor output shaft 552 of the rigidity variable actuator 550 are all disposed coaxially, and a reference sign W is assigned to their central axes collectively in each of FIGS. 45 and 46. The central axes W extend in the Z-axis direction.

The screw shaft member 512 (see FIGS. 44 to 46) is a ball screw, for example. The screw shaft member 512 extends through the through-hole 13b of the nut 13. A connection end 12a, which is one end of the screw shaft member 512, is connected to the reciprocation table 130. The screw shaft member 512 linearly reciprocates together with the reciprocation table 130 without rotating around its central axis W.

The nut 13 (see FIGS. 44 to 46) is fitted to a spiral groove of the screw shaft member 512 via a plurality of rolling elements Ba (e.g., balls). The nut 13 is supported by a nut support portion 126 (see FIG. 44) of the table support base 120 such that the nut 13 is rotatable around the central axis W of the through-hole 13b without moving in the Z-axis direction. The nut 13 rotationally reciprocates along with a linear reciprocating motion of the screw shaft member 512. Note that the nut 13 includes fitting rods 13a projecting toward the speed reducer 520.

The screw shaft member 512 and the nut 13 perform an energy accumulation operation in which energy is accumulated in the spiral spring 530, and an energy release operation in which the energy is released from the spiral spring 530. In the energy accumulation operation, a linear reciprocating motion input into the screw shaft member 512 from the reciprocation table 130 is converted to a rotational reciprocating motion by the nut 13, and the nut 13 outputs the rotational reciprocating motion to the spiral spring 530. In the energy release operation, a rotational reciprocating motion of the nut 13 in accordance with a torque of the spiral spring 530 is converted to a linear reciprocating motion by the screw shaft member 512, and the screw shaft member 512 outputs the linear reciprocating motion to the reciprocation table 130. The energy accumulation operation and the energy release operation will be described later more specifically in connection with the spiral spring 530.

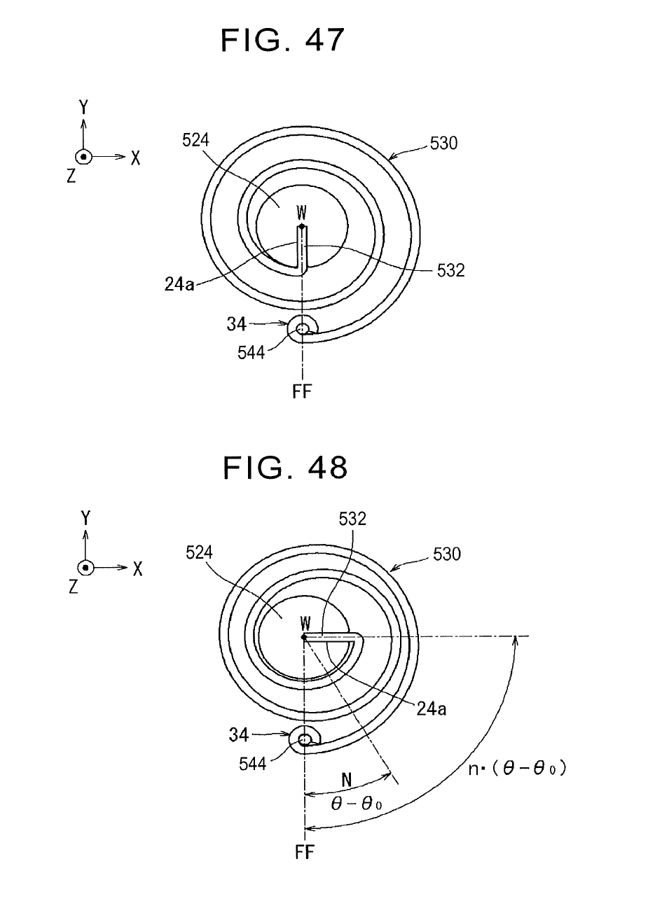

The speed reducer 520 (see FIGS. 44 to 46) converts a rotational amount between the nut 13 and the spiral spring 530 based on a preset speed reducing ratio. The speed reducer 520 includes the input-output cylinder 522 and the input-output shaft 524 that are rotatable in synchronization with each other on the same axis, for example, and the input-output shaft 524 rotates “n” times as many as the number of rotations of the input-output cylinder 522. The input-output cylinder 522 rotates together with the nut 13, and the input-output shaft 524 rotates together with an inner end 532 of the spiral spring 530. For example, the input-output cylinder 522 has a fitting hole 22a. The fitting hole 22a faces the nut and is provided in a thick part of the input-output cylinder 522. The fitting rod 13a of the nut 13 is fitted into the fitting hole 22a. The input-output shaft 524 has an engaging groove 24a (see FIGS. 46 and 47) that is cut toward the central axis W. The inner end 532 of the spiral spring 530 is fitted into the engaging groove 24a. The speed reducer 520 is supported by a speed reducer supporting portion 124 (see FIG. 44) of the table support base 120 so as to be rotatable around its central axis W without moving in the Z-axis direction.

The inner end 532 (an end portion on a side of the central axis W, i.e., an end portion close to the central axis W) of the spiral spring 530 (see FIGS. 44 to 46) is connected to the nut 13 via the speed reducer 520, and an outer end 34 (an end portion on a side radially distanced from the central axis W) thereof is connected to the rigidity variable actuator 550 via the turning member 540. For example, the inner end 532 is a linear portion bent toward the central axis W. The inner end 532 is fitted into the engaging groove 24a of the speed reducer 520 as has been already described (see FIGS. 46 and 47). The outer end 34 forms a through-hole winding around the after-mentioned spring support shaft 544. The spring support shaft 544 is passed through the outer end 34. The spiral spring 530 accumulates elastic energy when the inner end 532 and the outer end 34 are turned relative to each other in opposite directions around the central axis W thereof.

As will be described later more specifically with reference to FIGS. 47 to 50, in a case where the screw shaft member 512 and the nut 13 perform the energy accumulation operation, the spiral spring 530 accumulates, as the elastic energy, input energy that is generated along with the linear reciprocating motion of the reciprocation table 130, and is input from the nut 13. Further, in a case where the screw shaft member 512 and the nut 13 perform the energy release operation, the spiral spring 530 releases accumulated energy that is the elastic energy accumulated in the spiral spring 530, to the reciprocation table 130 via the nut 13 and the screw shaft member 512.

The turning member 540 (see FIGS. 44 to 46) transmits rotation of the motor output shaft 552 of the rigidity variable actuator 550 to the spiral spring 530. The turning member 540 includes the cylindrical portion 42 projecting toward the rigidity variable actuator 550 on the central axis W, and the spring support shaft 544 provided at a position radially distanced from the central axis W so as to project toward the spiral spring 530. The motor output shaft 552 is fitted into the cylindrical portion 42 so as to be prevented from falling off from the cylindrical portion 42. The cylindrical portion 42 rotates together with the motor output shaft 552. As has been described above, the spring support shaft 544 is passed through the outer end 34 of the spiral spring 530 (see FIGS. 45 and 47).

The rigidity variable actuator 550 (see FIGS. 44 to 46) is fixed at a predetermined position by an actuator support portion 122 of the table support base 120. The motor output shaft 552 is rotationally driven by the electric motor 554 in both of forward and reverse directions. The rotational driving of the motor output shaft 552 is controlled by the control device 560. The motor output shaft 552 turns the outer end 34 of the spiral spring 530 around the central axis W via the turning member 540. As has been already described, when the outer end 34 is turned relative to the inner end 532, the elastic energy is accumulated in the spiral spring 530. When a rotation angle displacement of the inner end 532 relative to the outer end 34 is changed, a rigidity of the spiral spring 530 seen from the linear motion-rotation conversion mechanism 510, that is, an apparent spring constant of the spiral spring 530 is changed.

The control device 560 (see FIG. 44) controls the rigidity variable actuator 550 so as to reduce drive energy of the table drive device 140, which is required to cause the reciprocation table 130 to linearly reciprocate. More specifically, the control device 560 drives the motor output shaft 552 to change the rotation angle displacement of the spiral spring 530 so as to change the apparent spring constant, thereby minimizing the drive energy. A method of setting the apparent spring constant will be described later.

Subsequently, a turning state of the spiral spring 530 at the time when the screw shaft member 512 and the nut 13 perform the energy accumulation operation and the energy release operation will be described mainly with the use of FIGS. 47 to 50. Note that, in the following description, a current position of the reciprocation table 130 in the Z-axis direction is indicated by “z” (see FIG. 44), and a current rotation angle of the nut 13 is indicated by θ. As illustrated in FIG. 44, the current position “z” of the reciprocation table 130 is defined as an end portion of the reciprocation table 130, the end portion being connected to the screw shaft member 512. Note that the reciprocation table 130 linearly reciprocates with a reciprocation central position z₀ serving as a center in a reciprocating motion. In FIG. 44, the current position “z” of the reciprocation table 130 coincides with the reciprocation central position z₀. When the reciprocation table 130 is disposed at the reciprocation central position z₀, a rotation angle of the nut 13 is a reference angle θ₀. When the rotation angle of the nut 13 is the reference angle θ₀, the spiral spring 530 is in a free state where no torque is accumulated. The spiral spring 530 in the free state is illustrated in FIG. 47. A reference line FF illustrated in FIG. 47 is a virtual straight line that passes through the central axis W of the spiral spring 530 and the outer end 34, and indicates an outer-end reference position (i.e., a reference position of the outer end). Further, the reference line FF is also a virtual straight line extending along the inner end 532 of the spiral spring 530, and indicates an inner-end reference position (i.e., a reference position of the inner end). Further, the reference line FF indicates a reference position of rotation of the nut 13 in FIG. 48 to be described subsequently.

FIG. 48 illustrates a state of the spiral spring 530 at the time when the reciprocation table 130 (see FIG. 44) linearly moves by a predetermined distance from the reciprocation central position z₀, and corresponds to a state where the screw shaft member 512 and the nut 13 perform the energy accumulation operation. Note that the motor output shaft 552 is not driven. In FIG. 48, the nut 13 rotates, for example, in a counterclockwise direction from the reference position by a rotation angle θ−θ₀ (see a reference sign N). At this time, the inner end 532 of the spiral spring 530 turns from the inner-end reference position in the counterclockwise direction by a turning angle n·(θ−θ₀) by a function of the speed reducer 520 that has been already described. As a result, a torque in accordance with the turning angle n·(θ−θ₀) of the inner end 532 is applied to the inner end 532 in a clockwise direction. The torque is transmitted to the nut 13 and causes the nut 13 and the screw shaft member 512 to perform the energy release operation. Note that, for example, in a case where the inner end 532 rotates from the inner-end reference position in the clockwise direction in accordance with the rotation of the nut 13, a torque in the counterclockwise direction is applied to the inner end 532.

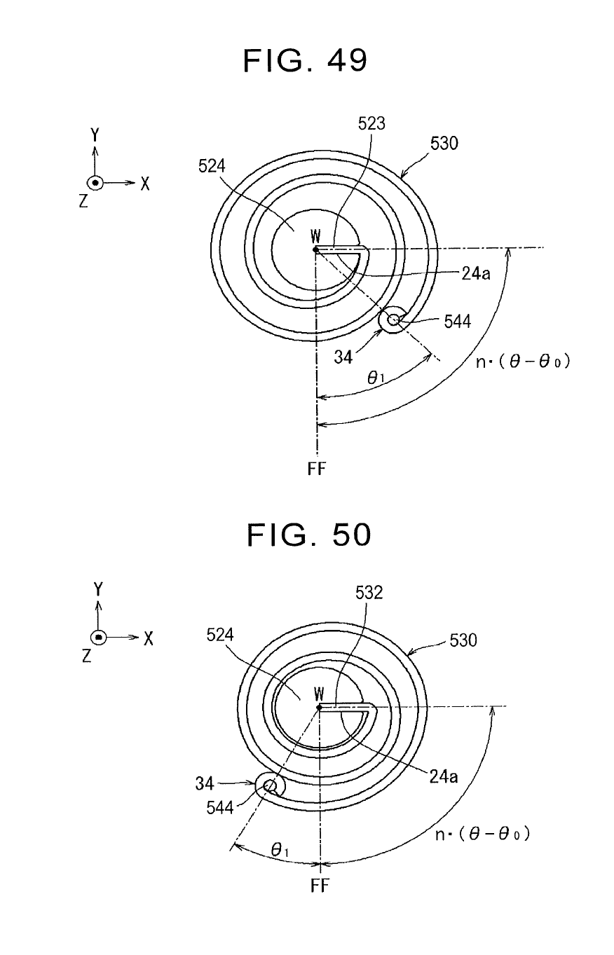

FIG. 49 illustrates a state where the reciprocation table 130 (see FIG. 44) linearly moves by a predetermined distance from the reciprocation central position z₀, and the outer end 34 of the spiral spring 530 is turned from the outer-end reference position in the counterclockwise direction by a turning angle θ₁ by driving the motor output shaft 552. In this case, a torque corresponding to an angle obtained by subtracting the turning angle θ₁ of the outer end 34 from the turning angle n·(θ−θ₀) of the inner end 532 is applied to the inner end 532 in the clockwise direction. The torque causes the nut 13 and the screw shaft member 512 to perform the energy release operation. As illustrated in FIG. 50, in a case where the outer end 34 is turned from the outer-end reference position in the clockwise direction by the turning angle θ₁, a torque corresponding to an angle obtained by adding the turning angle θ₁ of the outer end 34 to the turning angle n·(θ−θ₀) of the inner end 532 is applied to the inner end 532 in the clockwise direction.

Next will be described a method of calculating an apparent spring constant to minimize the drive energy for causing the reciprocation table 130 to linearly reciprocate. The Z-axis direction is referred to as a linear motion direction. Note that, in Expression 89 to Expression 97 described below, the motor output shaft 552 is not driven, and the outer end 34 of the spiral spring 530 is disposed at the outer-end reference position (see FIG. 47).

A current position “z” of the reciprocation table 130 can be expressed with the use of a current rotation angle θ of the nut 13 and a pitch “p” of a spiral groove of the screw shaft member 512 as follows.

z=(p·θ)/2π Expression 89

A reciprocation central position z₀ of the reciprocation table 130 is given by Expression 90 with the use of a reference angle θ₀ of the nut 13.

z₀=(p·θ₀)/2π Expression 90

An output from the spiral spring 530 to the nut 13 is converted to a thrust “f” in the linear motion direction by the nut 13 and the screw shaft member 512. When an apparent spring constant in the linear motion direction is assumed to be k_{L}, the thrust “f” is given by Expression 91.

f=k_{L}·(z−z₀) Expression 91

Here, when Expression 89 and Expression 90 are applied to z and z₀, respectively, Expression 92 is obtained.

f=k_{L}·p·(θ−θ₀)/2π Expression 92

The following discusses a torque τ that occurs in the nut 13 due to the spiral spring 530. When an apparent spring constant in a rotation direction is k_{R}, a torque input from the spiral spring 530 into the input-output shaft 524 of the speed reducer 520 is τ_{A}, a speed reducing ratio of the speed reducer 520 is “n”, and an efficiency of the speed reducer 520 is η_{R}, the torque τ is given by Expression 93 and Expression 94.

τ=k_{R}·(θ−θ₀) Expression 93

τ=η_{R}·n·τ_{A} Expression 94

Further, when an actual spring constant of the spiral spring 530 is k, the torque τ_{A} input from the spiral spring 530 into the input-output shaft 524 of the speed reducer 520 is given by Expression 95. Note that, as has been already described, when the rotation angle of the nut 13 is θ−θ₀, the inner end 532 of the spiral spring 530 is turned from the inner-end reference position by a turning angle n·(θ−θ₀) (see FIG. 48). Accordingly, the following expression is obtained.

τ_{A}=k·n·(θ−θ₀) Expression 95

Subsequently, when Expression 95 is substituted into Expression 94, the torque τ is given by Expression 96.

τ=η_{R}·n·k·n·(θ−θ₀)=η_{R}·n²·k·(θ−θ₀) Expression 96

Subsequently, when Expression 96 and Expression 93 are combined to obtain a solution about the apparent spring constant k_{R} in the rotation direction, k_{R} is given by Expression 97.

k_{R}=η_{R}·n²·k Expression 97

Here, it is assumed that the motor output shaft 552 is driven so as to turn the outer end 34 of the spiral spring 530 from the outer-end initial position by the turning angle θ₁ (see FIG. 49). At this time, the torque τ_{A} input from the spiral spring 530 into the input-output shaft 524 of the speed reducer 520 is given by Expression 98 as follows. Note that, as has been already described in FIG. 49, the turning angle of the inner end 532 relative to the outer end 34 of the spiral spring 530 is n·(θ−θ₀)−θ₁.

τ_{A}=k·{n(θ−θ₀)−θ₁} Expression 98

Then, when Expression 98 is substituted into Expression 94, the torque τ is given by Expression 99.

τ=ηR·n·k·{n(θ−θ₀)−θ₁}=η_{R}n²·k[1−θ₁/{n·(θ−θ₀))}]·(θ−θ₀) Expression 99

Then, Expression 99 and Expression 93 are used to obtain a solution about the apparent spring constant k_{R} in the rotation direction, k_{R} is given by Expression 100.

k_{R}=ηR·n²·k·[1−θ₁/{n·(θ−θ₀)}] Expression 100

Then, when it is assumed that the work of the screw shaft member 512 in the linear motion direction is equal to the work of the nut 13 in the rotation direction, Expression 101 is given as follows. Note that η_{L} indicates a rotation-linear motion conversion efficiency.

f·(z−z₀)=η_{L}·τ·(θ−θ₀) Expression 101

Here, when Expression 89 and Expression 90 are applied to z and z₀ in Expression 101, respectively, Expression 102 is obtained.

f·p·(θ−θ₀)/2π=η_{L}·τ·(θ−θ₀) Expression 102

Then, when Expression 92 is applied to the thrust “f” in Expression 102, Expression 103 is obtained.

k_{L}·{p·(θ−θ₀)/2}²=η_{L}·τ·(θ−θ₀) Expression 103

Then, when Expression 99 is applied to the torque τ of Expression 103, Expression 104 is obtained.

k_{L}{p·(θ−θ₀)/2π}²=η_{L}·η_{R}·n²·k·[1−θ₁/{n·(θ−θ₀)}]·(θ−θ₀)² Expression 104

Then, Expression 104 is solved for the apparent spring constant k_{L} in the linear motion direction, Expression 105 is obtained.

k_{L}=n_{L}·n_{R}·n²·k·[1−θ₁/{n·(θ−θ₀)}]·(2π/p)² Expression 105

Now, when drive energy for causing the reciprocation table 130 to linearly reciprocate is F, a mass of the reciprocation table 130 is “m”, and a viscosity relating to the linear reciprocating motion of the reciprocation table 130 is “v”, an equation of motion relating to the reciprocation table 130 is given by Expression 106. Note that “m” may be also a sum of the mass of the reciprocation table 130 and a mass of the screw shaft member 512.

F=m·(d²z/dt²)+v·(dz/dt)+k_{L}·z Expression 106

When it is assumed that the linear reciprocating motion of the reciprocation table 130 is a sine wave, a current position “z” of the reciprocation table 130 is given by Expression 107.

z=A·sin(ω·t) Expression 107

Note that A indicates an amplitude of “z”, ω indicates an angular frequency (angular velocity) at which the reciprocation table 130 linearly reciprocates, and “t” indicates a time. When a period of the linear reciprocating motion of the reciprocation table 130 is T, ω is given by ω=2π/T.

When Expression 107 is applied to Expression 106, Expression 108 is obtained.

F=−A·m·ω²·sin(ω·t)+A·v·ω cos(ω·t)+A·k_{L}·sin(ω·t)=A·(k_{L}−m·ω²)·sin(ω·t)+A·v·ω·cos (ω·t) Expression 108

In Expression 108, when the first term is 0, the drive energy F is minimized. That is, F is minimized by controlling the apparent spring constant k_{L} in the linear motion direction so as to satisfy Expression 109.

k_{L}=m·ω² Expression 109

Here, when Expression 105 and Expression 109 are combined, Expression 110 is obtained as follows.

η_{L}·_{R}·n²·k·[1−θ₁/{n·(θ−θ₀)}]·(2π/p)²=m·ω² Expression 110

When Expression 110 is solved for θ₁, Expression 111 is obtained.

$${θ}_{1} = \{ 1 - \begin{matrix}1 \\ {η}_{L} \cdot {η}_{R} \cdot {n}^{2} \cdot k\end{matrix} \cdot {( \begin{matrix}p \\ 2 π\end{matrix} )}^{2} \cdot m \cdot {ω}^{2} \} \cdot n \cdot ( 0 - {θ}_{0} ) \qquad Expression 111$$

By using θ₁ in Expression 111, the drive energy F for causing the reciprocation table 130 to linearly reciprocate is minimized. In the Expression 111, only a current rotation angle θ of the nut 13 is a variable. The current rotation angle θ of the nut 13 is changed in real time in accordance with the linear reciprocating motion of the reciprocation table 130. Accordingly, the abovementioned drive energy F can be minimized by changing the turning angle θ₁ of the outer end 34 of the spiral spring 530 in real time in accordance with the current rotation angle θ of the nut 13. Note that, as can be understood from Expression 105, when the turning angle θ₁ of the outer end 34 of the spiral spring 530 is changed, the apparent spring constant k_{L} in the linear motion direction is changed.

The control device 560 changes the turning angle 81 of the outer end 34 of the spiral spring 530 in real time so as to satisfy Expression 111. As a result, in a relationship shown in Expression 105, the apparent spring constant k_{L} in the linear motion direction is changed in real time. Thus, the drive energy F for causing the reciprocation table 130 to linearly reciprocate is constantly minimized.

Note that, as shown in Expression 111, the turning angle θ₁ of the outer end 34 of the spiral spring 530 is a function of the angular frequency ω of the reciprocation table 130. Accordingly, even when the angular frequency ω of the reciprocation table 130 is changed in accordance with the number of rotations of the grinding object 114 around the object support shaft 112 and a shape of the grinding object 114, the turning angle θ₁ corresponding to the angular frequency ω thus changed is calculated in Expression 111. Accordingly, by setting the turning angle θ₁ based on Expression 111, it is possible to minimize the drive energy F for causing the reciprocation table 130 to linearly reciprocate in accordance with any of various processing periods.

The linear motion variable rigidity unit 1 is configured as described above. In the linear motion variable rigidity unit 1, kinetic energy at the time when the reciprocation table 130 linearly reciprocates is released again to the reciprocation table 130 itself, and thus, the linear reciprocating motion of the reciprocation table 130 is assisted efficiently. Accordingly, the drive energy of the table drive device 140, which is required to cause the reciprocation table 130 to linearly reciprocate, is reduced, and thus, an output of the table drive device 140 is reduced.

In the linear motion variable rigidity unit 1, the control device 560 changes the apparent spring constant of the spiral spring 530 in real time, and thus, the drive energy for causing the reciprocation table 130 to linearly reciprocate is constantly minimized. Accordingly, the output of the table drive device 140 is reduced to the minimum. Note that the apparent spring constant of the spiral spring 530 is easily changed by driving the rigidity variable actuator 550 so as to change the turning angle θ₁ of the outer end 34 of the spiral spring 530.

In the linear motion variable rigidity unit 1, the linear motion-rotation conversion mechanism 510 is constituted by the screw shaft member 512 and the nut 13, that is, the linear motion-rotation conversion mechanism 510 has a simple configuration.

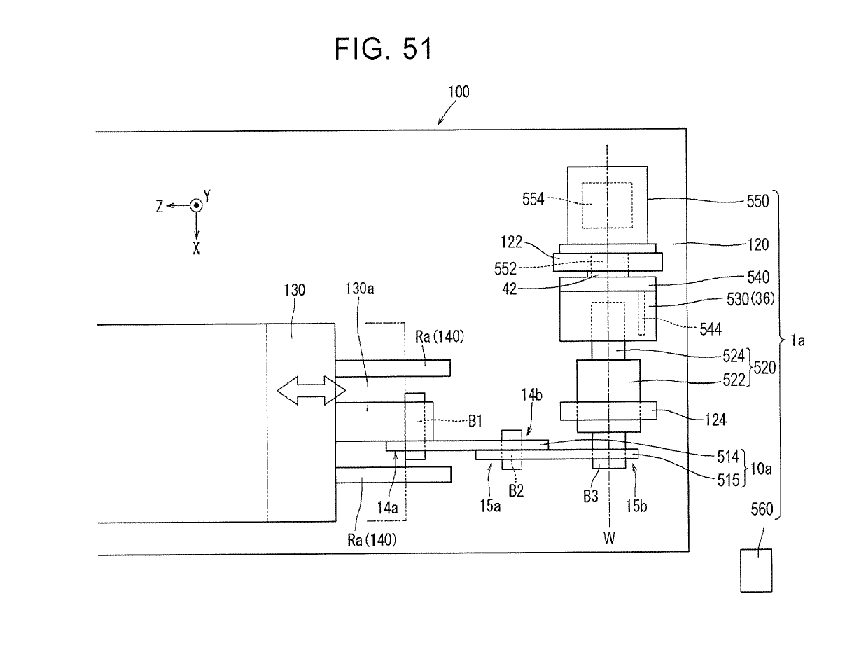

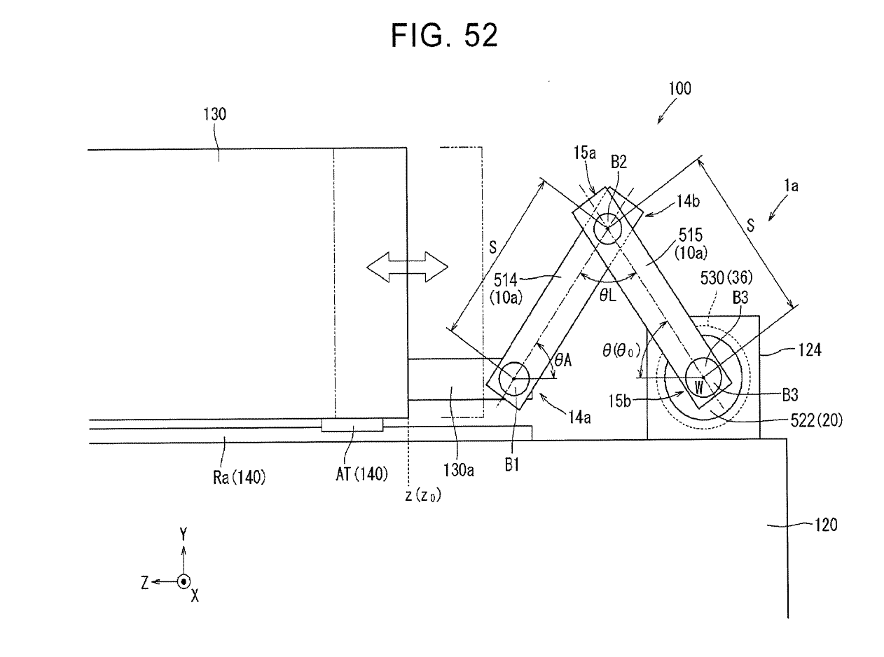

A linear motion variable rigidity unit 1a according to Embodiment 9 will be described mainly with reference to FIGS. 51, 52. Note that, in FIGS. 51 and 52, parts regarded as having the same or substantially the same configurations/functions as those in FIGS. 42 to 50 will have the same reference signs as in FIGS. 42 to 50, and thus, redundant descriptions thereof are omitted. The linear motion variable rigidity unit 1a (see FIG. 51) includes: a linear motion-rotation conversion mechanism 10a; a speed reducer 520; a variable rigidity mechanism 36 including a spiral spring 530; a turning member 540; a rigidity variable actuator 550; a control device 560; and a support member constituted by a table support base 120.

The linear motion-rotation conversion mechanism 10a is constituted by two link members 514, 515 as illustrated in FIGS. 51 and 52. The link members 514, 515 are disposed so as to be perpendicular to the speed reducer 520, the spiral spring 530, the turning member 540, and the rigidity variable actuator 550. More specifically, the link members 514, 515 are disposed to extend along the Z-axis direction, and the speed reducer 520, the spiral spring 530, the turning member 540, and the rigidity variable actuator 550 are disposed along the X-axis direction. Configurations, functions, and assembled states of the speed reducer 520, the spiral spring 530, the turning member 540, and the rigidity variable actuator 550 are similar to those provided in the linear motion variable rigidity unit 1 described in Embodiment 8, so redundant descriptions thereof are omitted.

As illustrated in FIGS. 51, 52, a first link connection end 14a (a linear-motion input-output portion), which is one end of the first link member 514, is connected to a distal end of the linear member 130a extending from the reciprocation table 130 along the Z-axis direction, via a rotary joint B1, for example. The first link connection end 14a linearly reciprocates together with the reciprocation table 130 along the Z-axis direction. The first link connection end 14a can rotate relative to the linear member 130a with the rotary joint B1 serving as a supporting point.

An end portion of the first link member 514, which is opposite to the first link connection end 14a, is a first link connection end 14b. The first link connection end 14b is connected to a second link connection end 15a, which is one end of the second link member 515, via a rotary joint B2. The link connection ends 14b, 15a can rotate relative to each other with the rotary joint B2 serving as a supporting point. Along with this rotation, an angle θ_{L} increases and decreases with the rotary joint B2 serving as a vertex of the angle θ_{L}.

An end portion of the second link member 515, which is opposite to the second link connection end 15a, is a second link connection end 15b (a rotational motion input-output portion). The second link connection end 15b is connected to the input-output cylinder 522 of the speed reducer 520 via a bolt B3, for example. The bolt B3 is fitted into the input-output cylinder 522 so as to be prevented from falling off from the input-output cylinder 522. Accordingly, the bolt B3 rotates together with the input-output cylinder 522. The second link connection end 15b is fixed to the bolt B3 and rotates together with the bolt B3. Note that the bolt B3 and the rotary joint B1 are provided such that their central axes are positioned at the same height. Further, the central axis of the bolt B3 coincides with central axes of the speed reducer 520, the spiral spring 530, the turning member 540, and the rigidity variable actuator 550, and a reference sign W in the figure indicates the central axes of all of these members.

The link members 514, 515 perform an energy accumulation operation in which energy is accumulated in the spiral spring 530, and an energy release operation in which the energy is released from the spiral spring 530. In the energy accumulation operation, the link members 514, 515 convert a linear reciprocating motion of the reciprocation table 130 to a rotational reciprocating motion, and output the rotational reciprocating motion thus converted to the spiral spring 530. More specifically, when the reciprocation table 130 linearly reciprocates, the first link connection end 14a linearly reciprocates while rotating with the rotary joint B1 serving as a supporting point. Accordingly, the second link connection end 15b also rotationally reciprocates together with the bolt B3 with the bolt B3 serving as a supporting point. This rotational reciprocating motion is input into the spiral spring 530 via the speed reducer 520. Note that the link connection ends 14b, 15a rotate such that the angle θ_{L} decreases when the first link connection end 14a moves closer to the second link connection end 15b, and the link connection ends 14b, 15a also rotate such that the angle θ_{L} increases when the first link connection end 14a moves away from the second link connection end 15b.

In the energy release operation, the link members 514, 515 convert a rotational reciprocating motion of the second link connection end 15b in accordance with a torque of the spiral spring 530 to a linear reciprocating motion, and outputs the linear reciprocating motion thus converted to the reciprocation table 130. More specifically, when the second link connection end 15b rotationally reciprocates together with the bolt B3 in accordance with the torque of the spiral spring 530 with the bolt B3 serving as a supporting point, the link connection ends 14b, 15a rotate relative to each other with the rotary joint B2 serving as a supporting point, and the first link connection end 14a linearly reciprocates while rotating with the rotary joint B1 serving as a supporting point. The link connection ends 14b, 15a rotate such that the angle θ_{L} increases when the first link connection end 14a moves away from the second link connection end 15b, and the link connection ends 14b, 15a also rotate such that the angle θ_{L} decreases when the first link connection end 14a moves closer to the second link connection end 15b.

A turning state of the spiral spring 530 at the time when the link members 514, 515 perform the energy accumulation operation and the energy release operation is similar to that described with reference to FIGS. 47 to 50. Note that, in the present embodiment, θ indicates a current rotation angle of the second link connection end 14b relative to the Z-axis as illustrated in FIG. 52. A reference angle θ₀ indicates a rotation angle of the second link connection end at the time when the reciprocation table 130 is disposed at the reciprocation central position z₀. In FIG. 52, the current position “z” of the reciprocation table 130 coincides with the reciprocation central position z₀, and the current rotation angle θ of the second link connection end 14b coincides with the reference angle θ₀. In FIGS. 48 to 50, θ and θ₀ correspond to the current rotation angle and the reference angle of the second link connection end 14b, respectively.

Similarly to Embodiment 8, the control device 560 updates the apparent spring constant so as to decrease the drive energy F of the table drive device 140, which is required to cause the reciprocation table 130 to linearly reciprocate. A calculation method for the apparent spring constant is described below. Note that, in Expression 112 to Expression 120, the motor output shaft 552 is not driven, and thus, the outer end 34 of the spiral spring 530 is disposed at the outer-end reference position (see FIG. 47). Further, as illustrated in FIG. 52, a length S of the first link member 514 is the same as a length S of the second link member 515. A magnitude of a rotation angle θ_{A} of the first link connection end 14a relative to the Z-axis coincides with a magnitude of a rotation angle θ of the second link connection end 15b.

A current position “z” of the reciprocation table 130 is given by Expression 112 with the use of the current rotation angle θ of the second link connection end 15b and the length S of the second link member 515. Since two link members are provided, a component, in the Z-axis direction, of the length S of the second link member 515 is doubled in Expression 112.

z=2S·cos θ Expression 112

When the reference angle θ₀ of the second link connection end 14b is used, a reciprocation center z₀ of the reciprocation table 130 is given by Expression 113 as follows.

z₀=2S*cos θ₀ Expression 113

The output from the spiral spring 530 to the second link connection end 14b is converted to a thrust “f” in the linear motion direction by the link members 514, 515. When the apparent spring constant in the linear motion direction is k_{L}, the thrust “f” is given by Expression 114. The linear motion direction indicates the Z-axis direction.

f=k_{L}·(z−z₀) Expression 114

Here, when Expression 112 and Expression 113 are applied to z and z₀, respectively, Expression 115 is obtained.

f=k_{L}·2S·(cos θ−cos θ₀) Expression 115

The following discusses a torque τ that occurs in the second link connection end 14b due to the spiral spring 530. When an apparent spring constant in the rotation direction is k_{R}, a torque input from the spiral spring 530 into the input-output shaft 524 of the speed reducer 520 is τ_{A}, a speed reducing ratio of the speed reducer 520 is “n”, and an efficiency of the speed reducer 520 is η_{R}, the torque τ is given by both Expression 116 and Expression 117.

τ=k_{R}·(θ−θ₀) Expression 116

τ=η_{R}·n·τ_{A} Expression 117

Further, when an actual spring constant of the spiral spring 530 is k, the torque τ_{A} input from the spiral spring 530 into the input-output shaft 524 of the speed reducer 520 is given by Expression 118. Note that, when the rotation angle of the second link connection end 15b is θ−θ₀ due to a function of the speed reducer 520, the inner end 532 of the spiral spring 530 is turned from the inner-end reference position by a turning angle n·(θ−θ₀) (see FIG. 48). Accordingly, the following expression is obtained.

τ_{A}=k·n·(θ−θ₀) Expression 118

Then, when Expression 118 is substituted into Expression 117, the torque τ is given by Expression 119.

τ=η_{R}·n·k·n·(θ−θ₀)=η_{R}−n²·k(θ−θ₀) Expression 119

Then, Expression 119 and Expression 116 are combined so as to obtain a solution about the apparent spring constant k_{R} in the rotation direction, k_{R} is given by Expression 120.

k_{R}=n_{R}·n²·k Expression 120

Here, it is assumed that the motor output shaft 552 is driven so as to turn the outer end 34 of the spiral spring 530 from the outer-end initial position by a turning angle θ₁ (see FIG. 49). At this time, the torque τ_{A} input from the spiral spring 530 into the input-output shaft 524 of the speed reducer 520 is given by Expression 121 as follows. Note that the turning angle of the inner end 532 relative to the outer end 34 of the spiral spring 530 is n·(θ−θ₀)−θ₁ (see FIG. 49).

τ_{A}=k·{n·(θ−θ₀)−θ₁} Expression 121

Then, when Expression 121 is substituted into Expression 117, the torque τ is given by Expression 122.

τ=η_{R}·n·k·{n·(θ−θ₀)−θ₁}=η_{R}·n²·k[1−θ₁/{n·(θ−θ₀)}]·(θ−θ₀) Expression 122

Then, Expression 122 and Expression 116 are used so as to obtain a solution about the apparent spring constant k_{R} in the rotation direction, k_{R} is given by Expression 123.

k_{R}=η_{R}·n²·k·[1−θ₁/{n·(θ−θ₀)}] Expression 123

Subsequently, when it is assumed that the work of the first link connection end 14a in the linear motion direction is equal to the work of the second link connection end 15b in the rotation direction, Expression 124 is given as follows. Note that η_{L} indicates a rotation-linear motion conversion efficiency.

f·(z−z₀)=η_{L}·τ·(θ−θ₀) Expression 124

Here, when Expression 112 and Expression 113 are applied to z and z₀ of Expression 124, respectively, and when Expression 122 is applied to τ of Expression 124, Expression 125 is obtained.

f·2S·(cos θ−cos θ₀)=η_{L}·η_{R}·n²·k[1−θ₁/{n·(θ−θ₀)}]·(θ−θ₀)² Expression 125

Then, when Expression 115 is applied to the thrust “f” of Expression 125, Expression 126 is obtained.

k_{L}*4S²·(cos θ−cos θ₀)²=η_{L}·η_{R}·n²·k·[1−θ₁/{n·(θ−θ₀))}]·(θ−θ₀)² Expression 126

Then, Expression 126 is solved for the apparent spring constant k_{L} in the linear motion direction, Expression 127 is obtained.

$${k}_{L} = \frac{{η}_{L} \cdot {η}_{R} \cdot {n}^{2} \cdot k}{4 {S}^{2} \cdot {( cos θ - cos {θ}_{0} )}^{2}} \cdot \{ 1 - \frac{{θ}_{1}}{n \cdot ( θ - {θ}_{0} )} \} \cdot {( θ - {θ}_{0} )}^{2} \qquad Expression 127$$

Now, when drive energy for causing the reciprocation table 130 to linearly reciprocate is F, a mass of the reciprocation table 130 is “m”, and a viscosity relating to the linear reciprocating motion of the reciprocation table 130 is “v”, an equation of motion relating to the reciprocation table 130 is given by Expression 128. Note that “m” may be also a sum of a mass of the reciprocation table and a mass of both link members.

F=m·(d²z/dt²)+v·(dz/dt)+k_{L}·z Expression 128

When the linear reciprocating motion of the reciprocation table 130 is assumed to be a sine wave, a current position “z” of the reciprocation table 130 is given by Expression 129.

z=A·sin(ω·t) Expression 129

Note that A indicates an amplitude of z, ω indicates an angular frequency (angular velocity) at which the reciprocation table linearly reciprocates, and t indicates a time. As has been already described, ω is given by ω=2π/T.

When Expression 129 is applied to Expression 128, Expression 130 is obtained.

F=−A·m·ω² sin(ω·t)+A·v·ω·cos(ω·t)+A·k_{L}·cos(ω·t)=A·(k_{L}−m·ω²)·sin(·t)+A·v·ω·cos(ω·t) Expression 130

In Expression 130, when the first term is 0, the drive energy F is minimized. That is, by controlling the apparent spring constant k_{L} in the linear motion direction so as to satisfy Expression 131, F is minimized.

k_{L}=m·ω² Expression 131

Here, when Expression 127 and Expression 131 are combined, Expression 132 is obtained as follows.

$$\frac{{η}_{L} \cdot {η}_{R} \cdot {n}^{2} \cdot k}{4 {S}^{2} \cdot {( cos θ - cos {θ}_{0} )}^{2}} \cdot \{ 1 - \frac{{θ}_{1}}{n \cdot ( θ - {θ}_{0} )} \} \cdot {( θ - {θ}_{0} )}^{2} = m \cdot {ω}^{2} \qquad Expression 132$$

Then, when Expression 132 is solved for θ₁, Expression 133 is obtained as follows.

$${θ}_{1} = \{ 1 - \begin{matrix}4 {S}^{2} \cdot {( cos θ - cos {θ}_{0} )}^{2} \\ {η}_{L} \cdot {η}_{R} \cdot {n}^{2} \cdot k\end{matrix} \cdot \begin{matrix}m \cdot {ω}^{2} \\ {( θ - {θ}_{0} )}^{2}\end{matrix} \} \cdot n \cdot ( θ - {θ}_{0} ) \qquad Expression 133$$

When Expression 133 is transformed, Expression 134 is obtained as follows.

$${θ}_{1} = ( 1 - \frac{1}{{η}_{L} \cdot {η}_{R} \cdot {n}^{2} \cdot k} \cdot \{ \frac{2 S \cdot {( cos θ - cos {θ}_{0} )}^{2}}{θ - {θ}_{0}} \} \cdot m \cdot {ω}^{2} ) \cdot n \cdot ( θ - {θ}_{0} ) \qquad Expression 134$$

By using θ₁ of Expression 134, the drive energy F for causing the reciprocation table 130 to linearly reciprocate is minimized. In Expression 134, only a current rotation angle θ of the second link connection end 14b is a variable. The current rotation angle θ of the second link connection end 14b is changed in real time in accordance with the linear reciprocating motion of the reciprocation table 130. Accordingly, the abovementioned drive energy F can be minimized by changing the turning angle θ of the outer end 34 of the spiral spring 530 in real time in accordance with the current rotation angle θ of the second link connection end 14b. Note that, as can be understood from Expression 127, when the turning angle θ₁ of the outer end 34 of the spiral spring 530 is changed, the apparent spring constant k_{L} in the linear motion direction is changed.

The control device 560 changes the turning angle θ₁ of the outer end 34 of the spiral spring 530 in real time so as to satisfy Expression 134. As a result, in a relationship shown in Expression 127, the apparent spring constant k_{L} in the linear motion direction is changed in real time. Thus, the drive energy F for causing the reciprocation table 130 to linearly reciprocate is constantly minimized.

Note that, in the linear motion variable rigidity unit 1a, the first link member 514 and the second member 515 may be connected by a plurality of link members. However, in this case, the first link connection end 14a and the second link connection end 15b function in a manner similar to the manner in which the first link connection end 14a and the second link connection end 15b function in the present embodiment.

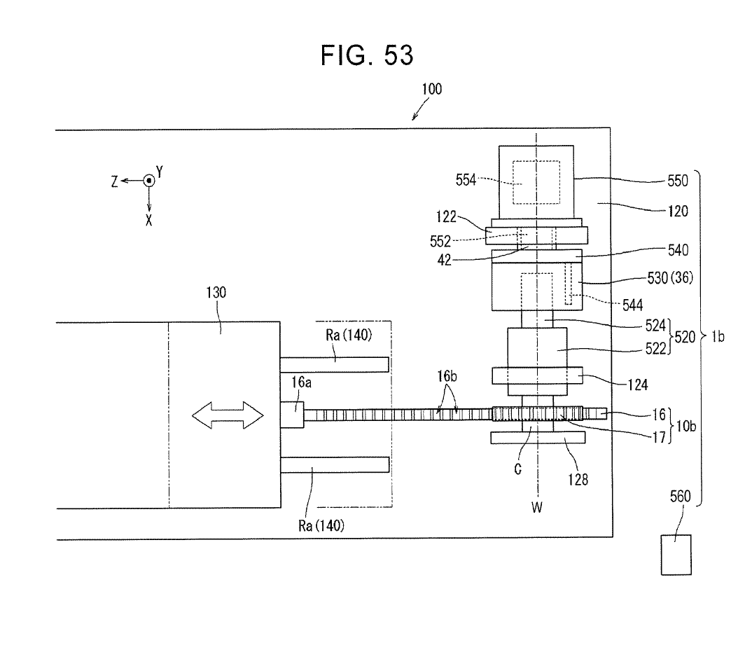

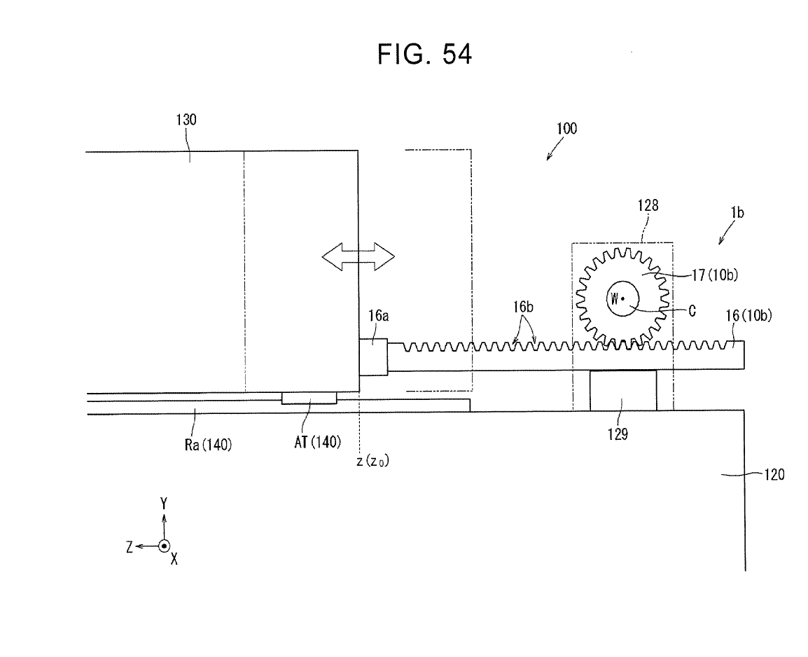

A linear motion variable rigidity unit 1b according to Embodiment 10 will be described mainly with reference to FIGS. 53 and 54. Note that, in FIGS. 53 and 54, parts regarded as having the same or substantially the same configurations/functions as those in FIGS. 42 to 52 will have the same reference signs as in FIGS. 42 to 52, and thus, redundant descriptions thereof are omitted.

The linear motion variable rigidity unit 1b includes: a linear motion-rotation conversion mechanism 10b; a speed reducer 520; a variable rigidity mechanism 36 including a spiral spring 530; a turning member 540; a rigidity variable actuator 550; a control device 560; and a support member constituted by a table support base 120. Similarly to Embodiment 9, the speed reducer 520, the spiral spring 530, the turning member 540, and the rigidity variable actuator 550 are disposed along the X-axis direction.

The linear motion-rotation conversion mechanism 10b is constituted by a rack 16, and a pinion 17 that is a gear wheel fitted to grooves 16b of the rack 16. A connection end 16a, which is one end of the rack 16, is connected to the reciprocation table 130. A longitudinal direction of the rack 16 is set to the Z-axis direction. The rack 16 is supported by a rack support portion 129 of the table support base 120 so as to linearly reciprocate along the Z-axis direction. The rack 16 linearly reciprocates together with the reciprocation table 130 along the Z-axis direction.

The pinion 17 is provided so as to rotate around its rotating shaft C at a predetermined position without moving in the Z-axis direction. One end of the rotating shaft C is supported by a pinion support portion 128 of the table support base 120. The other end of the rotating shaft C is fitted into an input-output cylinder 522 of the speed reducer 520 so as to be prevented from falling off from the input-output cylinder 522. The rotating shaft C rotates together with the input-output cylinder 522. The pinion 17 rotates together with the rotating shaft C. Note that a central axis of the rotating shaft C coincides with central axes of the speed reducer 520, the spiral spring 530, the turning member 540, and the rigidity variable actuator 550, and a reference sign W in the figure indicates the central axes of all of these members.

A linear reciprocating motion of the rack 16 is converted to a rotational reciprocating motion of the pinion 17 and the rotational reciprocating motion is output to the spiral spring 530. A rotational reciprocating motion of the pinion 17 is converted to a linear reciprocating motion of the rack 16 so as to cause the reciprocation table 130 to linearly reciprocate.

A method of calculating an apparent spring constant in the case of employing the linear motion variable rigidity unit 1b is the method described using Expression 89 to Expression 111. Note that, in the case of the present embodiment, θ indicates a current rotation angle of the pinion 17. θ₀ indicates a reference angle that is a rotation angle of the pinion 17 at the time when the reciprocation table 130 is disposed at a reciprocation central position z₀. Further, “p” indicates a moving amount of the rack 16 in the Z-axis direction at the time when the pinion 17 rotates once.

The control device 560 changes a turning angle θ₁ of an outer end 34 of the spiral spring 530 in real time so as to satisfy Expression 111. As a result, in the relationship shown in Expression 105, an apparent spring constant k_{L} in the linear motion direction is changed in real time. Thus, drive energy F for causing the reciprocation table 130 to linearly reciprocate is constantly minimized. Note that the linear motion-rotation conversion mechanism 10b is constituted by the rack 16 and the pinion 17, that is, the linear motion-rotation conversion mechanism 10b has a simple configuration.

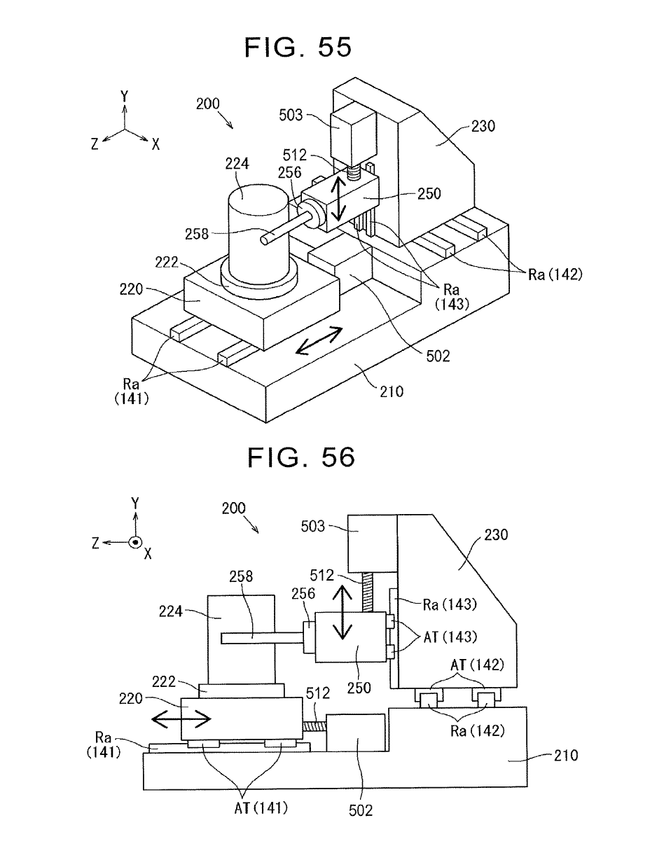

Subsequently described is Embodiment 11 with reference to FIGS. 55 and 56. Note that, in FIGS. 55 and 56, parts regarded as having the same or substantially the same configurations/functions as in FIGS. 42 to 54 will have the same reference signs as in FIGS. 42 to 54, and thus, redundant descriptions thereof are omitted.

In the present embodiment, a linear motion variable rigidity unit is attached to a machining center, which is a machine tool. In the present embodiment, the linear motion variable rigidity unit described in Embodiment 8 is attached to the machining center. Note that the linear motion variable rigidity unit described in Embodiment 9 or Embodiment 10 may be attached to the machining center.

A machining center 200 illustrated in FIGS. 55 and 56 includes: a base 210; a cutting object reciprocation table 220 (a linear reciprocating body) that supports a cutting object 224; a cutting member reciprocation table 250 (a linear reciprocating body) including a cutting member (cutting tool) 258; two linear motion variable rigidity units 502, 503 individually connected to the reciprocation tables 220, 250, respectively; and a cutting member support table 230 that supports the cutting member reciprocation table 250. The cutting member support table 230 can slide along the Y-axis direction on rails Ra provided on the base 210. The cutting member support table 230 is driven by a table drive device 142, which is a linear motor, for example. The table drive device 142 is constituted by, for example, the rails Ra and the sliders AT, which have been described in Embodiment 8.

The cutting object reciprocation table 220 is disposed at a position distanced from the cutting member support table 230 in the Z-axis direction by a predetermined distance. The cutting object reciprocation table 220 can linearly reciprocate along the Z-axis direction on rails Ra provided on the base 210, so as to move closer to or move away from the cutting member support table 230. The linear reciprocating motion of the cutting object reciprocation table 220 is driven by a table drive device 141, which is a linear motor, for example. Drive energy required for the linear reciprocating motion is minimized by assistance provided by the first linear motion variable rigidity unit 502. The table drive device 141 is constituted by, for example, the rails Ra and the sliders AT, which have been described in Embodiment 8.

An object support base 222 is provided on the cutting object reciprocation table 220. The object support base 222 supports the cutting object 224. The cutting object 224 is columnar, for example, and extends in the Y-axis direction. The cutting object 224 rotates together with the object support base 222 around a central axis of the cutting object 224.

The cutting member reciprocation table 250 can linearly reciprocate on the rails Ra provided on the cutting member support tables 230, along the Y-axis direction. The linear reciprocating motion of the cutting member reciprocation table 250 is driven by a table drive device 143, which is a linear motor, for example. Drive energy required for the linear reciprocating motion is minimized by assistance provided by the second linear motion variable rigidity unit 503. The table drive device 143 is constituted by, for example, the rails Ra and the sliders AT, which have been described in Embodiment 8.

The cutting member 258 is attached to a distal end of the cutting member reciprocation table 250 via a rotational member 256. The cutting member 258 extends in the Z-axis direction toward the cutting object 224 and makes contact with an outer peripheral surface of the cutting object 224. Note that a position of the cutting member 258 in the X-axis direction is adjusted by the cutting member support table 230. The cutting member 258 rotates together with the rotational member 256 around a central axis of the cutting member 258 so as to grind the outer peripheral surface of the cutting object 224. The cutting member reciprocation table 250 causes the cutting member 258 to linearly reciprocate along the Y-axis direction. Accordingly, the cutting member 258 grinds the cutting object 224 along the Y-axis direction. As described above, the cutting object 224 rotates together with the object support base 222 in a circumferential direction. Accordingly, the cutting member 258 grinds the cutting object 224 over the circumferential direction.

Note that the second linear motion variable rigidity unit 503 minimizes drive energy at the time when the cutting member reciprocation table 250 linearly reciprocates along the Y-axis direction (a vertical direction), and thus, an effect of a gravitational force “g” is considered in calculation of the apparent spring constant for minimizing the drive energy. That is, Expression 106 and Expression 108 to Expression 111 can be replaced with Expression 135 and Expression 136 to Expression 139 as follows.

An equation of motion relating to the reciprocation table 250 is given by Expression 135.

F=m·(d²z/dt²)+v·(dz/dt)+k_{L}·z+m·g Expression 135

When Expression 107 is substituted into Expression 135, Expression 136 is obtained.

F=A·(k_{L}−m·ω²)·sin(ω·t)+A·v·cos(ω·t)+m·g Expression 136

When A·(k_{L}−m·ω²)·sin(ω·t)+m·g=0 is satisfied in Expression 136, the drive energy F is minimized. At this time, the apparent spring constant k_{L} is as follows.

$${k}_{L} = m \cdot {ω}^{2} - \frac{m \cdot g}{A \cdot sin ( ω \cdot t )} = m \cdot \{ {ω}^{2} - \frac{g}{A \cdot sin ( ω \cdot t )} \} \qquad Expression 137$$

When Expression 105 and Expression 137 are combined, Expression 138 is obtained as follows.

$${η}_{L} \cdot {η}_{R} \cdot {n}^{2} \cdot k \cdot \{ 1 - \frac{{θ}_{1}}{n \cdot ( θ - {θ}_{0} )} \} \cdot {( \frac{2 π}{p} )}^{2} = m \cdot \{ {ω}^{2} - \frac{g}{A \cdot sin ( ω \cdot t )} \} \qquad Expression 138$$

When Expression 138 is solved for θ₁, Expression 139 is obtained as follows.

$${θ}_{1} = ( 1 - \frac{1}{{η}_{L} \cdot {η}_{R} \cdot {n}^{2} \cdot k} \cdot {( \frac{p}{2 π} )}^{2} \cdot m \cdot \{ {ω}^{2} - \frac{g}{A \cdot sin ( ω \cdot t )} \} ) \cdot n \cdot ( θ - {θ}_{0} ) \qquad Expression 139$$

When θ₁ is substituted into Expression 105, the apparent spring constant k_{L} in the Y-axis direction, which is the linear motion direction, is changed.

Embodiments for carrying out the disclosure have been described with reference to the drawings. However, the disclosure is not limited to the structures, the configuration, the appearances, the shapes, and the like described in the above embodiments, and various modifications, additions, and deletes may be made without departing from the scope of the disclosure. For example, in each of the linear motion variable rigidity units 1, 1a, 1b, the speed reducer 520 may not be provided. That is, the spiral spring 530 may be directly connected to the nut 13 (see FIGS. 44 to 46), the second link connection end (see FIGS. 51 and 52), or the rotating shaft C of the pinion 17 (FIGS. 53 and 54). The elastic body included in the variable rigidity mechanism 36 is not limited to the spiral spring 530, and any elastic body can be used, as long as the elastic body can accumulate therein kinetic energy along with a linear reciprocating motion of a linear reciprocating body and can release energy for assisting the linear reciprocating motion of the linear reciprocating body. The configuration of the linear motion-rotation conversion mechanism is not limited to the configurations described in Embodiments 8 to 10, and any configuration may be employed.

An object to which the linear motion variable rigidity unit is attached is not limited to the grinding machine 100 and the machining center 200, and may be any other machine tool. Further, the object to which the linear motion variable rigidity unit is attached is not limited to a machine tool, and may be any linear reciprocating body that linearly reciprocates.

In all of the above-described embodiments, consumed energy is reduced, i.e., energy is efficiently used. The above-described embodiments may be combined with each other. That is, energy of the rotational motion or the linear motion of the user, the device, or the like can be efficiently accumulated by adding a load or reducing a load during the rotational motion or the linear motion, considering the influence of the gravitational force on the rotational motion or the linear motion, the influence of the inertia force on the rotational motion or the linear motion, and/or the influence of the central position of the reciprocating swing motion locus on the rotational motion or the linear motion, or converting the linear motion to the rotational motion or converting the rotational motion to the linear motion with the use of the linear motion-rotation conversion mechanism. Thus, the rotational motion or the linear motion can be efficiently assisted with the use of the accumulated energy, for example, by adding a load or reducing a load during the rotational motion or the linear motion, considering the influence of the gravitational force on the rotational motion or the linear motion, the influence of the inertia force on the rotational motion or the linear motion, and/or the influence of the central position of the reciprocating swing motion locus on the rotational motion or the linear motion.

What is claimed is:

1. An assist device connected to a moving body that performs a reciprocating swing motion, the assist device comprising:
a first output portion configured to swing around a swing center as a center of a swing motion;
a variable rigidity device including an elastic body configured to accumulate energy and release the energy in accordance with a first swinging angle as a swinging angle of the first output portion, and a rigidity varying unit configured to change an apparent rigidity of the elastic body seen from the first output portion;
a first angle detecting portion configured to detect the first swinging angle; and
a control device configured to adjust the apparent rigidity of the elastic body seen from the first output portion by controlling the rigidity varying unit in accordance with the first swinging angle detected by the first angle detecting portion.

2. The assist device according to claim 1, wherein:
the moving body is a body of a user;
the assist device further includes a body attachment member configured to be attached to the body of the user;
the variable rigidity device includes a variable rigidity mechanism, and the variable rigidity mechanism includes the elastic body and is configured such that a rigidity of the variable rigidity mechanism is changed;
the first output portion is an output link;
a rotation central part of the output link is connected to the body attachment member at a predetermined position via the variable rigidity mechanism, the predetermined position corresponding to a hip joint of the user;
a rotation free end of the output link is configured to be attached to a femoral region;
the rigidity varying unit is a rigidity variable actuator configured to change an apparent rigidity of the variable rigidity mechanism seen from the output link;
the first swinging angle is a swinging angle of the output link;
the first angle detecting portion is an angle detecting portion configured to detect the swinging angle of the output link;
the assist device further includes an input device configured to input an input value;
the control device controls the rigidity variable actuator based on a detection angle detected by the angle detecting portion and the input value input by the input device; and
the control device changes the apparent rigidity of the variable rigidity mechanism seen from the output link such that a load is applied to the femoral region in a reciprocating rotational motion of the femoral region around the hip joint, by controlling the rigidity variable actuator.

3. The assist device according to claim 2, wherein:
the reciprocating rotational motion of the femoral region around the hip joint is a walking motion;
the input device is configured to input, to the control device, a stride central angle of the femoral region in an ideal walking motion; and
the control device is configured such that, when the stride central angle of the output link in an actual walking motion deviates from the stride central angle of the femoral region in the ideal walking motion, the control device increases the load applied to the femoral region in accordance with a deviation angle of the stride central angle of the output link.

4. The assist device according to claim 3, wherein:
the input device is configured to input, to the control device, a maximum stride angle of the femoral region in the ideal walking motion; and
when a maximum stride angle of the output link in the actual walking motion is different from the maximum stride angle of the femoral region in the ideal walking motion, the control device changes the apparent rigidity of the variable rigidity mechanism seen from the output link such that the maximum stride angle of the output link approaches the maximum stride angle of the femoral region in the ideal walking motion, by controlling the rigidity variable actuator.

5. The assist device according to claim 4, wherein:
the input device is configured to input, to the control device, a gait improvement rate that determines a degree of an influence of an angular difference on a control of the apparent rigidity of the variable rigidity mechanism seen from the output link, the angular difference being a difference between the maximum stride angle of the output link and the maximum stride angle of the femoral region in the ideal walking motion.

6. The assist device according to claim 2, wherein:
the input device is configured to input, to the control device, a load factor that determines a degree of the load applied to the femoral region; and
the control device changes the apparent rigidity of the variable rigidity mechanism seen from the output link such that the load is applied to the femoral region based on the load factor, by controlling the rigidity variable actuator.

7. The assist device according to claim 2, wherein:
the elastic body of the variable rigidity mechanism is a spiral spring provided coaxially with a rotation center of the output link;
one end of the spiral spring is directly or indirectly connected to the rigidity variable actuator, and another end of the spiral spring is directly or indirectly connected to the output link; and
the rigidity variable actuator changes the apparent rigidity of the variable rigidity mechanism seen from the output link by changing a rotation angle of the one end of the spiral spring.

8. The assist device according to claim 1, wherein:
the moving body is a body of a user;
the assist device further includes a body attachment member configured to be attached to the body of the user;
the variable rigidity device includes a variable rigidity mechanism, and the variable rigidity mechanism includes the elastic body and is configured such that a rigidity of the variable rigidity mechanism is changed;
the first output portion is an output link;
a rotation central part of the output link is connected to the body attachment member at a predetermined position via the variable rigidity mechanism, the predetermined position corresponding to a joint of the user;
a rotation free end of the output link is configured to be attached to a part of the body, the part being rotated around the joint;
the rigidity varying unit is a rigidity variable actuator configured to change an apparent rigidity of the variable rigidity mechanism seen from the output link;
the first swinging angle is a swinging angle of the output link;
the first angle detecting portion is an angle detecting portion configured to detect the swinging angle of the output link;
the assist device further includes a distance measuring portion configured to measure a distance between a position where the user receive a mass from an object and a rotation center of the output link;
the control device controls the rigidity variable actuator based on a detection angle detected by the angle detecting portion and a measurement distance measured by the distance measuring portion; and
the control device changes the apparent rigidity of the variable rigidity mechanism seen from the output link such that a load applied to the user is reduced, by controlling the rigidity variable actuator.

9. The assist device according to claim 8, wherein
the distance measuring portion includes a first acceleration sensor configured to be attached to the position where the user receives the mass from the object,
a second acceleration sensor configured to be attached to the rotation center of the output link, and
a calculation portion configured to calculate a distance between the first acceleration sensor and the second acceleration sensor based on detection values of the first acceleration sensor and the second acceleration sensor.

10. The assist device according to claim 8, wherein:
the elastic body of the variable rigidity mechanism is a spiral spring provided coaxially with the rotation center of the output link;
one end of the spiral spring is directly or indirectly connected to the rigidity variable actuator, and another end of the spiral spring is directly or indirectly connected the output link; and
the rigidity variable actuator changes the apparent rigidity of the variable rigidity mechanism seen from the output link by changing a rotation angle of the one end of the spiral spring.

11. The assist device according to claim 10, wherein a speed reducer is provided between the spiral spring and the output link, and the speed reducer is configured to maintain the swinging angle of the output link such that the swinging angle of the output link is reduced at a predetermined ratio relative to a swinging angle of the other end of the spiral spring.

12. The assist device according to claim 1, wherein:
the assist device is a swinging joint device connected to the moving body that performs the reciprocating swing motion, the swinging joint device being configured to alternately repeat an energy accumulation mode and an energy release mode, the energy accumulation mode being a mode in which energy is accumulated in the elastic body by a motion of the moving body, and the energy release mode being a mode in which the energy accumulated in the elastic body is released so as to assist the motion of the moving body;
the rigidity varying unit of the variable rigidity device is an apparent rigidity varying unit configured to change an apparent rigidity of the elastic body seen from the first output portion;
the control device controls the apparent rigidity varying unit in accordance with the first swinging angle detected by the first angle detecting portion, so as to adjust the apparent rigidity of the elastic body seen from the first output portion; and
the control device adjusts the apparent rigidity of the elastic body seen from the first output portion based on the first swinging angle and at least one of i) a gravitational force applied to the moving body in accordance with the first swinging angle, ii) an inertia force applied to the moving body in accordance with the first swinging angle and a motion state of the moving body, and iii) a central position of a reciprocating swing motion locus of the first output portion.

13. The assist device according to claim 12, wherein:
the elastic body is a flat spiral spring;
one end of the flat spiral spring is connected to a first output portion-side input-output shaft portion that is turned around a spring center as a center of the flat spiral spring at an angle in accordance with the first swinging angle of the first output portion;
another end of the flat spiral spring is connected to a rigidity adjustment member that is turned around the spring center by a rigidity adjustment electric motor;
the apparent rigidity of the elastic body is an apparent spring constant of the flat spiral spring;
the apparent rigidity varying unit is constituted by the rigidity adjustment electric motor and the rigidity adjustment member; and
the apparent rigidity of the elastic body seen from the first output portion is adjusted by adjusting a turning angle of the rigidity adjustment member by the rigidity adjustment electric motor.

14. The assist device according to claim 12, wherein:
in a case where the apparent rigidity of the elastic body seen from the first output portion is adjusted based on the gravitational force and the first swinging angle, the control device adjusts the apparent rigidity of the elastic body seen from the first output portion based on a moving body mass that is a mass of the moving body including the first output portion, a moving body gravity center distance that is a distance from the swing center to a gravity center of the moving body including the first output portion, an angular frequency of swinging, gravitational acceleration, and the first swinging angle.

15. The assist device according to claim 12, wherein:
the moving body includes a femoral region of a body of a user from a hip joint to a knee, and a lower leg below the knee;
the lower leg swings relative to the femoral region around a knee center that is a knee joint;
the first output portion is connected to the femoral region;
a second output portion swingable relative to the first output portion around the knee center is connected to the first output portion at a position corresponding to the knee center;
the second output portion is connected to the lower leg and includes a second angle detecting portion configured to detect a second swinging angle, the second swinging angle being a swinging angle of the second output portion relative to the first output portion; and
in a case where the apparent rigidity of the elastic body seen from the first output portion is adjusted based on the gravitational force, the inertia force, and the first swinging angle, the control device adjusts the apparent rigidity of the elastic body seen from the first output portion based on i) a femoral region mass that is a mass of the femoral region including the first output portion, ii) a femoral region length that is a distance from the swing center to the knee center; iii) a femoral region gravity center distance that is a distance from the swing center to a gravity center of the femoral region including the first output portion; iv) a lower leg mass that is a mass of the lower leg including the second output portion; v) a lower leg length that is a distance from the knee center as one end of the lower leg to another end of the lower leg; vi) a lower leg gravity center distance that is a distance from the knee center to a gravity center of the lower leg including the second output portion; vii) an angular frequency of swinging of the first output portion; viii) gravitational acceleration; ix) the first swinging angle; and x) the second swinging angle.

16. The assist device according to claim 12, wherein:
in a case where the apparent rigidity of the elastic body seen from the first output portion is adjusted based on the gravitational force, the central position, and the first swinging angle, the control device adjusts the apparent rigidity of the elastic body seen from the first output portion based on i) a moving body mass that is a mass of the moving body including the first output portion; ii) a moving body gravity center distance that is a distance from the swing center to a gravity center of the moving body including the first output portion; iii) an angular frequency of swinging; iv) gravitational acceleration; v) a central angle that is an angle formed between a gravitational acceleration direction and a virtual straight line connecting the swing center to the central position; and vi) the first swinging angle.

17. A linear motion variable rigidity unit comprising:
a linear motion-rotation conversion mechanism including a linear-motion input-output portion and a rotational motion input-output portion;
a variable rigidity mechanism including an elastic body connected to the rotational motion input-output portion;
a rigidity variable actuator connected to the variable rigidity mechanism;
a control device configured to control the rigidity variable actuator; and
a support member configured to support the linear motion-rotation conversion mechanism, the variable rigidity mechanism, and the rigidity variable actuator, wherein:
the linear-motion input-output portion is connected to a linear reciprocating body that linearly reciprocates;
the linear motion-rotation conversion mechanism performs an energy accumulation operation that converts a linear reciprocating motion input from the linear-motion input-output portion to a rotational reciprocating motion so as to output the rotational reciprocating motion from the rotational motion input-output portion, and an energy release operation that converts the rotational reciprocating motion input from the rotational motion input-output portion to the linear reciprocating motion so as to output the linear reciprocating motion from the linear-motion input-output portion;
in a case where the linear motion-rotation conversion mechanism performs the energy accumulation operation, the elastic body in the variable rigidity mechanism accumulates input energy that is input from the rotational motion input-output portion via the linear-motion input-output portion, the input energy being energy from the linear reciprocating body; and
in a case where the linear motion-rotation conversion mechanism performs the energy release operation, the elastic body releases accumulated energy that is energy accumulated in the elastic body, toward the linear reciprocating body via the rotational motion input-output portion and the linear-motion input-output portion; and
the rigidity variable actuator changes a rigidity of the elastic body of the variable rigidity mechanism seen from the linear motion-rotation conversion mechanism.

18. The linear motion variable rigidity unit according to claim 17, wherein:
the elastic body is a spiral spring;
one end of the spiral spring is connected to the rotational motion input-output portion and another end of the spiral spring is connected to the rigidity variable actuator; and
the rigidity variable actuator is configured to turn the spiral spring around a central axis of the spiral spring so as to change an apparent spring constant seen from the linear motion-rotation conversion mechanism, the apparent spring constant being a rigidity of the spiral spring seen from the linear motion-rotation conversion mechanism.

19. The linear motion variable rigidity unit according to claim 18, wherein:
the control device changes the apparent spring constant in real time by controlling the rigidity variable actuator to reduce drive energy that causes the linear reciprocating body to linearly reciprocate, based on a mass of the linear reciprocating body, an angular frequency at which the rotational motion input-output portion rotates in a reciprocating manner, and a current rotation angle of the rotational motion input-output portion.

20. A machine tool comprising:
the linear motion variable rigidity unit according to claim 17;
a reciprocation table as the linear reciprocating body that linearly reciprocates at a predetermined frequency; and
a table drive device configured to cause the reciprocation table to linearly reciprocate, wherein
the linear motion variable rigidity unit is attached to the reciprocation table.
